(19) United States
(12) Patent Application Publication
(10) Pub. No.: US 2013/0179206 A1
(43) Pub. Date: Jul. 11, 2013

(54) System And Method For Multi-Verifiable, As-Built Construction Modeling

(71) Applicants: Guy A. Harper, Redwood City, CA (US); Walter J. Caughlin, Point Richmond, CA (US)

(72) Inventors: Guy A. Harper, Redwood City, CA (US); Walter J. Caughlin, Point Richmond, CA (US)

(21) Appl. No.: 13/401,782

(22) Filed: Feb. 21, 2012

Related U.S. Application Data
(60) Provisional application No. 61/445,011, filed on Feb. 21, 2011.

(51) Int. Cl. G06Q 50/16

(52) U.S. Cl. CPC G06Q 50/165; G06Q 10/063
USPC 705/7.13; 705/7.29

(57) ABSTRACT

A system for multi-verifiable, as-built construction modeling in which accurate, independently verifiable site maps, floorplan, exterior and interior elevations alongside detailed checklists for subcontractors, suppliers, and professional services can be generated for providing detailed written proposals, cost estimates and critical path timeline.

### RELATED APPLICATION(S)

This application is a Nonprovisional patent application related to U.S. Provisional Patent Application Ser. No. 61/445,011 filed Feb. 21, 2011 entitled “SYSTEM AND METHOD FOR MULTI-VERIFIABLE, AS-BUILT CONSTRUCTION MODELING”, which is incorporated herein by reference in its entirety, and claims any and all benefits to which it is entitled therefrom.

### STATEMENT REGARDING CLAIM OF COPYRIGHT

A portion of the disclosure of this patent document, including all accompanying drawings, contains material to which a claim of copyright protection is made. The copyright owner has no objection to the facsimile reproduction by anyone of the patent document or the patent disclosure, as it appears in the Patent and Trademark Office patent file or records once made public, for purposes other than for those expressly permitted under state and federal law pertaining to unauthorized reproduction of copyrighted materials and literary expression, but reserves all other rights whatsoever.

### FIELD OF THE INVENTION

The present invention relates to construction modeling and estimation of reconstruction costs.

### SUMMARY OF THE INVENTION

The present invention is a system and method for developing an as-built model of a building from independent, verifiable and third-party resources.

As so often happens in the case of natural or man-caused disasters, including floods, conflagration, earthquakes, explosions caused by natural gas or other chemicals, catastrophic property damage is the result. Unfortunately, there are often no documents or very little documentation in place from which the “as-built” structures which are lost can be reconstructed. Architectural drawings or plans from decades gone by often don't exist, have been lost or misplaced, damaged or destroyed along with the structure. Often, second, third or fourth owners never receive copies of original building or architectural plans. In addition, building plans or drawings from municipality offices including tax assessors, building permit or planning departments are often not online, or are not maintained in a central location. Indeed, it has only been within the past few decades that many municipality offices have actually started tracking and maintaining records online or in a central location.

When a disaster strikes, property owners need to know precisely what they owned and how much it will cost to rebuild. Architects will need to know exactly what existed, in order to develop new plans for replacement. General contractors and subcontractors will need guidelines to estimate and rebuild. Insurers will need to know accurately what existed in the first place, in order to provide realistic and actual replacement costs. In one instance, an insurance company provided a detailed estimate for replacement cost of an entire residential structure lost during an explosion caused by a natural gas leak which destroyed over 30 residences in a small community. Unfortunately, the estimate failed to recognize that the structure included a bathroom, which of course it did, and therefore the estimate provided by the insurance company was fundamentally and inherently flawed. It is of course the homeowner who pays for such gross inaccuracy.

Therefore, there exists a very real and important need for a multi-verifiable system and method to develop as-built construction models.

The present invention is exactly such a system and method. The present invention utilizes a plurality of resources obtained form a plurality of independent, separately verifiable locations, and based upon the sum of these resources is able to develop a verifiable, accurate, as-built model for purposes of insurance, estimating and reconstruction.

One objective of Reconstructware™ reconstruction services is to assist homeowners in re-drawing building plans in order to identify the components that were in their previous home. The method utilizes an empirical system by using public documents including aerial photographs, building department records, county assessors office records, sub division (parcel) maps and the intimate knowledge of the home from the owners. The collaboration of documents, and at times with the support of (personal) pictures, gives a solid platform in which to begin the process. After documenting the building footprint, setbacks, lot coverage (including living and garage sizes), roof size and slope, window size and location and interior floor plan, the system produces a model for the re-creation of the “As Was” house. It is at this point where costs for professional services, suppliers, and subcontractors can be estimated and captured using an agreed upon unit price sheet for those specific scope(s) of work.

This in turn helps to negotiate a fair and balanced settlement. This tangible format and scalable plans are hard to dispute as everything can be cross checked and cross referenced by legal documents.

Re-Constructware™ offers a clear, easy to read system that concludes with a genuine construction budget, based on a list of components and a list of products and finishes that are assembled to best represent the existing structure, and by assigning current unit costs assembled by category for easy comparison.

The system of the present invention is much easier to understand than other estimating systems. It establishes a fair value for the construction costs to re-construct the home or other building.

The Re-Constructware™ system and method of the present invention has a 3 phase objective;

1. Establishes the pre-existing size, schedule of finishes, landscape/hardscape design, and therefore estimated cost of the “As Was” home.

2. Establishes the “As Was” cost, plus the addition of values for Building and Planning code upgrades.

3. This process creates an allowance for available funds to use for budgeting new construction.

### BRIEF DESCRIPTION OF THE DRAWINGS

FIG. 1 is a representative, typical cover sheet showing the form of presentation of an as-built model of a building as developed from independent, verifiable and third-party resources of the present invention.

FIG. 2 is a representative, typical table of contents of a typical as-built model of a building as developed from independent, verifiable and third-party resources of the present invention.

FIGS. 3A-C are representative, typical background information of a typical provider of a typical as-built model of a building as developed from independent, verifiable and third-party resources of the present invention.

FIG. 4 is a typical sheet of County Assessor's Office property information for the as-built model of a building as developed from independent, verifiable and third-party resources of the present invention.

FIG. 5 is a representative, typical map of the general geographical region of the location for the as-built model of a building as developed from independent, verifiable and third-party resources of the present invention.

FIG. 6 is a representative, typical municipality zoning map applicable to the as-built model of a building as developed from independent, verifiable and third-party resources of the present invention.

FIG. 7 is a representative, typical parcel map for the as-built model of a building as developed from independent, verifiable and third-party resources of the present invention.

FIGS. 8A-C are representative aerial satellite views of a clients parcel with existing roof structure and front and rear yard landscape from a typical as-built model of a building as developed from independent, verifiable and third-party resources of the present invention.

FIGS. 9A-C are representative dimensions diagrams of roof structures from a typical as-built model of a building as developed from independent, verifiable and third-party resources of the present invention.

FIGS. 10A-I are representative reports from a local municipal building department including permit description of recent improvements from a typical as-built model of a building as developed from independent, verifiable and third-party resources of the present invention.

FIGS. 11A-D are representative hand-drawn floor plan sketches, such as by a home or other building owner from a typical as-built model of a building as developed from independent, verifiable and third-party resources of the present invention.

FIGS. 12A-C are representative schedules of was-built finishes from a typical as-built model of a building as developed from independent, verifiable and third-party resources of the present invention.

FIGS. 13A-N are representative CAD sheets including index, site plan, floor plans, exterior elevations, electrical and lighting plans, landscape plans and inventory lists from a typical as-built model of a building as developed from independent, verifiable and third-party resources of the present invention.

FIGS. 14A-D are representative cross references of livable space quantities compared to County Assessor's office information from a typical as-built model of a building as developed from independent, verifiable and third-party resources of the present invention.

FIGS. 15A-E are representative cost breakdown for subcontractor, supplier & professional services unit price spread sheets from a typical as-built model of a building as developed from independent, verifiable and third-party resources of the present invention.

FIG. 16 is a representative list of cost adjustments for building and planning code upgrades from a typical as-built model of a building as developed from independent, verifiable and third-party resources of the present invention.

FIGS. 17A-B are representative list of cost adjustments for building and planning code upgrades from a typical as-built model of a building as developed from independent, verifiable and third-party resources of the present invention.

FIGS. 18A-G is a representative written proposal for construction of as-built model of a building as developed from independent, verifiable and third-party resources of the present invention.

FIGS. 19A-L are representative sub0contractor's estimates for the as-built model of a building as developed from independent, verifiable and third-party resources of the present invention.

### DETAILED DESCRIPTION OF EMBODIMENTS OF THE INVENTION

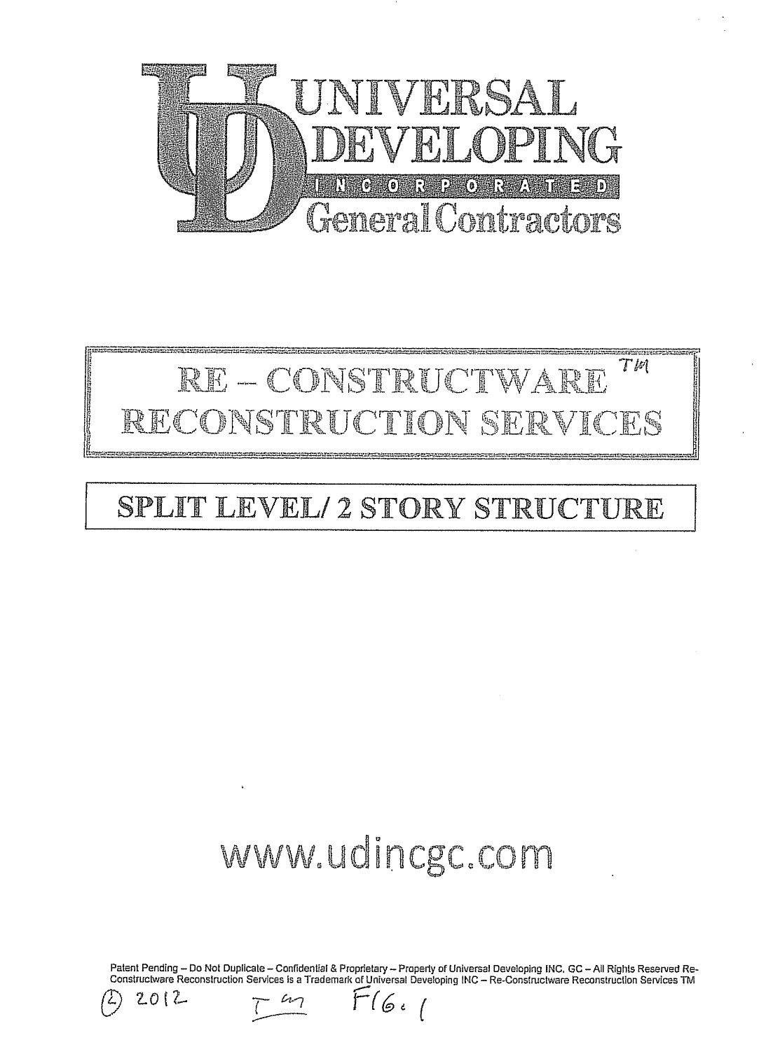

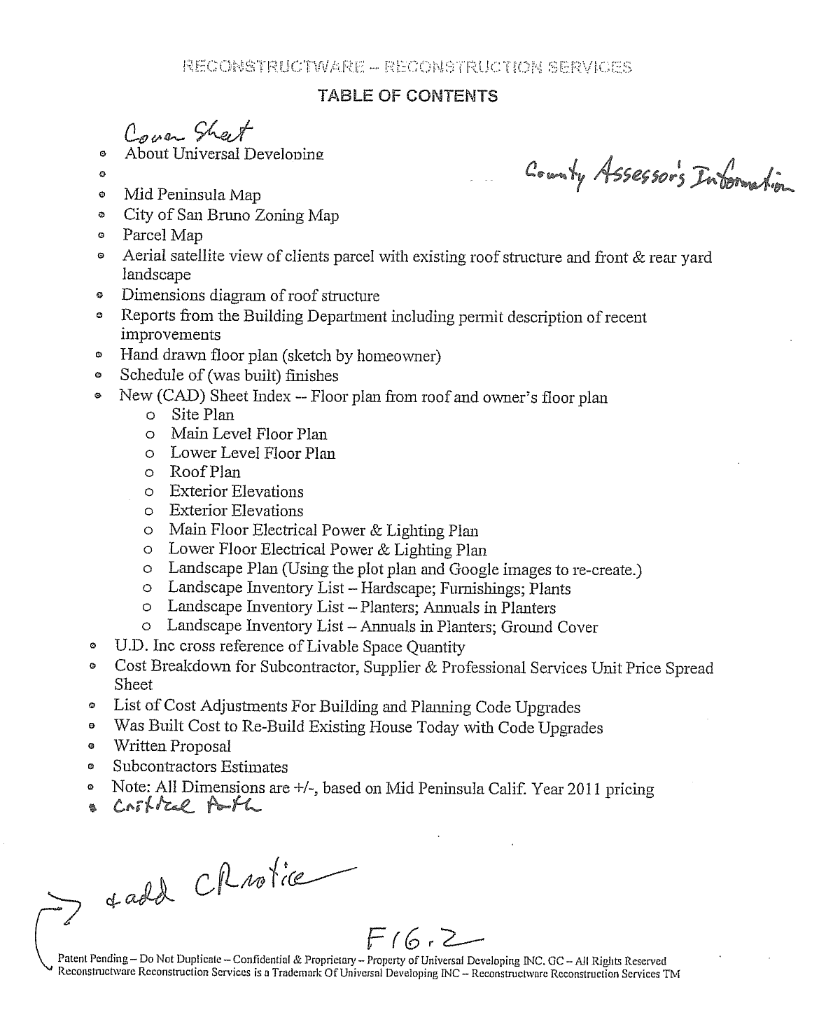

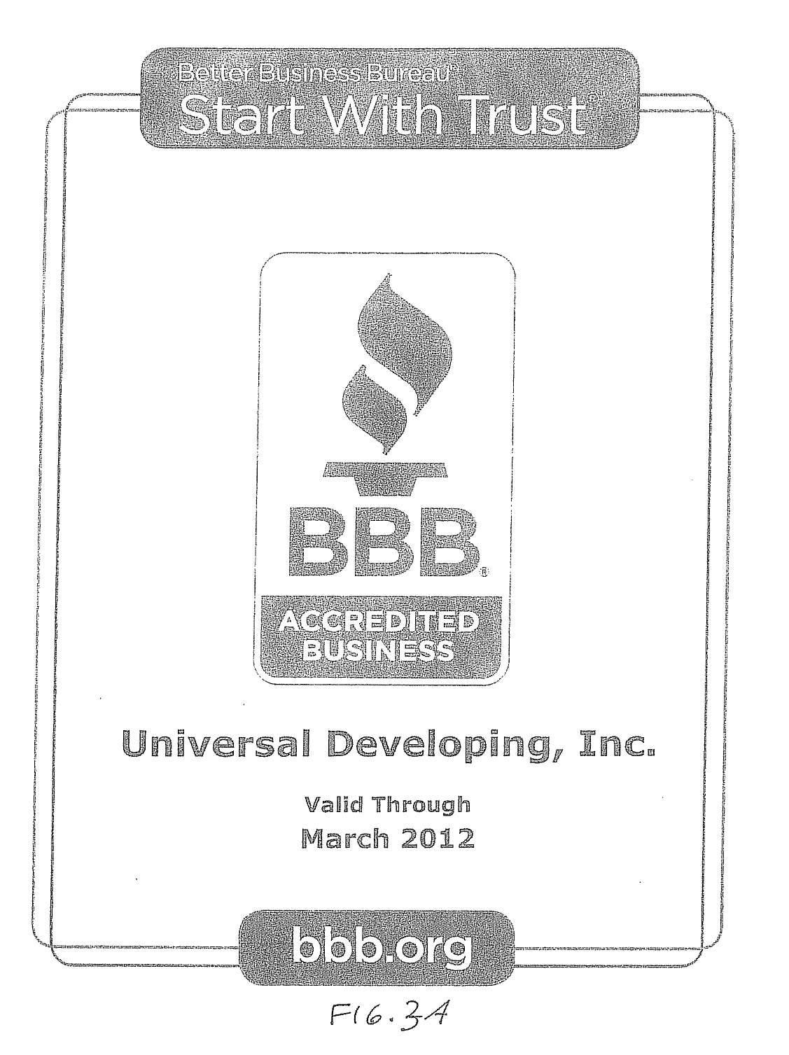

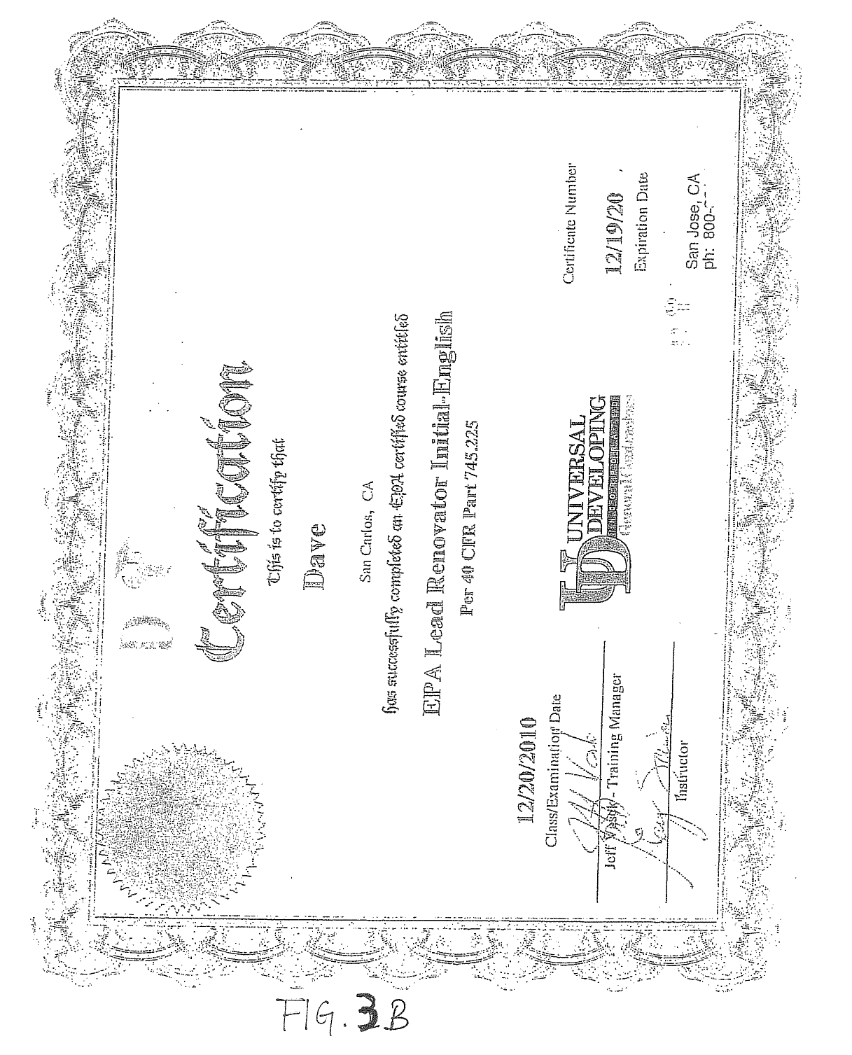

FIG. 1 is a representative, typical cover sheet showing the form of presentation of an as-built model of a building as developed from independent, verifiable and third-party resources of the present invention.

It will be understood that an embodiment of the present invention is a method to assist homeowners in re-drawing building plans in order to identify the components that were in their previous home. The method, therefore, would be practiced by building professionals and insurance interests and concerns, as well as homeowners or owners of property destroyed or otherwise in need of reconstruction.

FIG. 2 is a representative, typical table of contents of a typical as-built model of a building as developed from independent, verifiable and third-party resources of the present invention. The table of contents shown in FIG. 2 is exemplary of but a single embodiment of the present invention. It will be understood that components may be added, or deleted, as needed depending upon the type of building being reconstructed, the actual building, permit, planning or other records available to the user of the invention, etc.

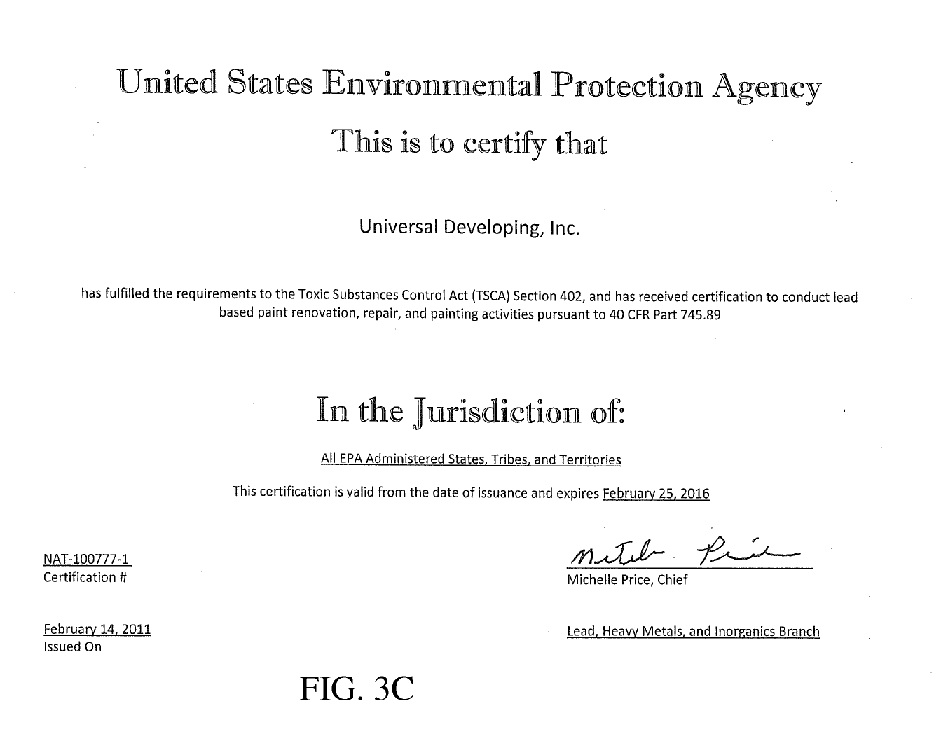

FIGS. 3A-C are representative, typical background information of a typical provider of a typical as-built model of a building as developed from independent, verifiable and third-party resources of the present invention. It will be understood that such typical background information includes but would not be limited to the following: Better Business Bureau (BBB)® or other local/regional/industry-wide accreditations, certifications and/or licensure evidences for such items as general contractor's licenses, lead removal, toxic remediation or other environmental inspection or service specialists, general resuuumes or other statements regarding the background, skills and qualifications of the provider, etc.

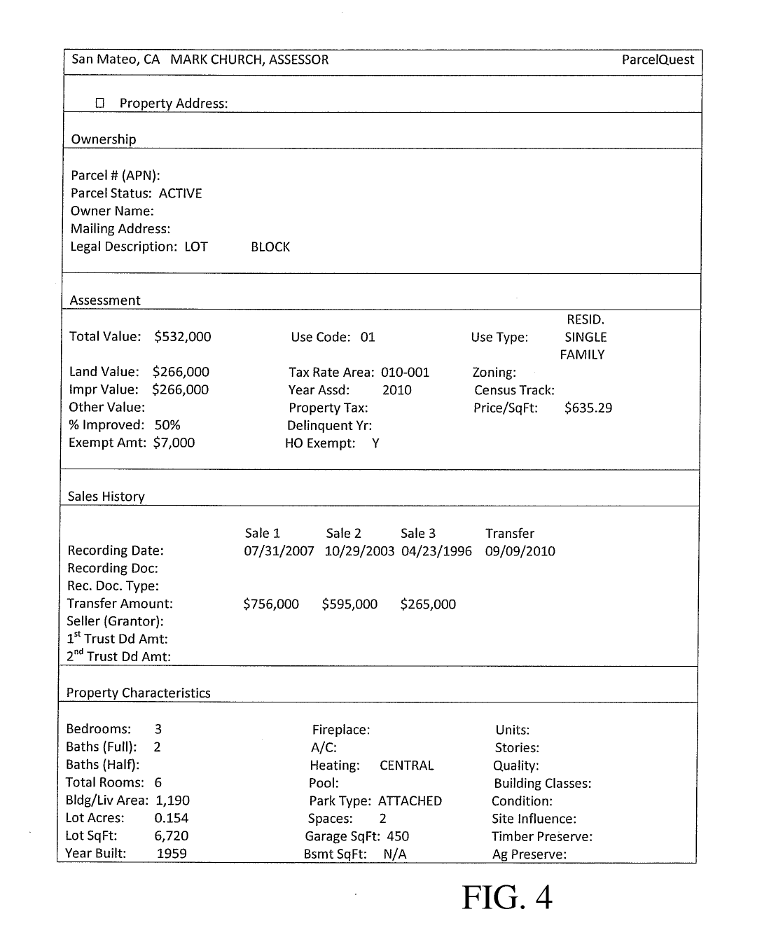

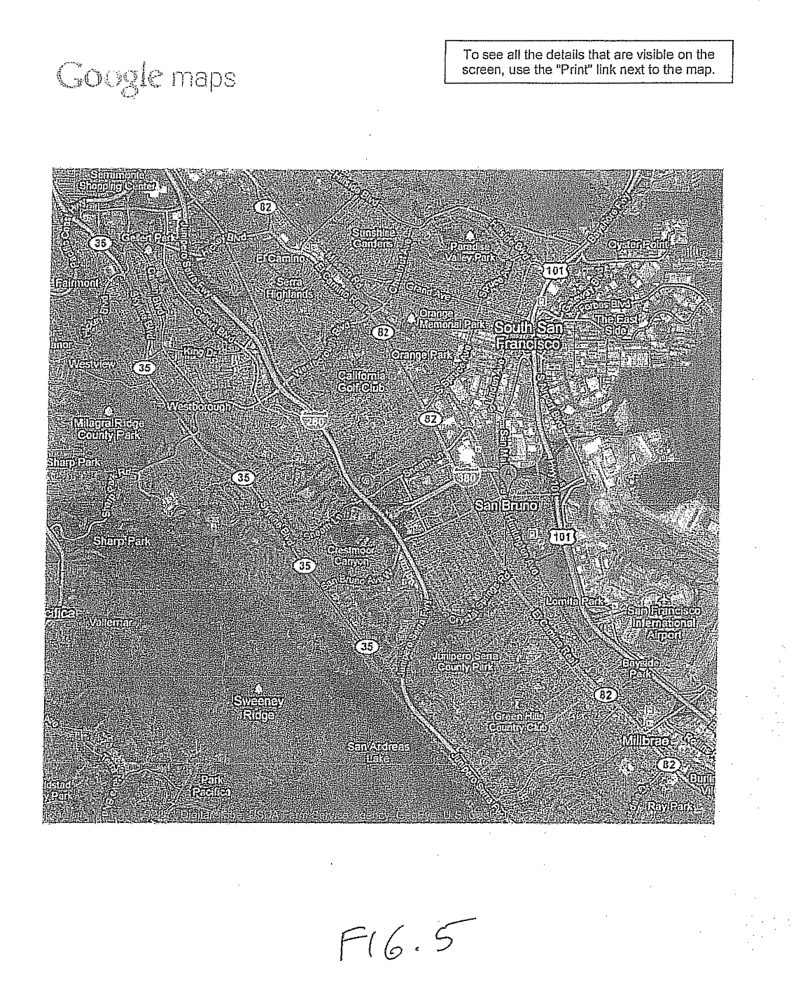

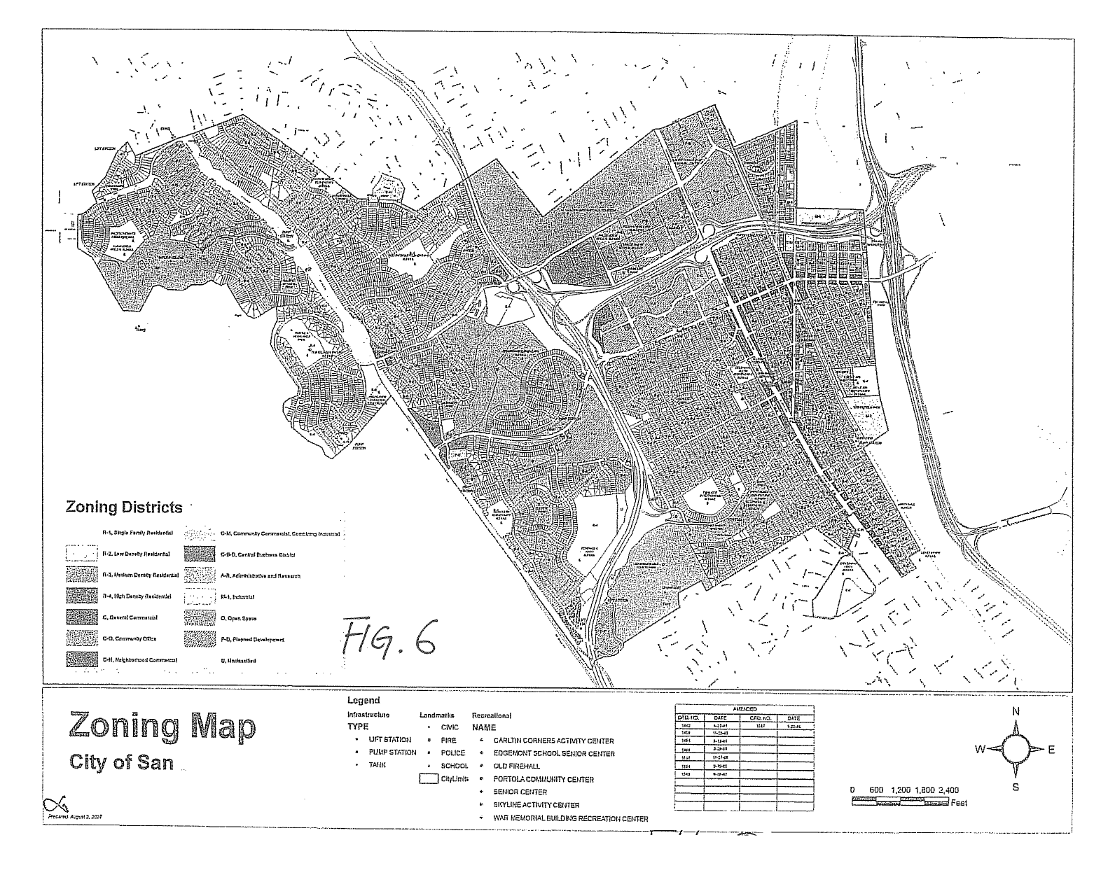

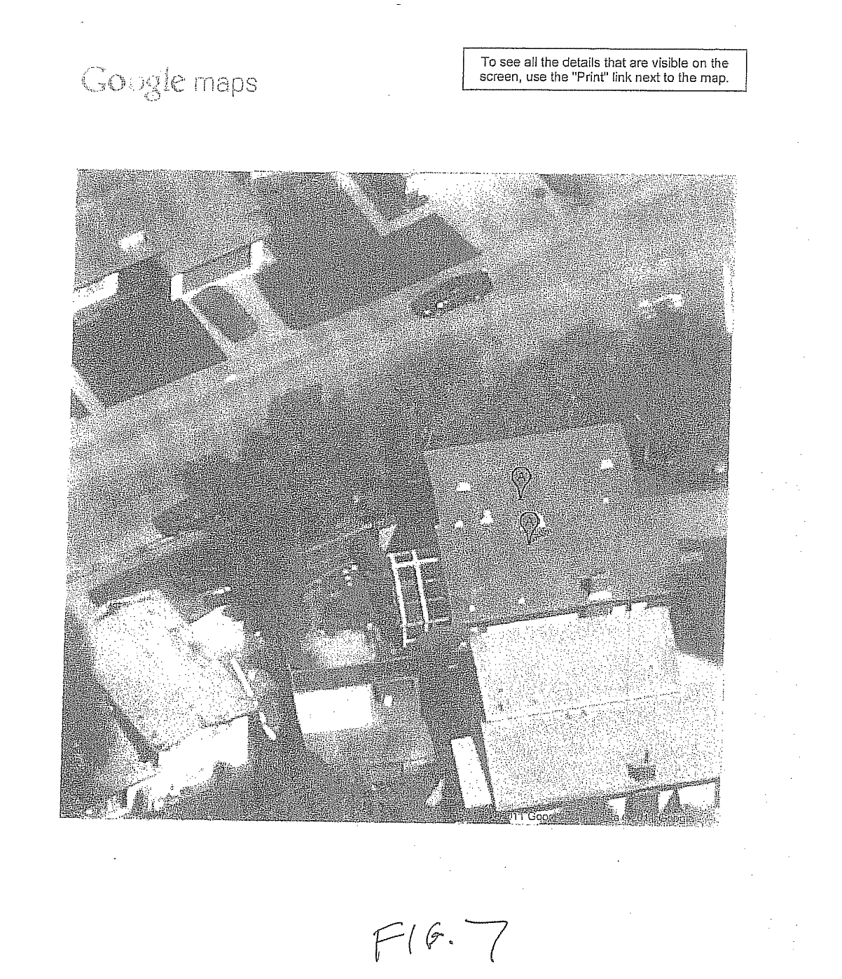

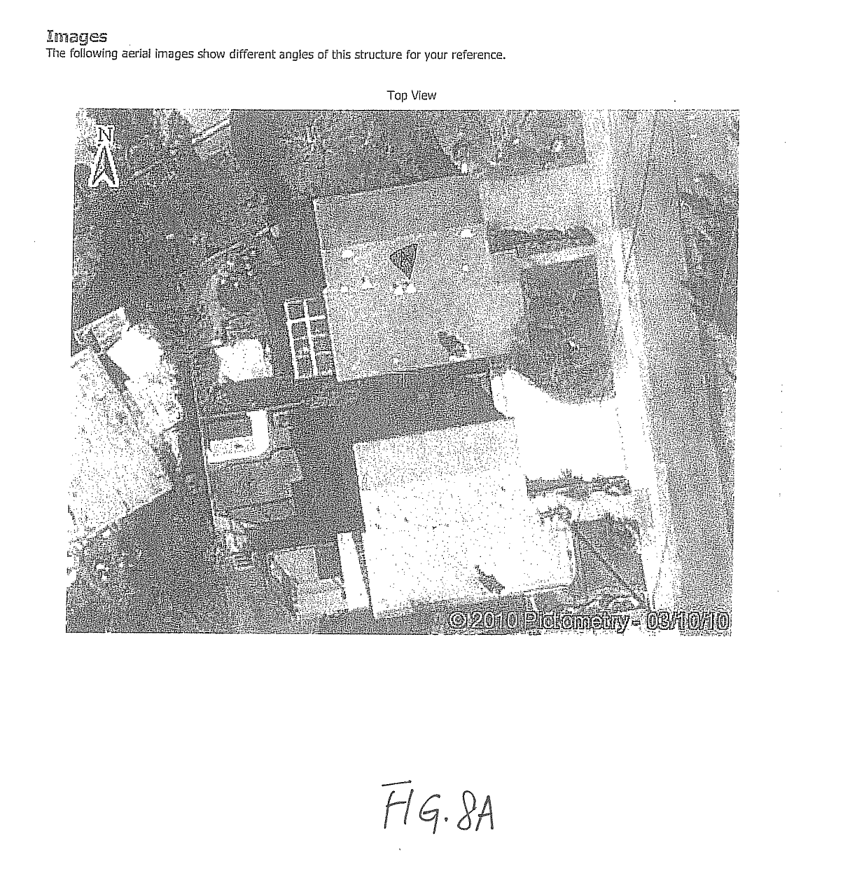

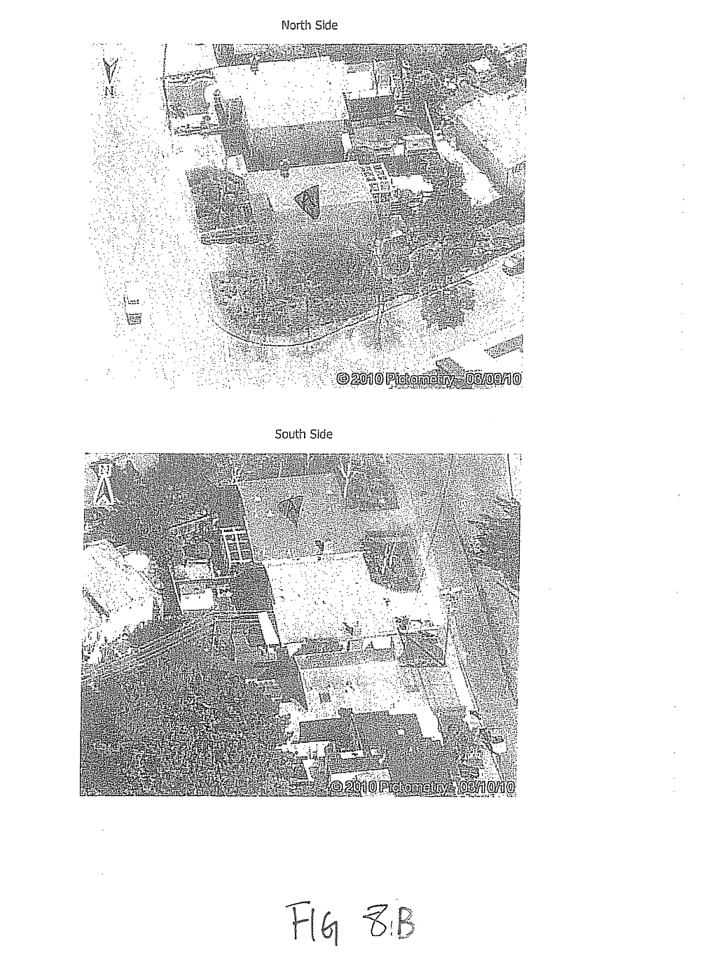

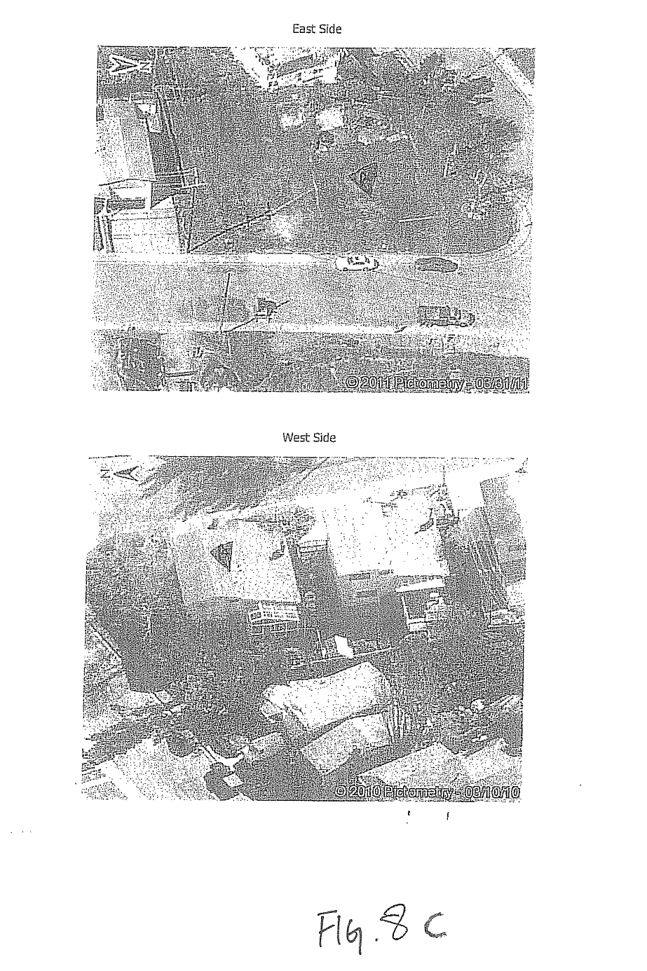

FIG. 4 is a typical sheet of County Assessor's Office property information for the as-built model of a building as developed from independent, verifiable and third-party resources of the present invention. Assessors parcel data is considered. This data includes address, owner contact details, legal plot description, assessed value which includes land value, improvement value, tax rate, zoning, census tract details, percentage improvements, and price per square foot. Sales history going back for the previous owners and transfer dates, recording document numbers, transfer prices, and trust deed amounts is important. Additionally, property characteristics are given, such as numbers of bedrooms, bathrooms, total rooms, living area and lot areas, year built, types of heating, A/C, pools or hot tubs, parking spaces and garage size, basement size, numbers of units, stories and condition.

FIG. 5 is a representative, typical map of the general geographical region of the location for the as-built model of a building as developed from independent, verifiable and third-party resources of the present invention. An initial consideration for developing the as-was built model is geographical location. Not only do materials vary in price from location to location, but so also will building costs, labor costs, fuel costs, permit fees, and costs of living. Precise geographical location is a critical factor which must be considered to develop an accurate, verifiable, as-built construction model.

One source of information is from satellite or aerial images. Google Earth (trademark) is once such source of aerial and satellite photos. Other sources of aerial and satellite photos include NASA, newspapers or other periodical and news reporting agencies. Given the advances in aerial and satellite photography, such images are rich in content, and provide precise information and data which includes roofline dimensions, setbacks, constructive easements, landscape and hardscape data. Such data can be very precise, i.e., resolution within a very few inches or percentages.

FIG. 6 is a representative, typical municipality zoning map applicable to the as-built model of a building as developed from independent, verifiable and third-party resources of the present invention. FIG. 7 is a represntative, typical parcel map for the as-built model of a building as developed from independent, verifiable and third-party resources of the present invention.

Zoning maps which are fundamental to virtually all municipalities are a critical factor in determining an accurate, verifiable, as-built construction model. Such zoning maps include data related to single family and multi-family residences, housing density, commercial and agricultural zones, central business districts, administrative and research parks, industrial locations, open space, planned development and other unclassified areas. In addition, zoning maps provide information regarding locations of civic, fire, police, school facilities and city limits.

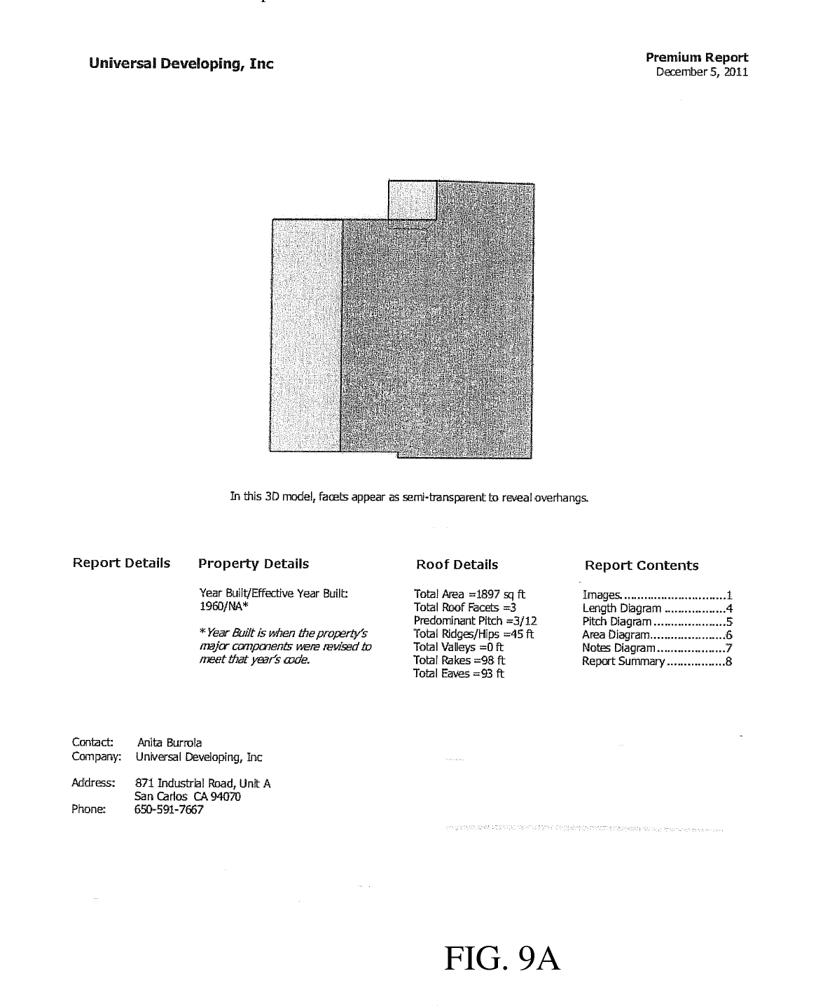

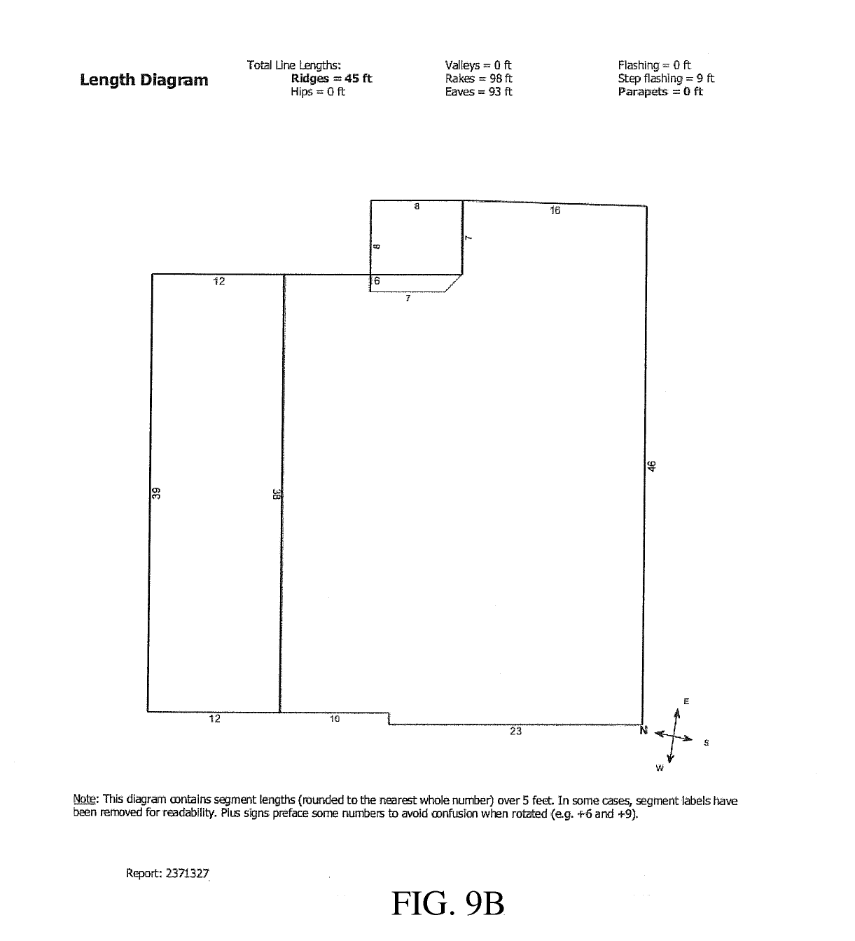

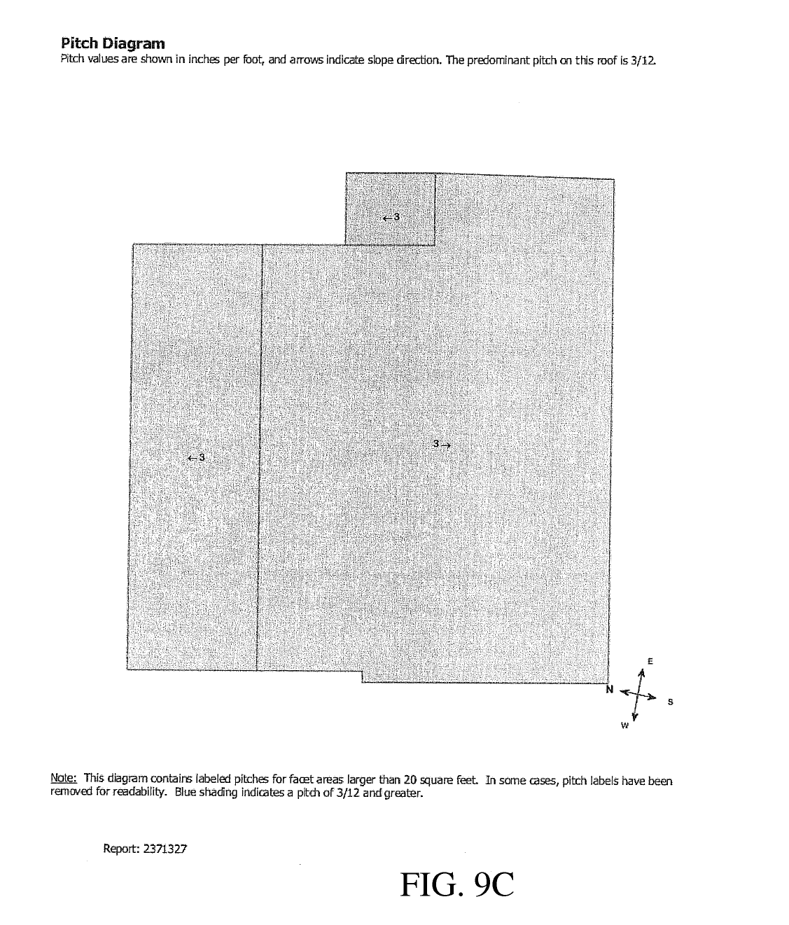

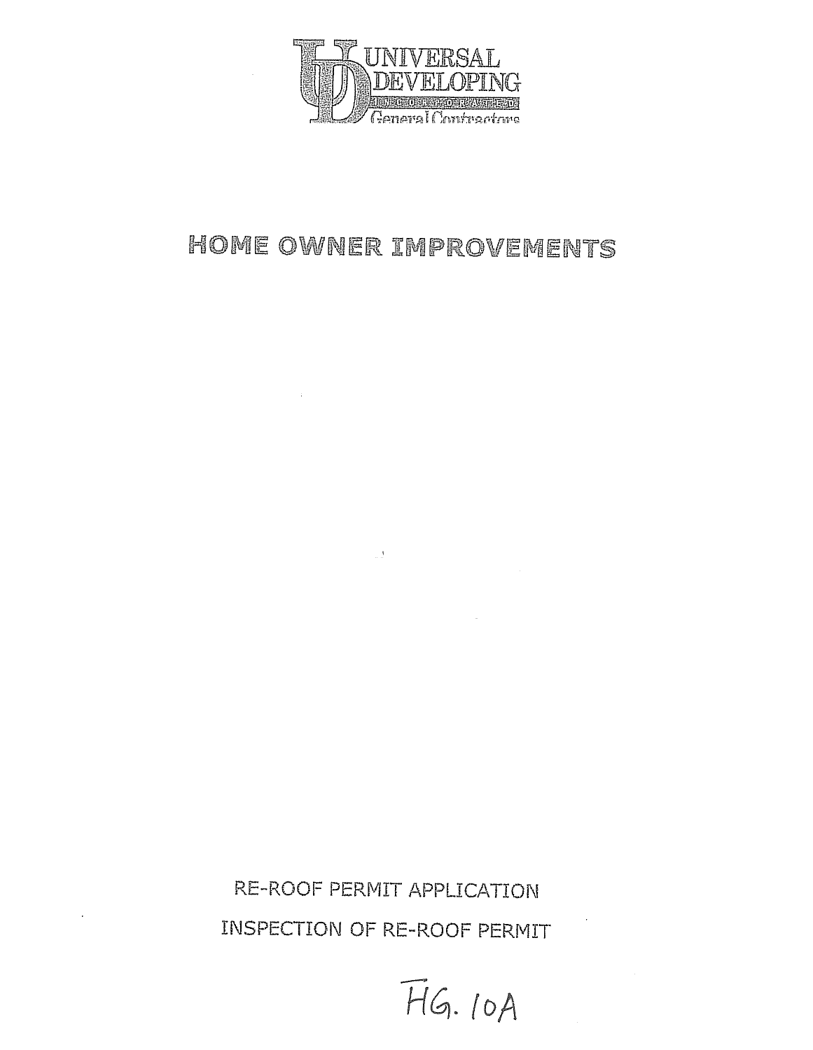

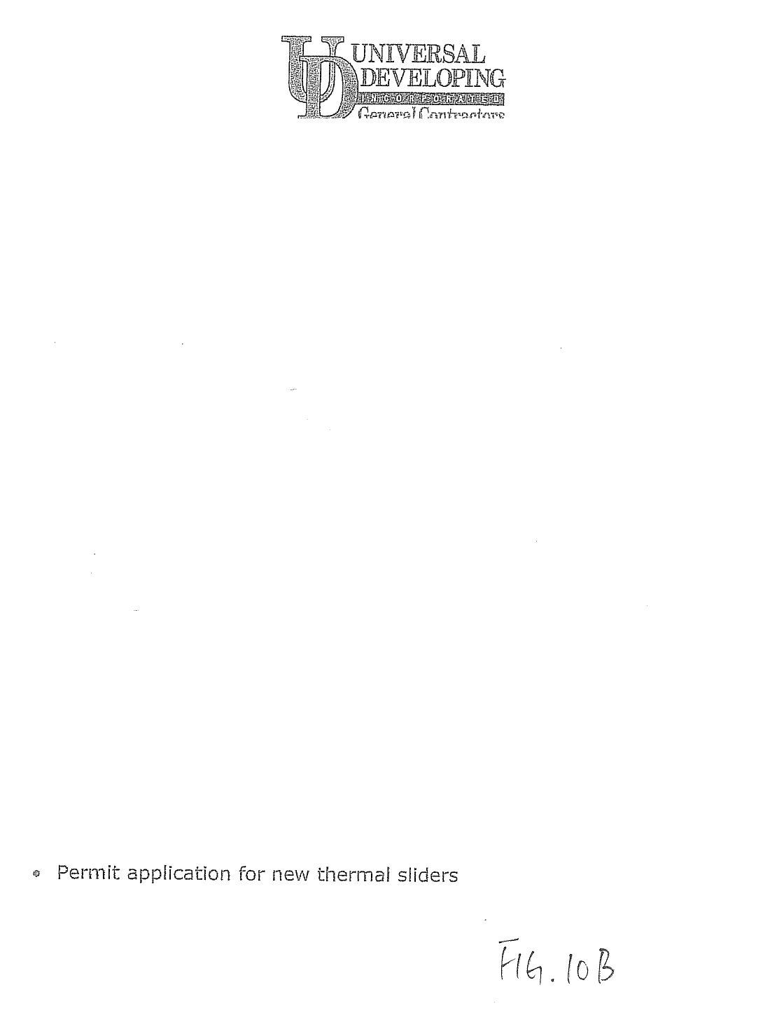

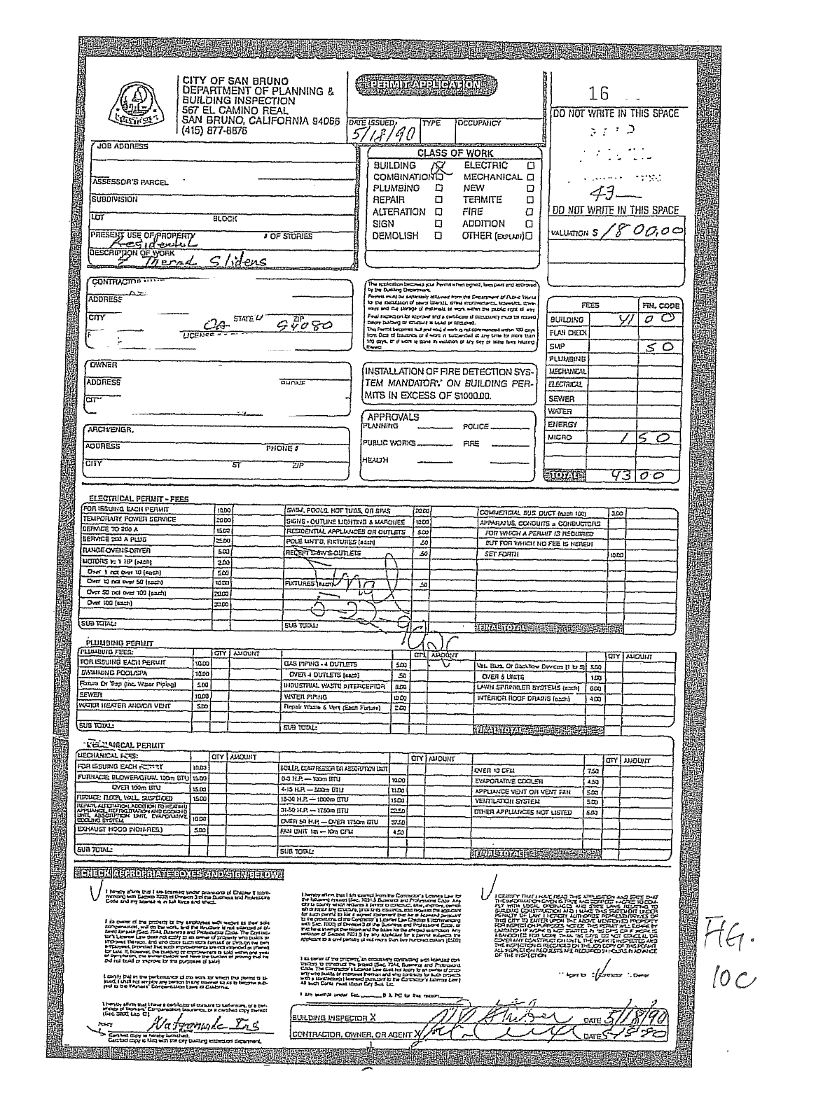

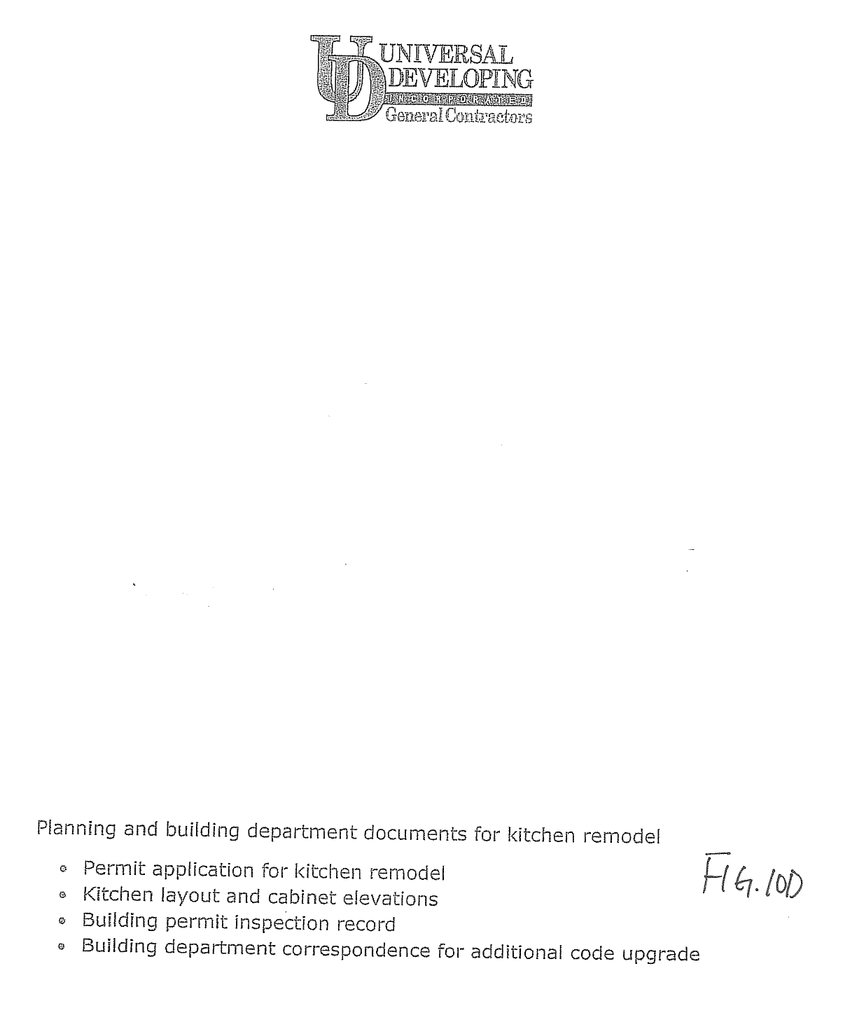

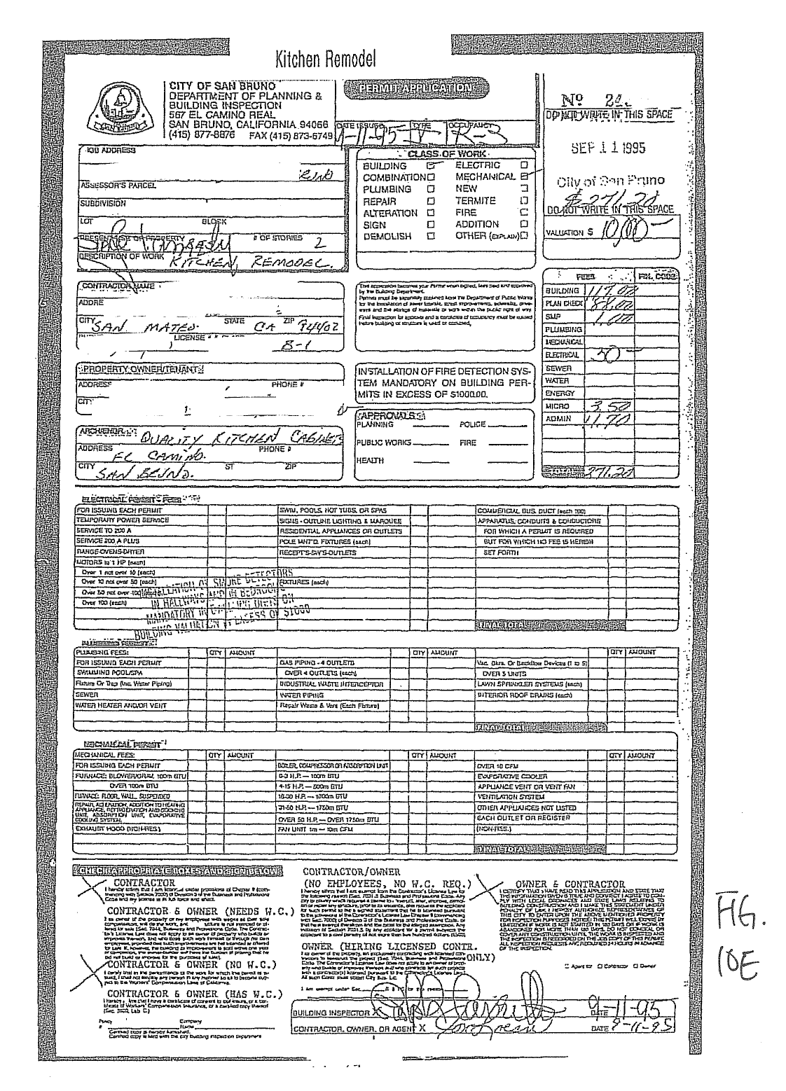

FIGS. 8A-C are representative aerial satellite views of a clients parcel with existing roof structure and front and rear yard landscape from a typical as-built model of a building as developed from independent, verifiable and third-party resources of the present invention. FIGS. 9A-C are representative dimensions diagrams of roof structures from a typical as-built model of a building as developed from independent, verifiable and third-party resources of the present invention.

Precise roofline drawings can be generated utilizing existing technology, such as but not limited to “EagleView” (trademark) reports. These reports contain segment lengths rounded to the nearest whole number or decimal point over X feet in length. In some cases, segment labels are removed for readability, and plus signs are added to avoid confusion when rotated. A compass legend plots the orientation. In a typical roofline, line lengths are related to ridges, hips, valleys, rakes, eaves, flashing and step flashing components.

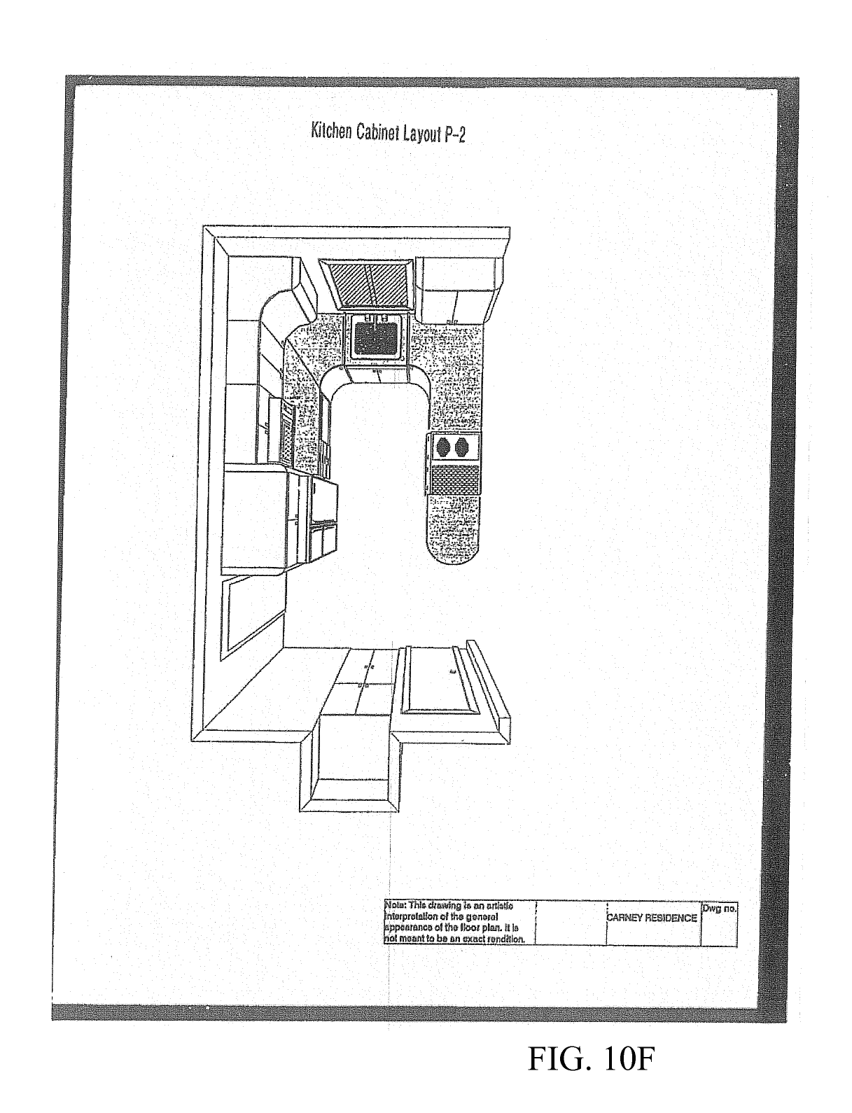

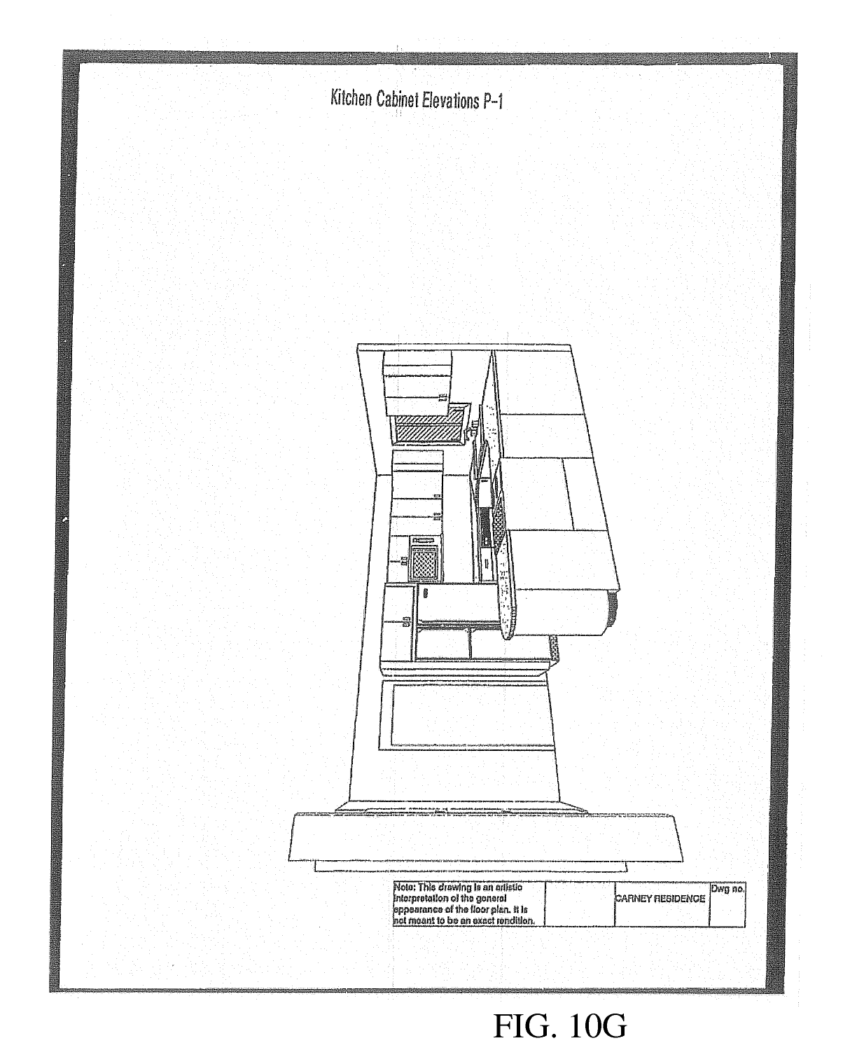

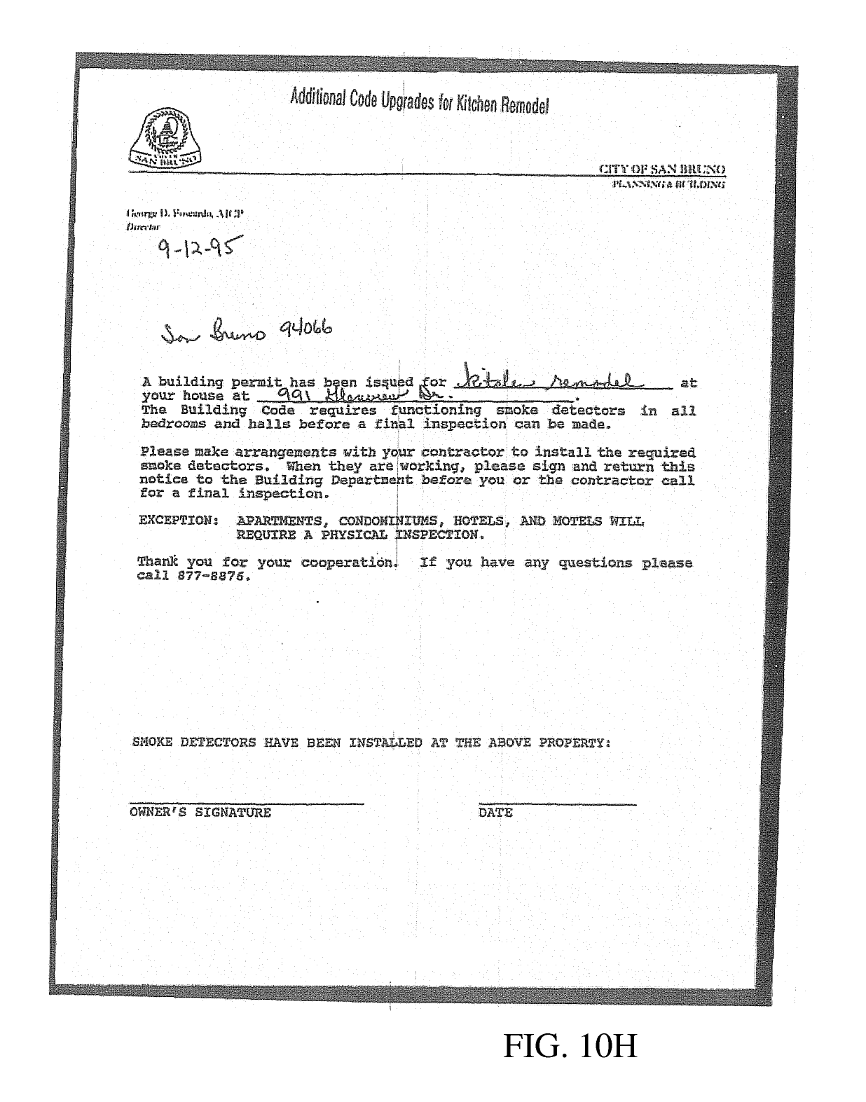

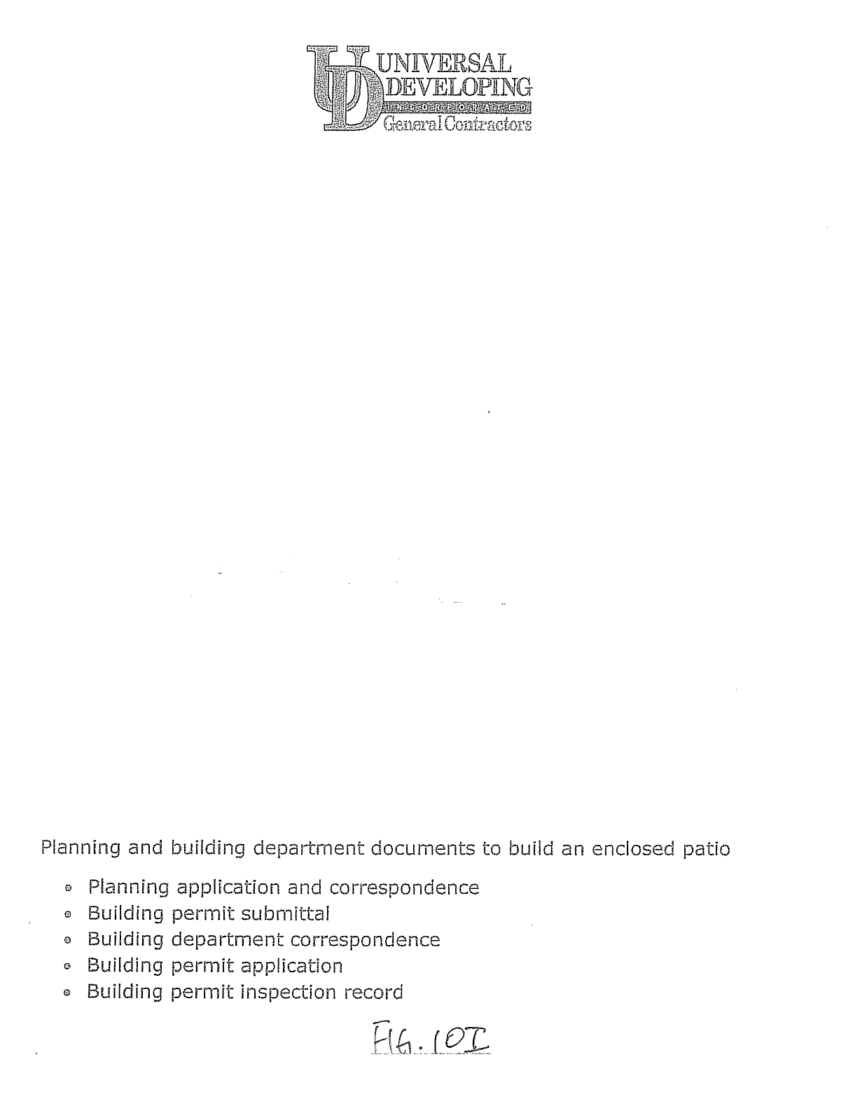

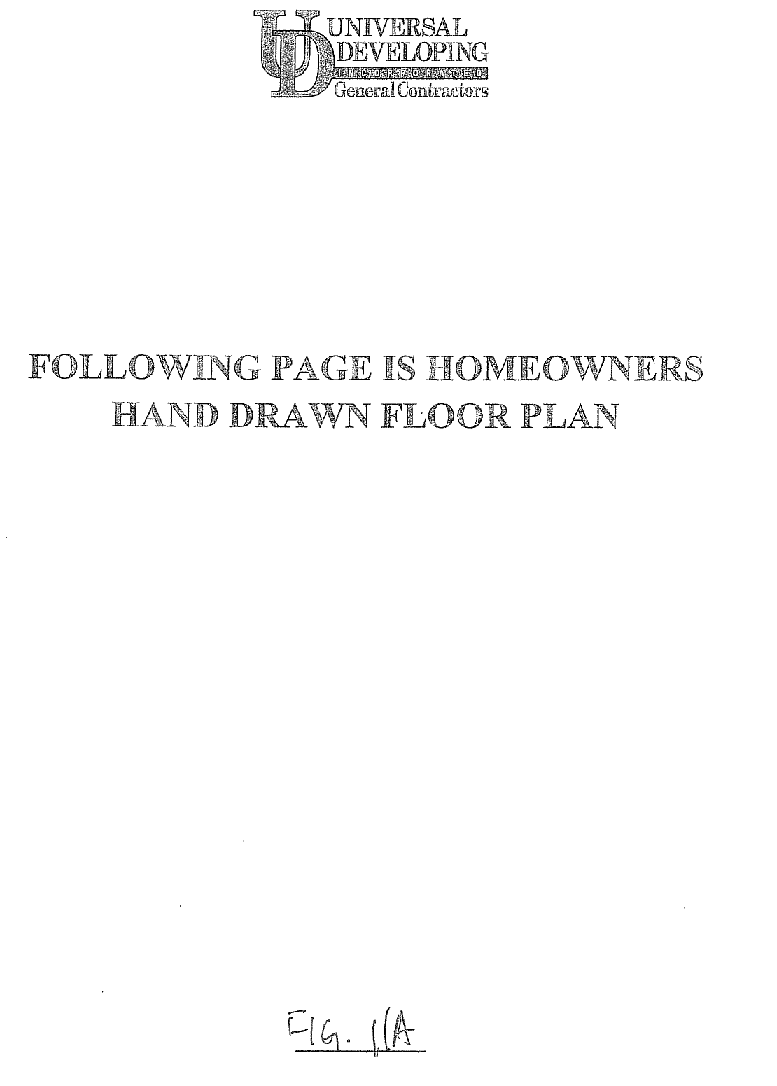

FIGS. 10A-I are representative reports from a local municipal building department including permit description of recent improvements from a typical as-built model of a building as developed from independent, verifiable and third-party resources of the present invention.

If available city or municipality planing and permit data can be utilized. Site information includes address, assessor's parcel number, and specific permit details including permit number, description of alteration, dates applied for and finalized, status data, contact information for the property owner, plan checker, contractor, insurer, etc. inspection and fee payment details include dates and fees for inspections, reviewer comments, etc.

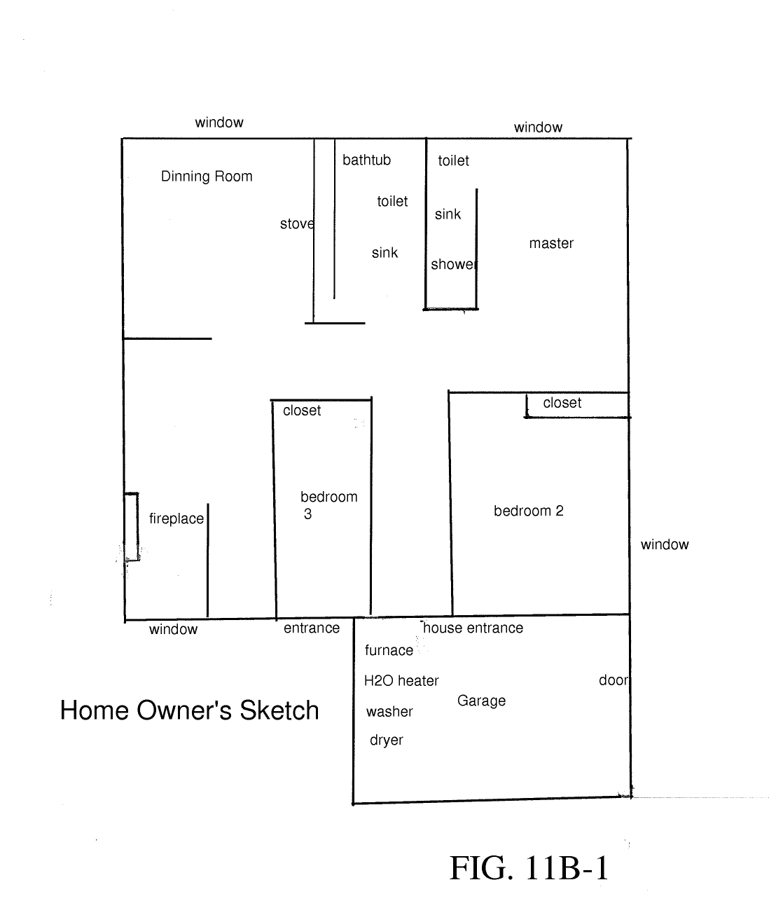

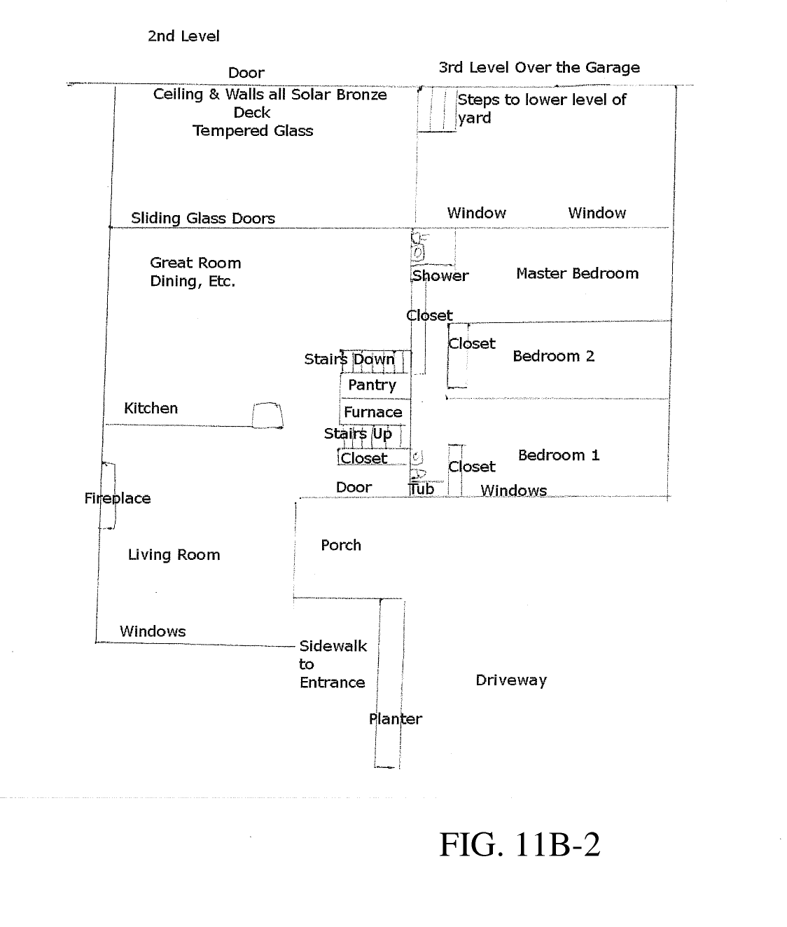

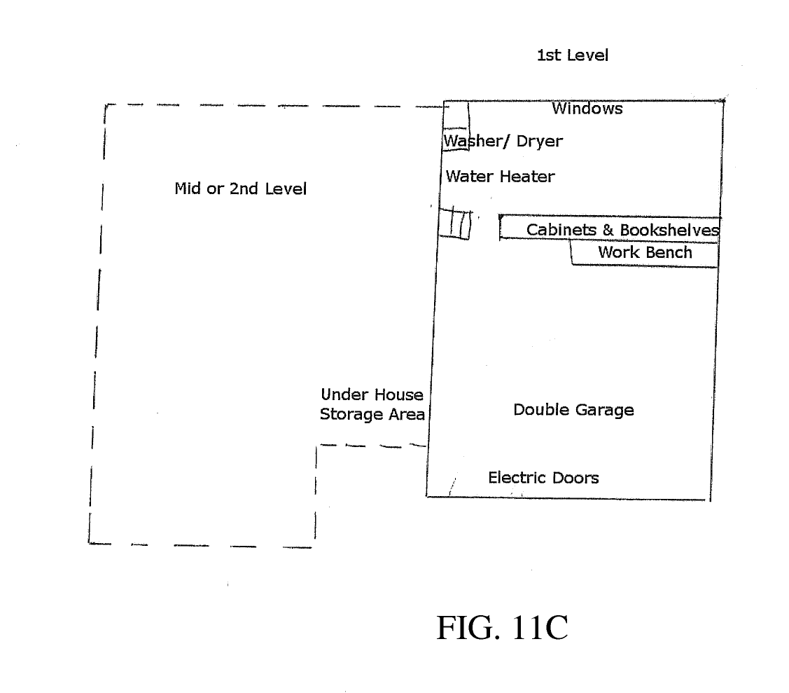

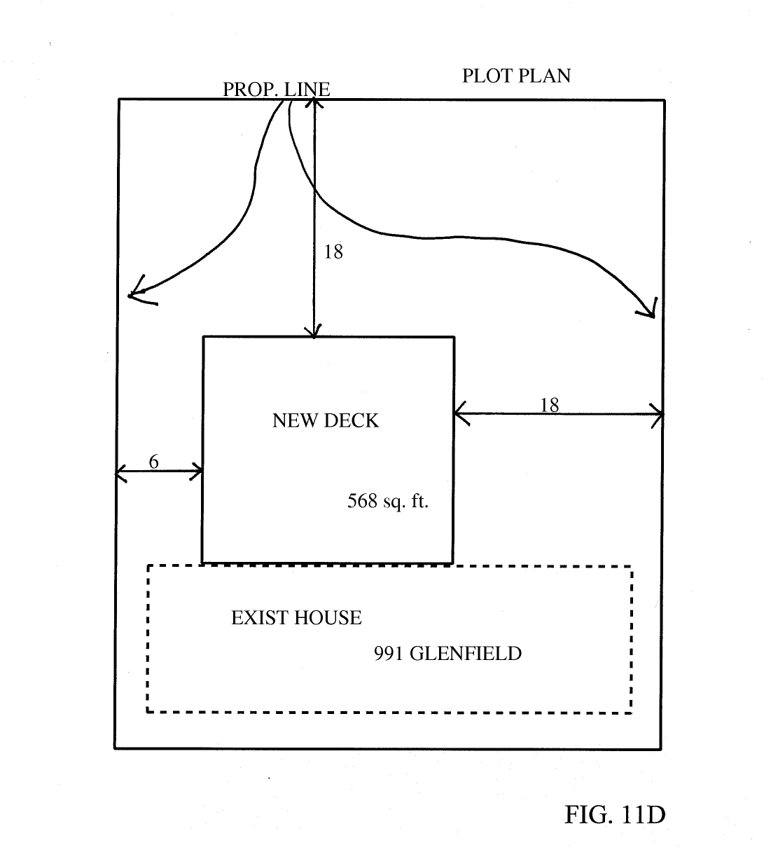

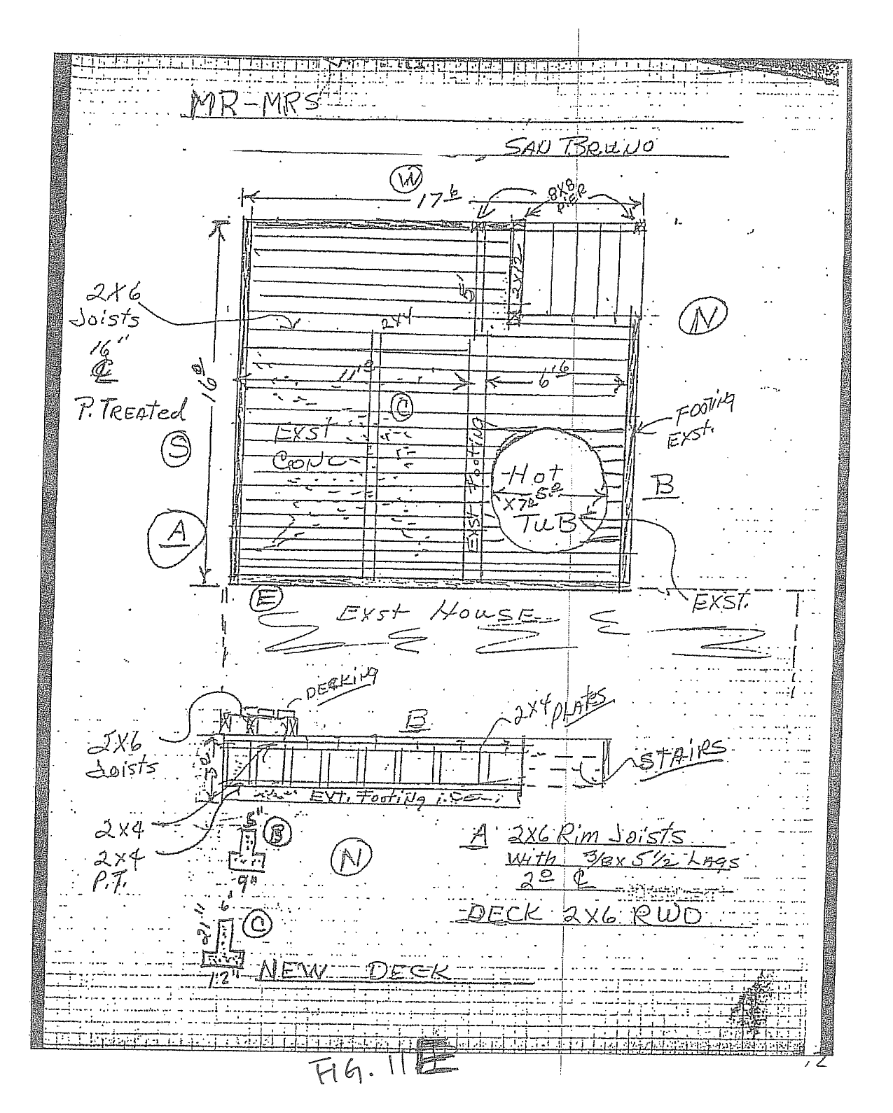

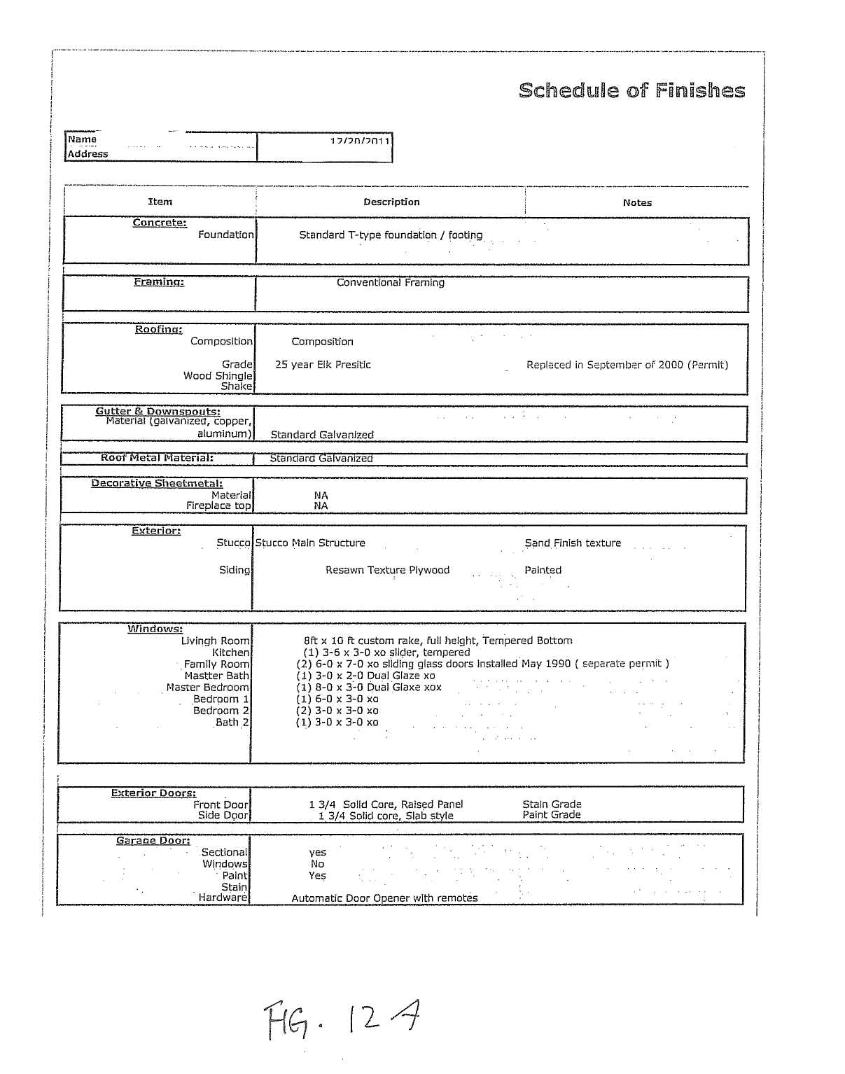

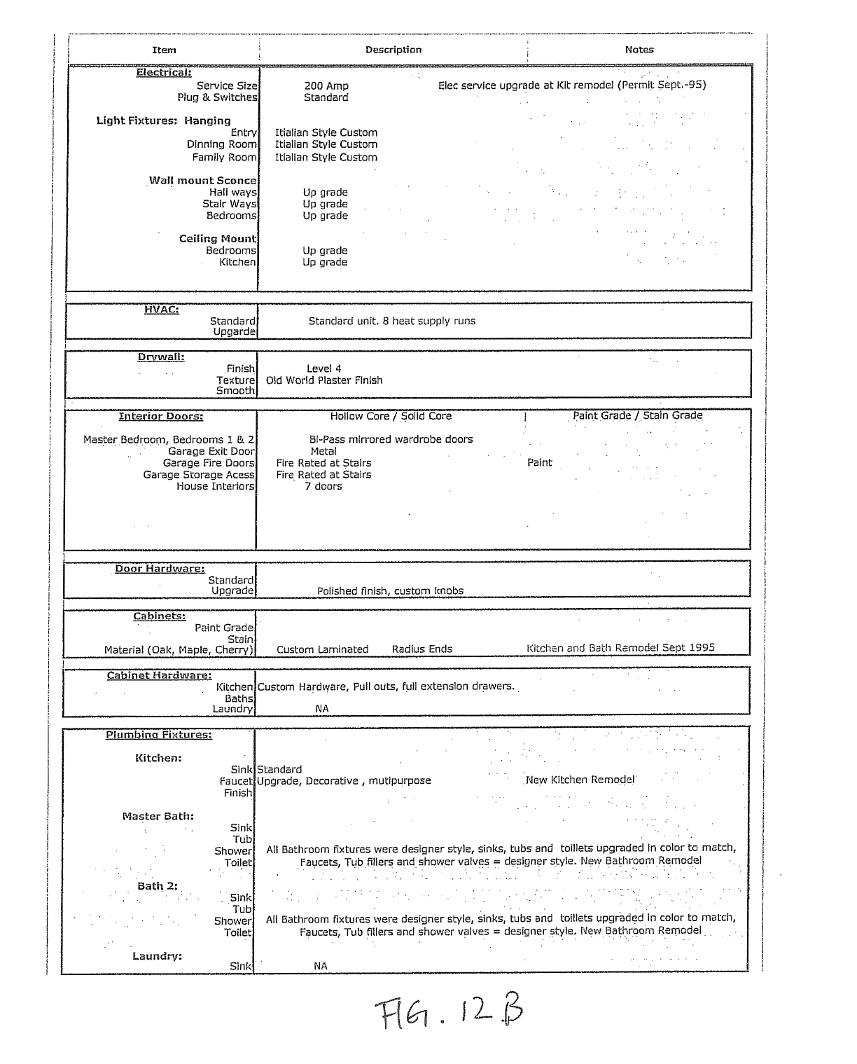

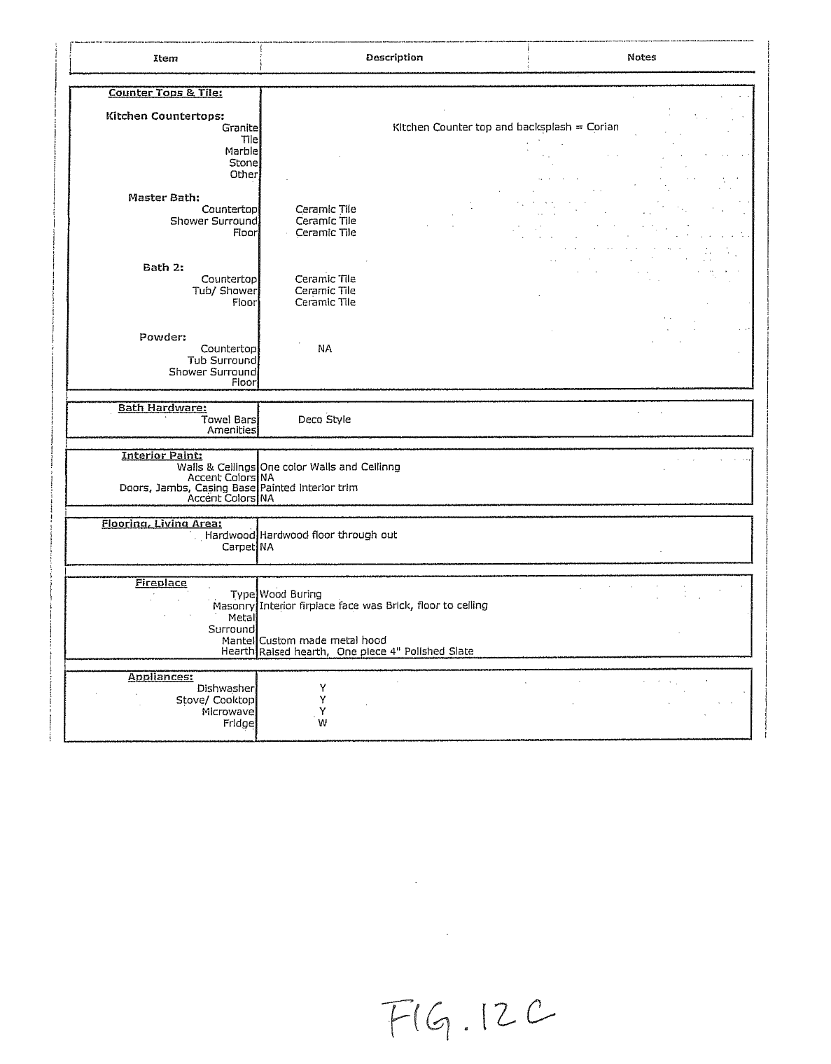

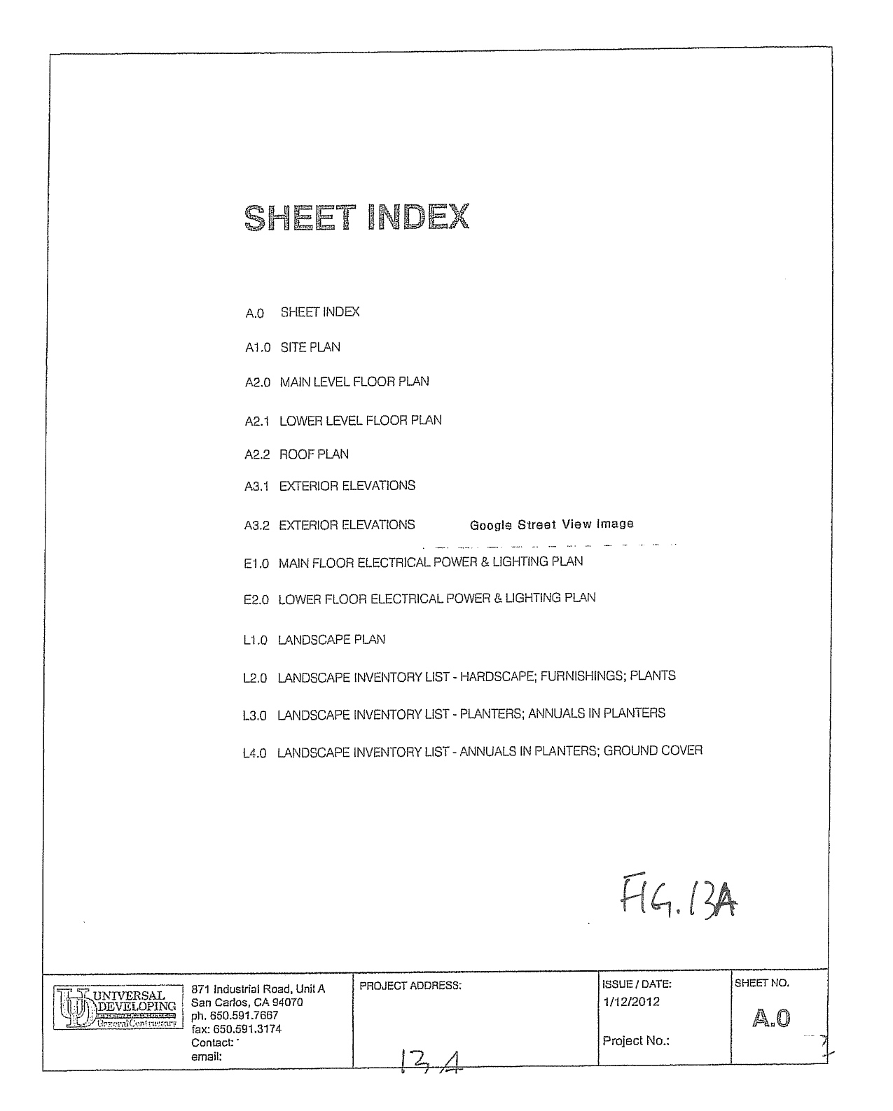

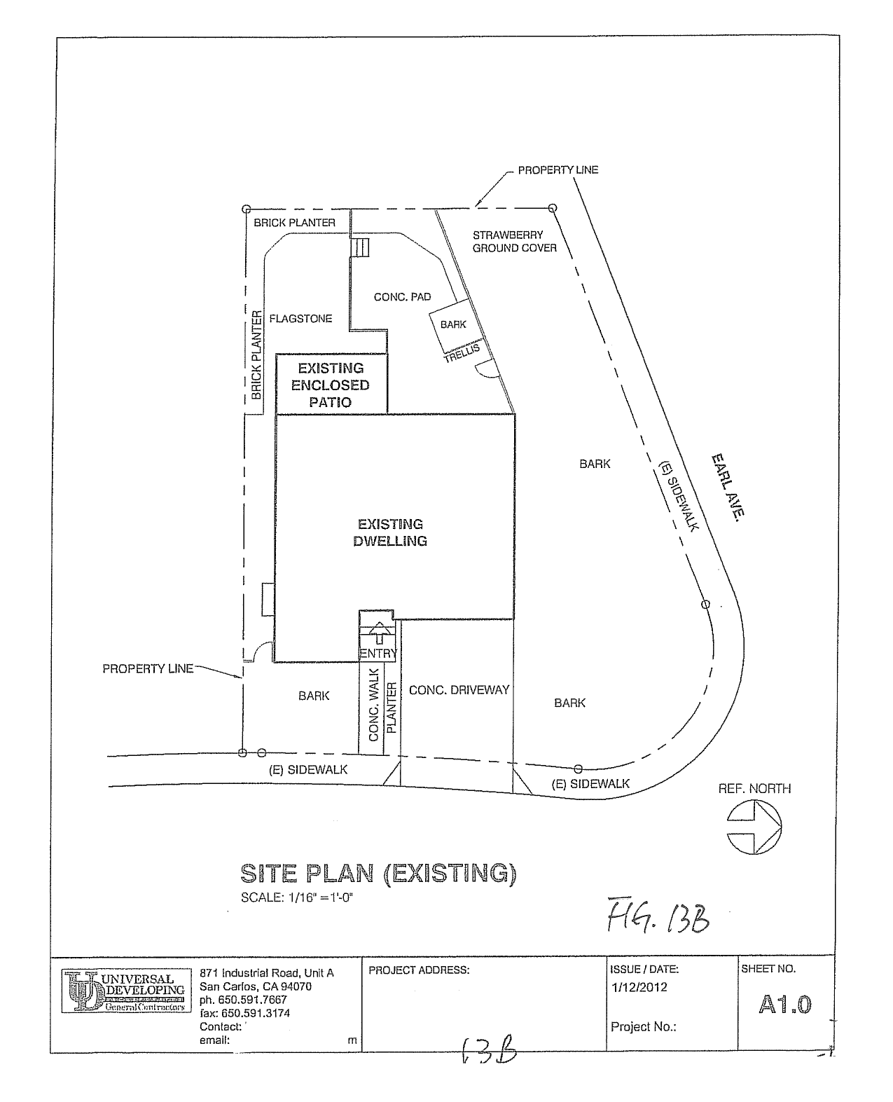

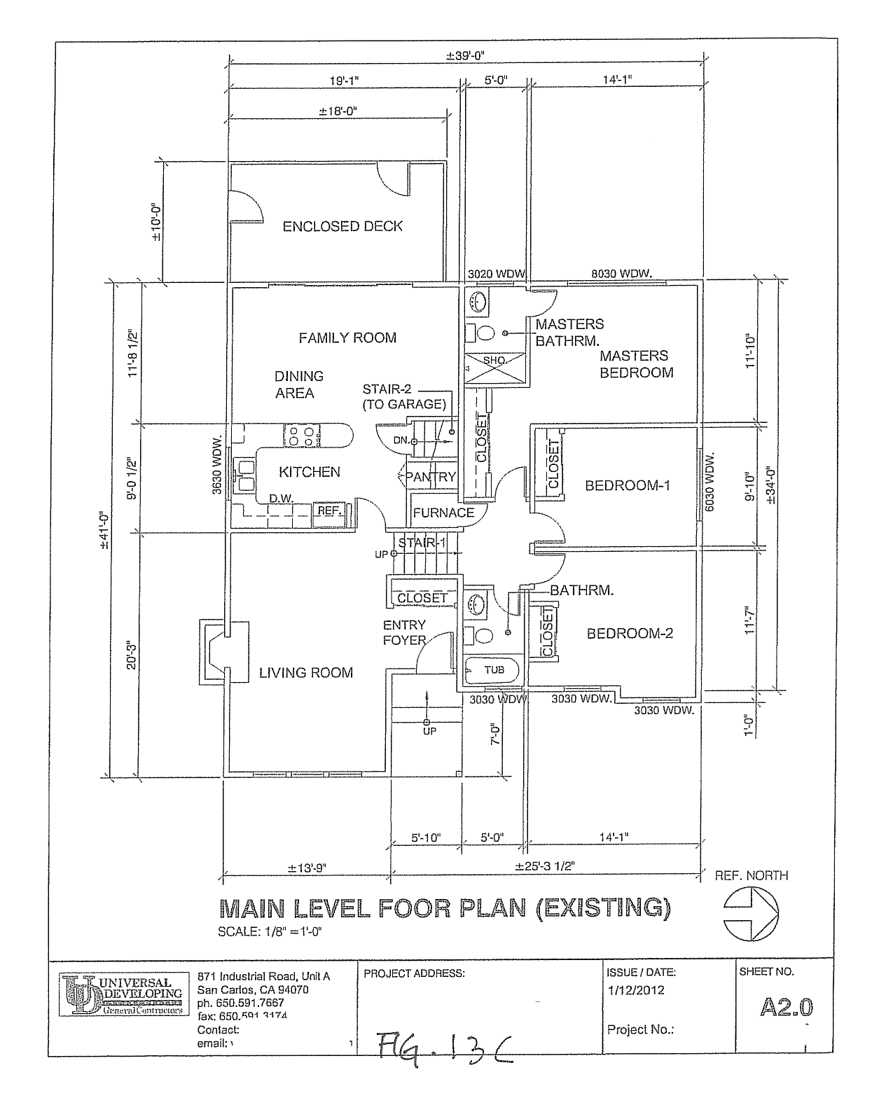

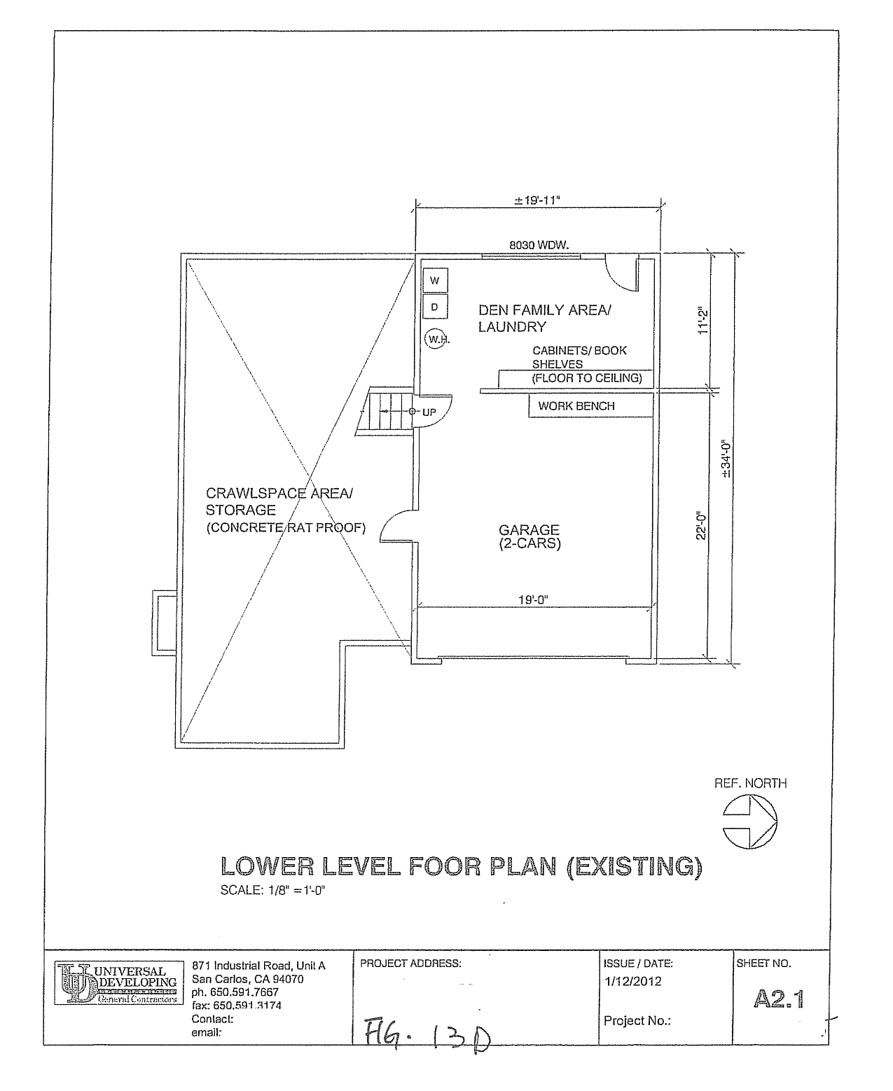

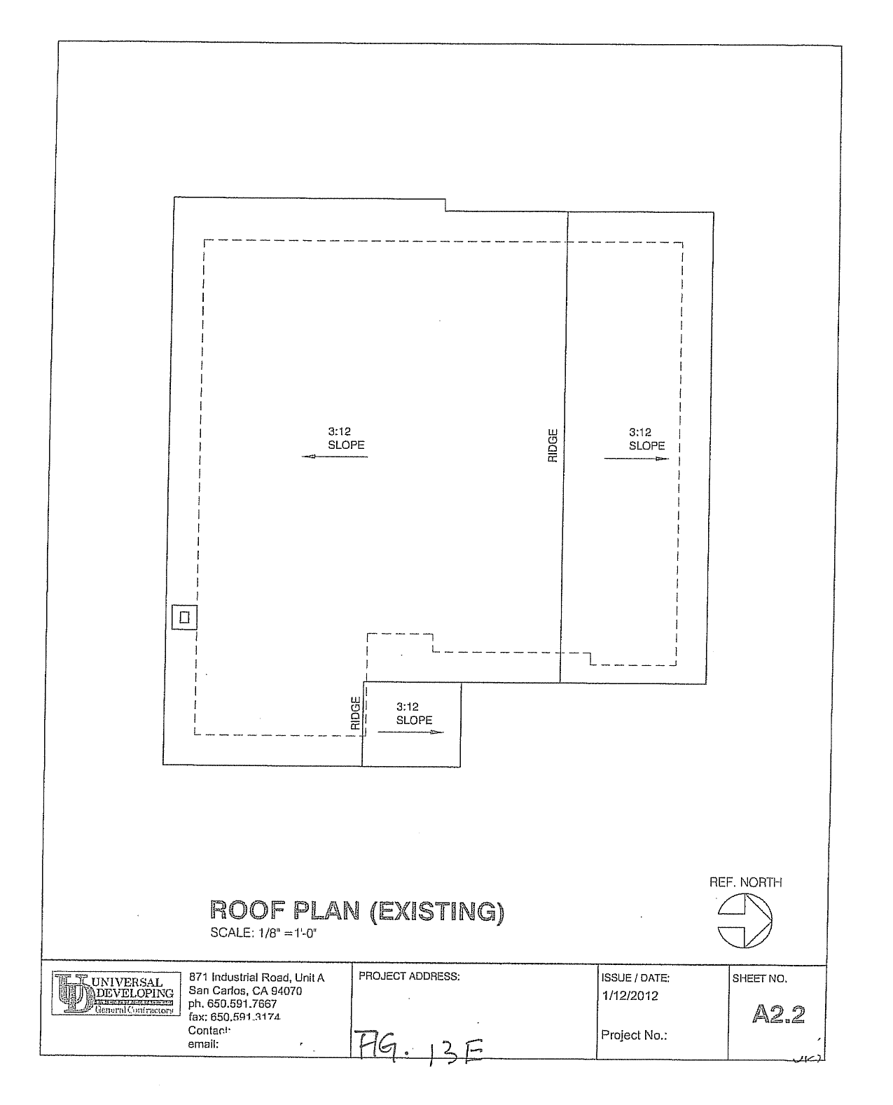

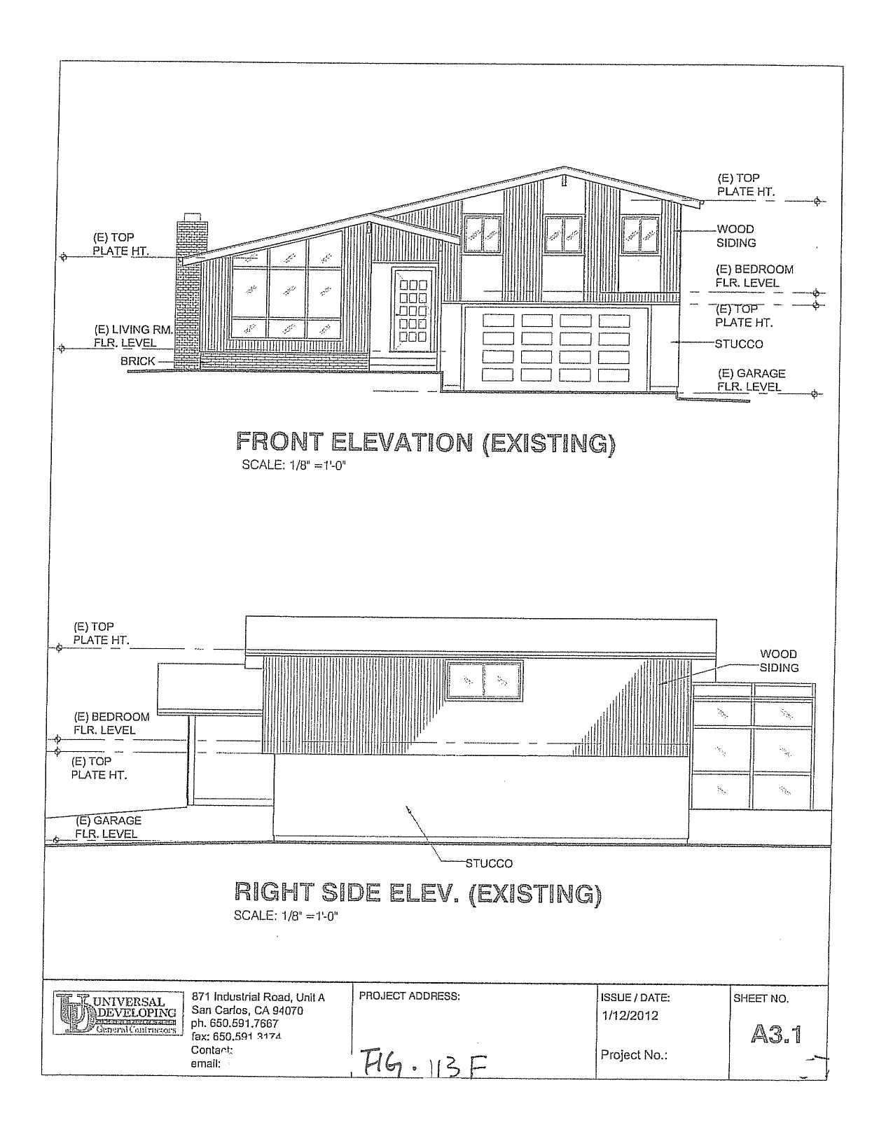

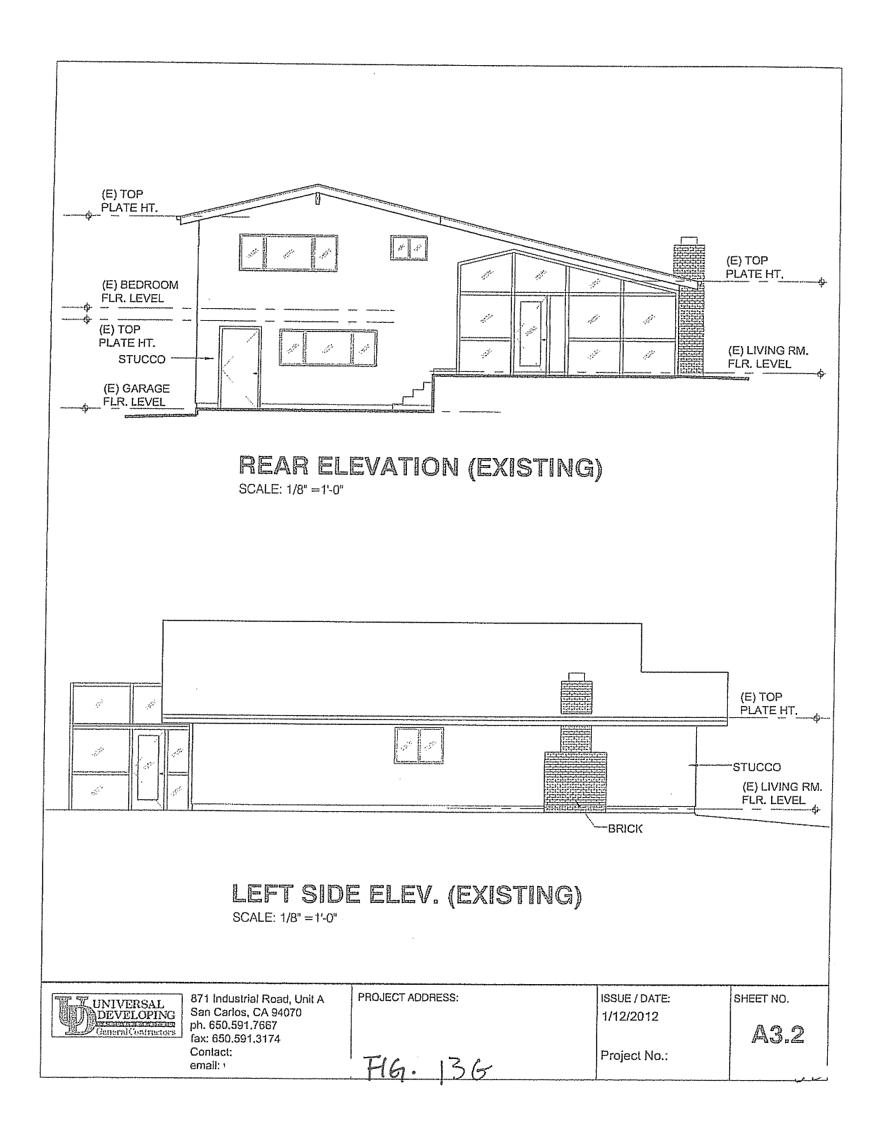

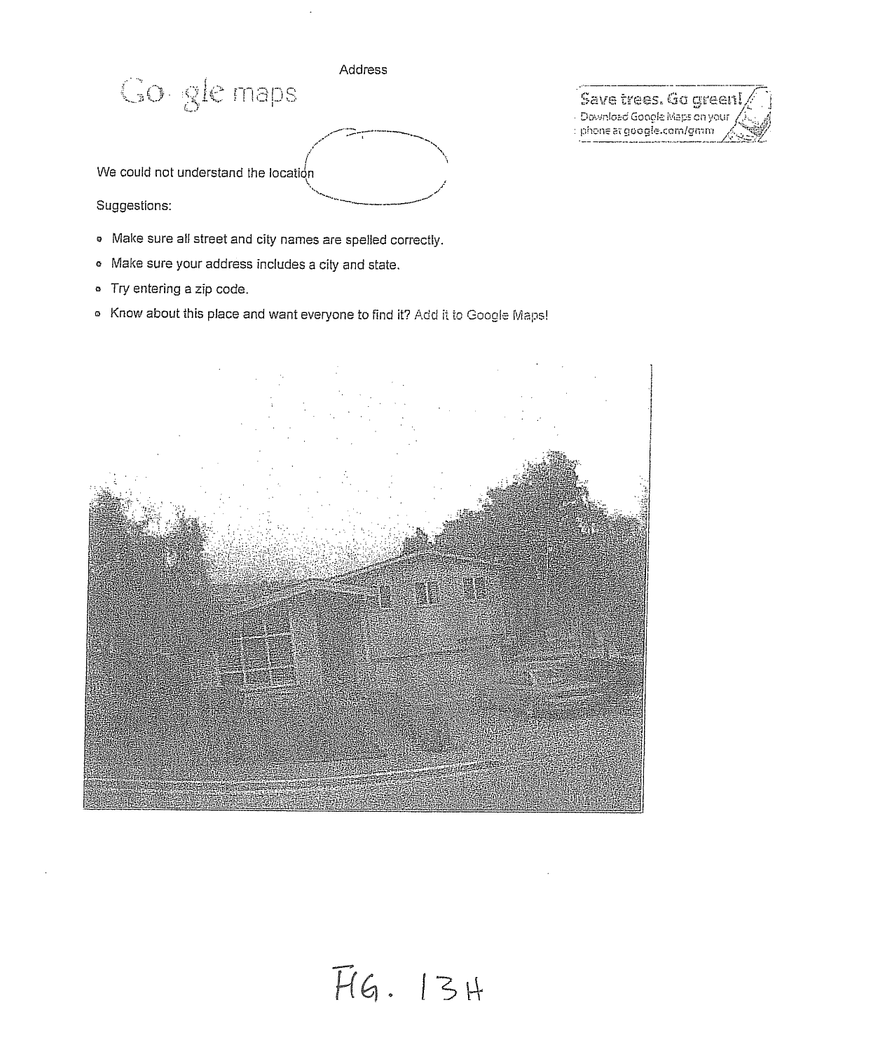

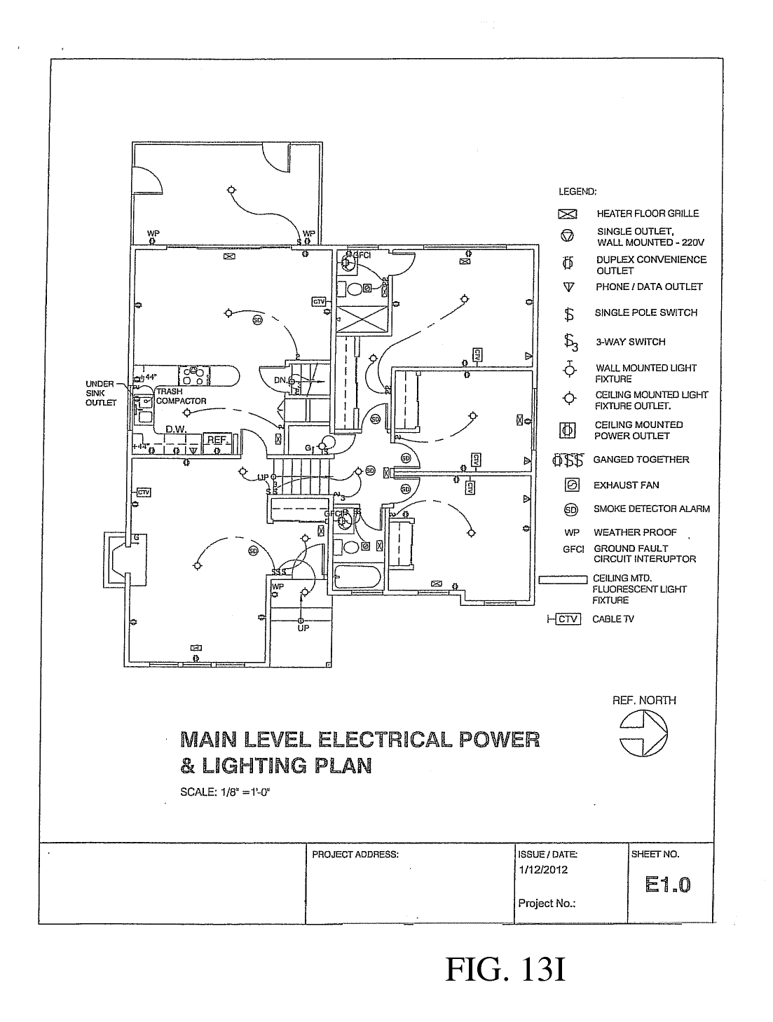

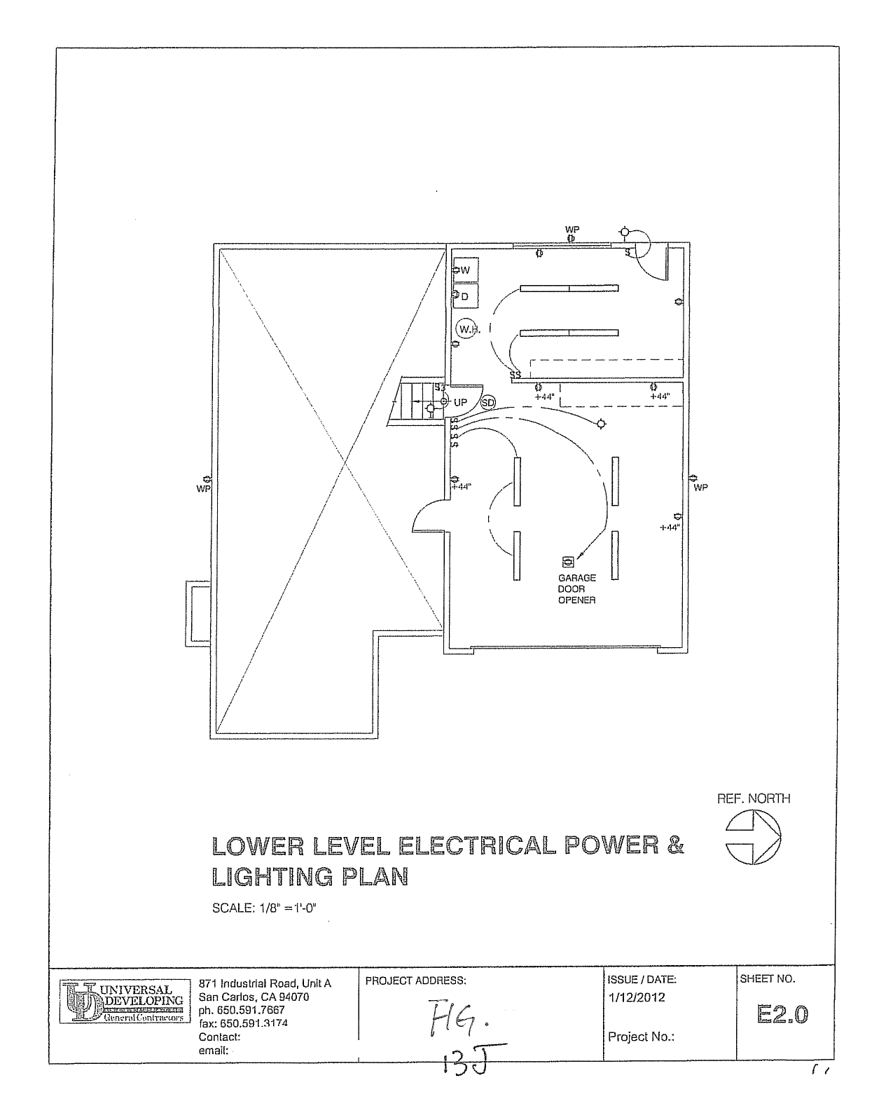

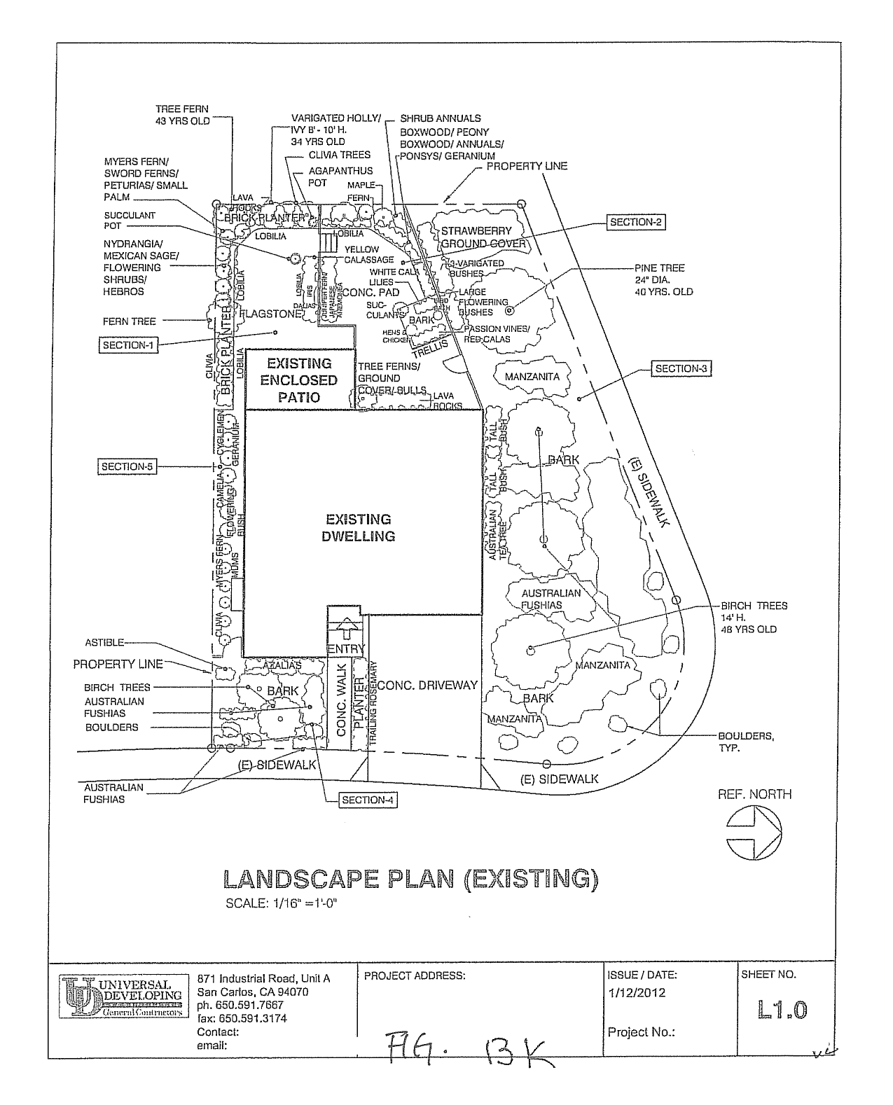

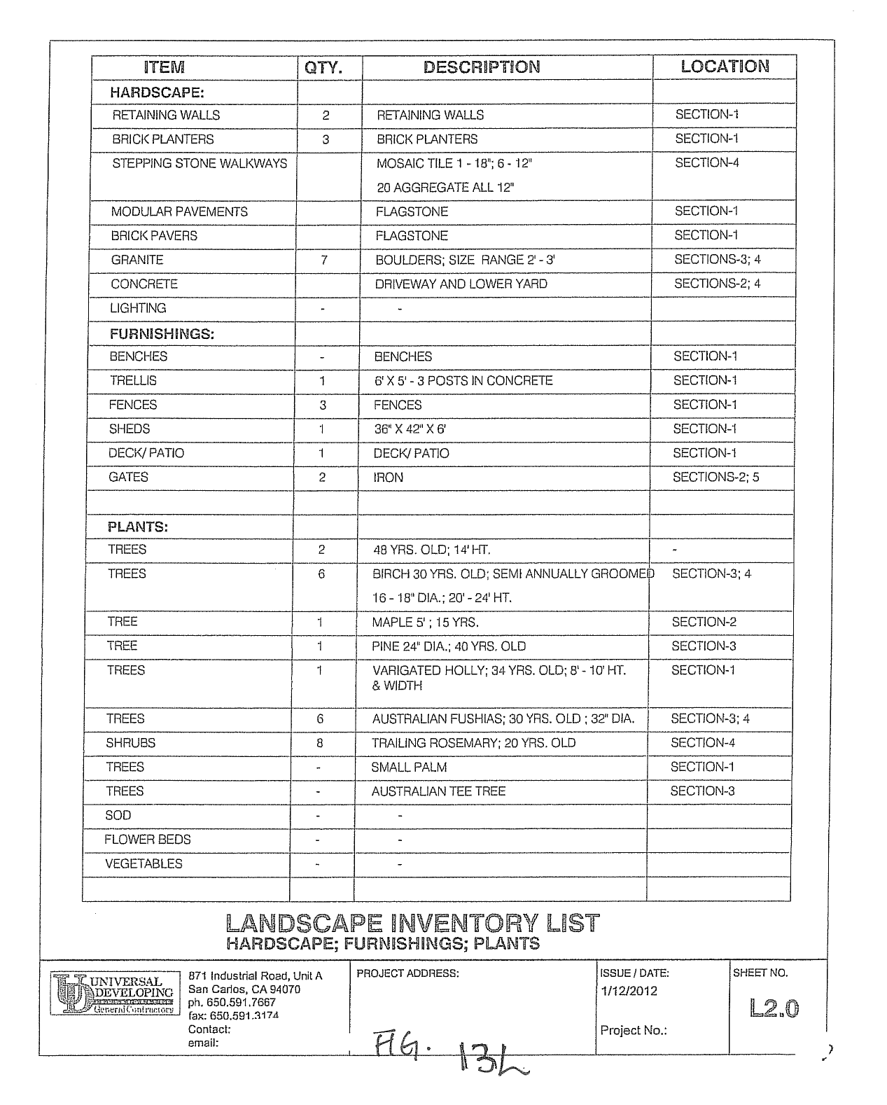

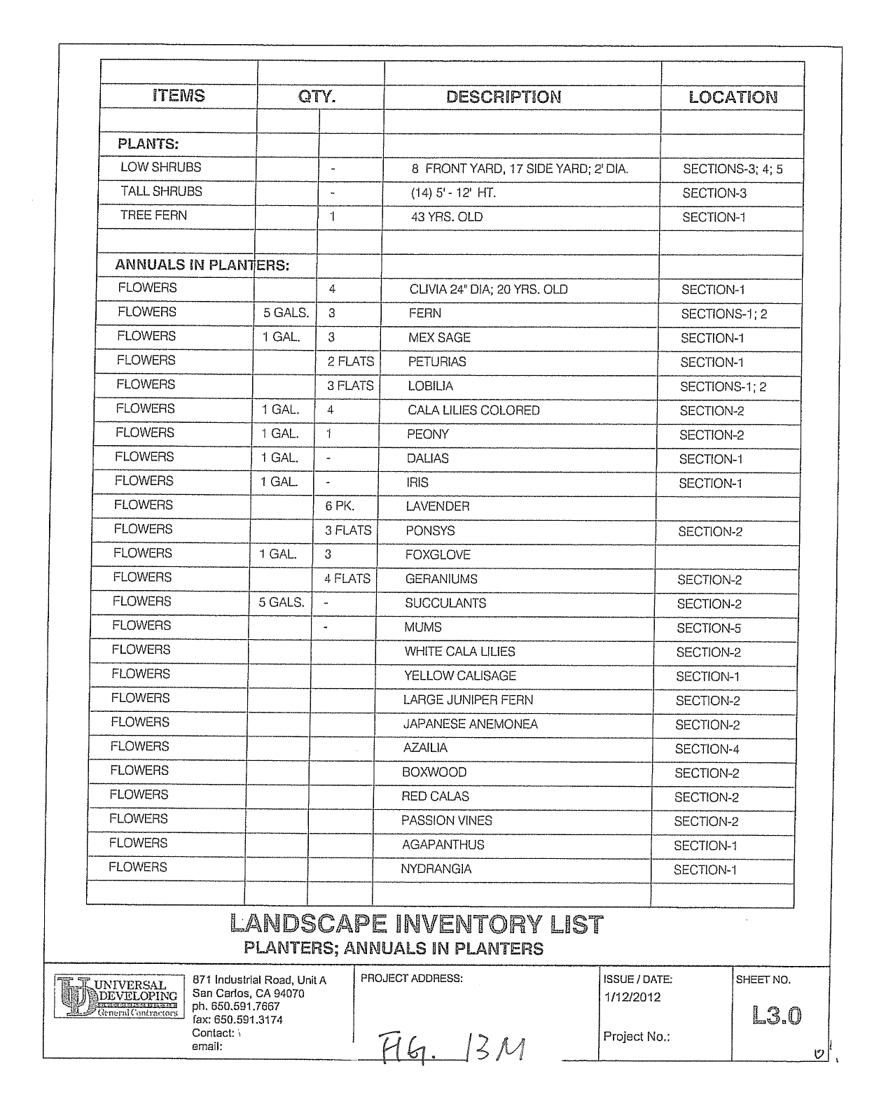

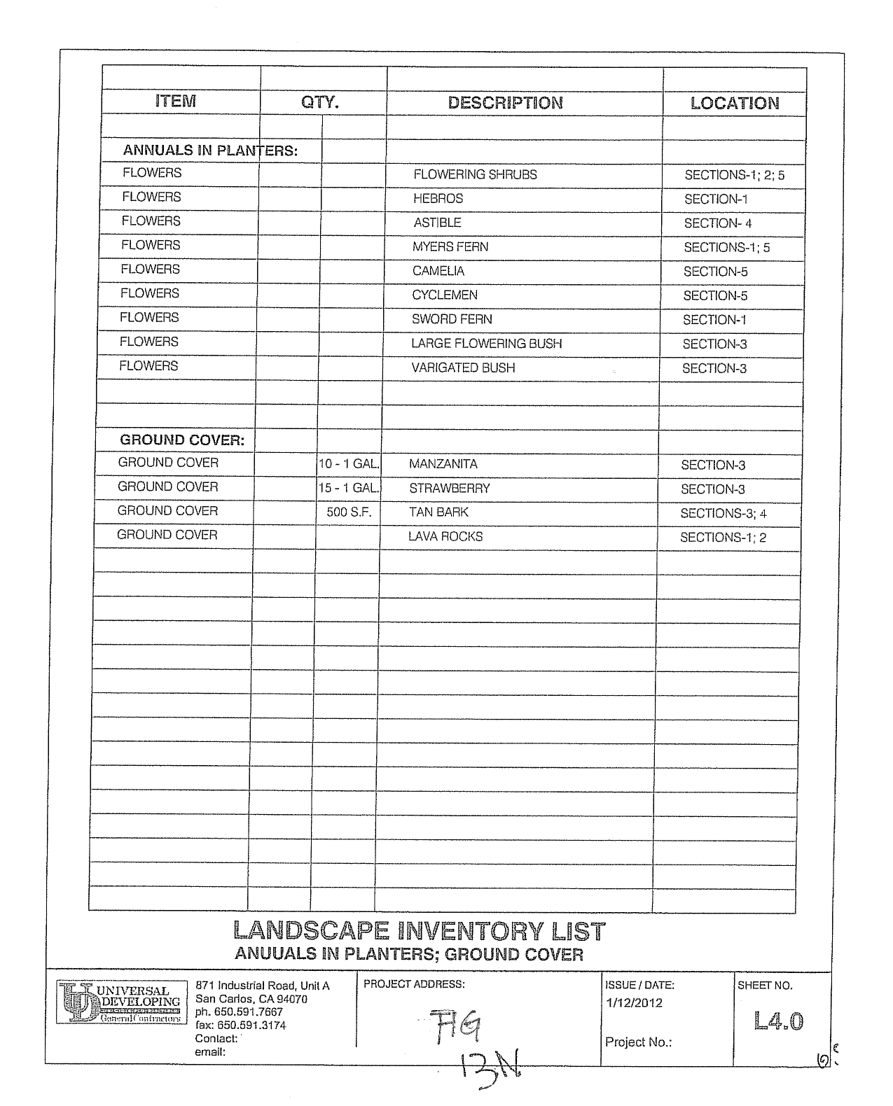

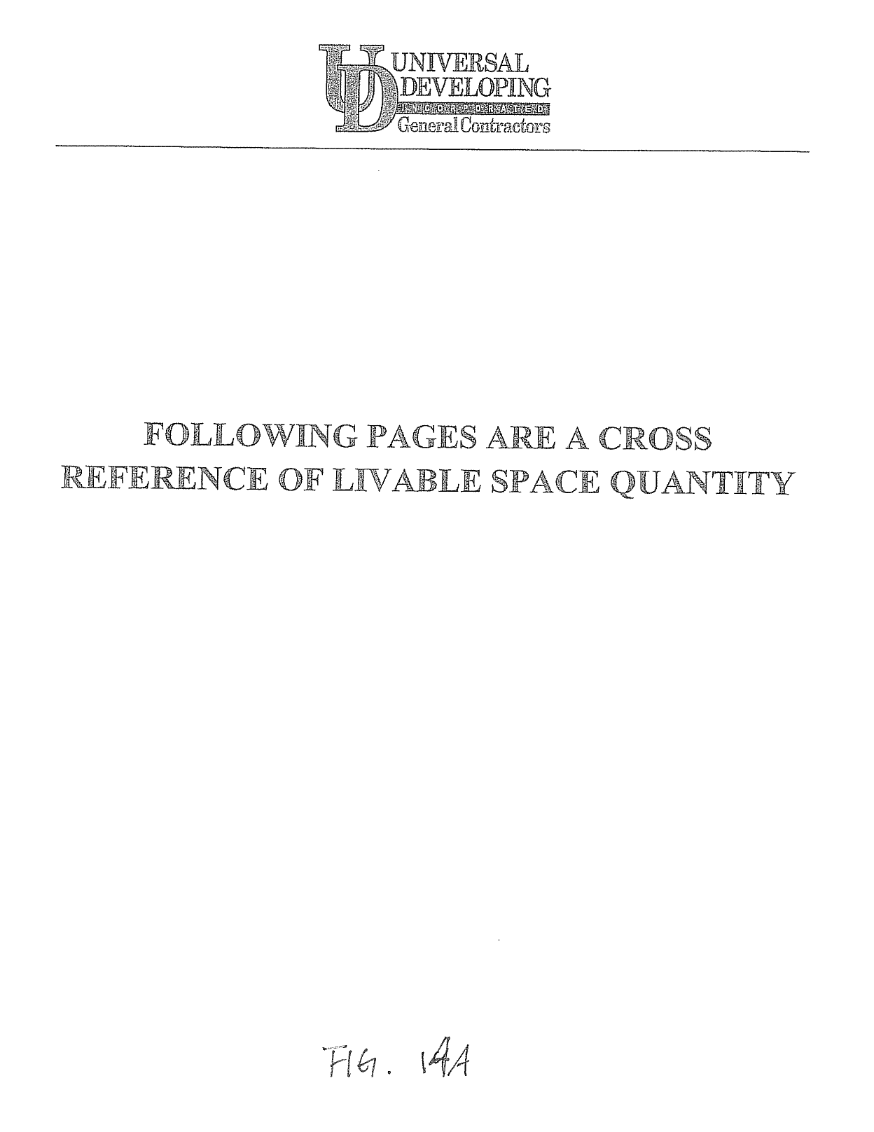

FIGS. 11A-D are representative hand-drawn floor plan sketches, such as by a home or other building owner from a typical as-built model of a building as developed from independent, verifiable and third-party resources of the present invention. In most cases, a homeowners or property owners or property managers hand sketch will provide invaluable information. These drawings could show entrances, windows, fireplaces, room locations, appliance and utility details not otherwise identified elsewhere in the physical record of the was-built property.

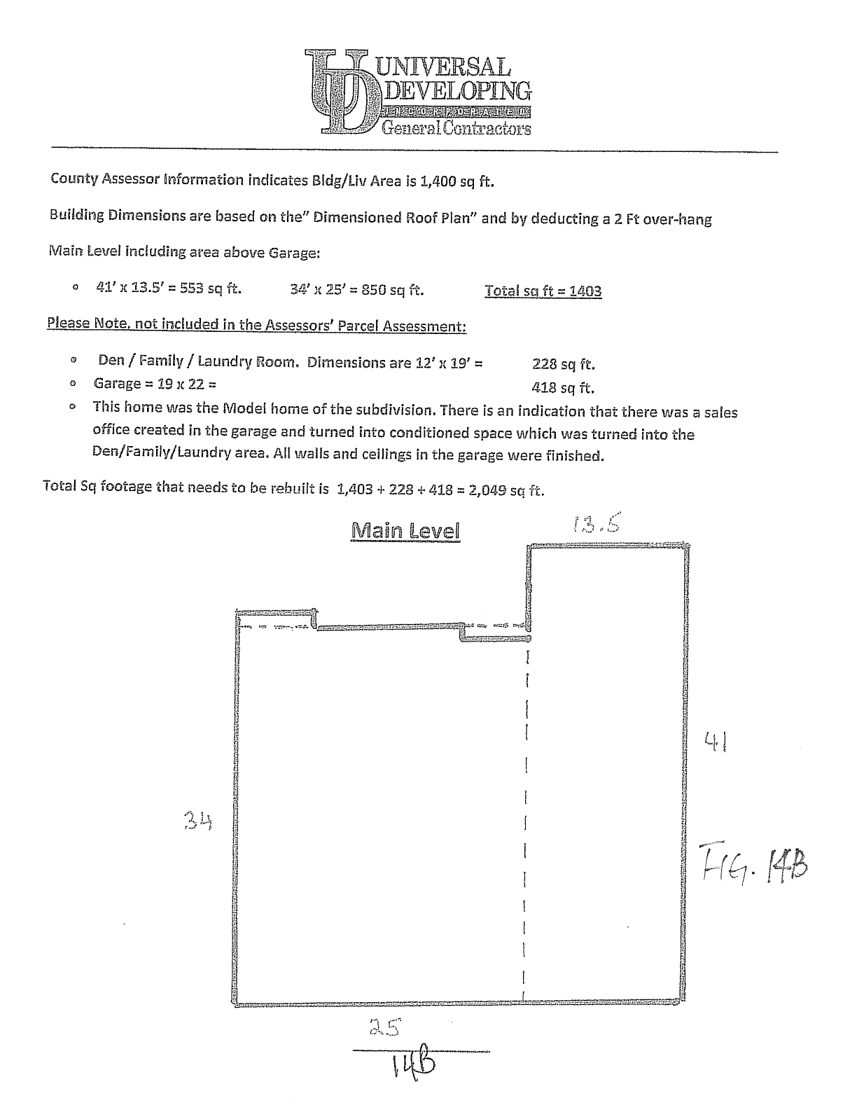

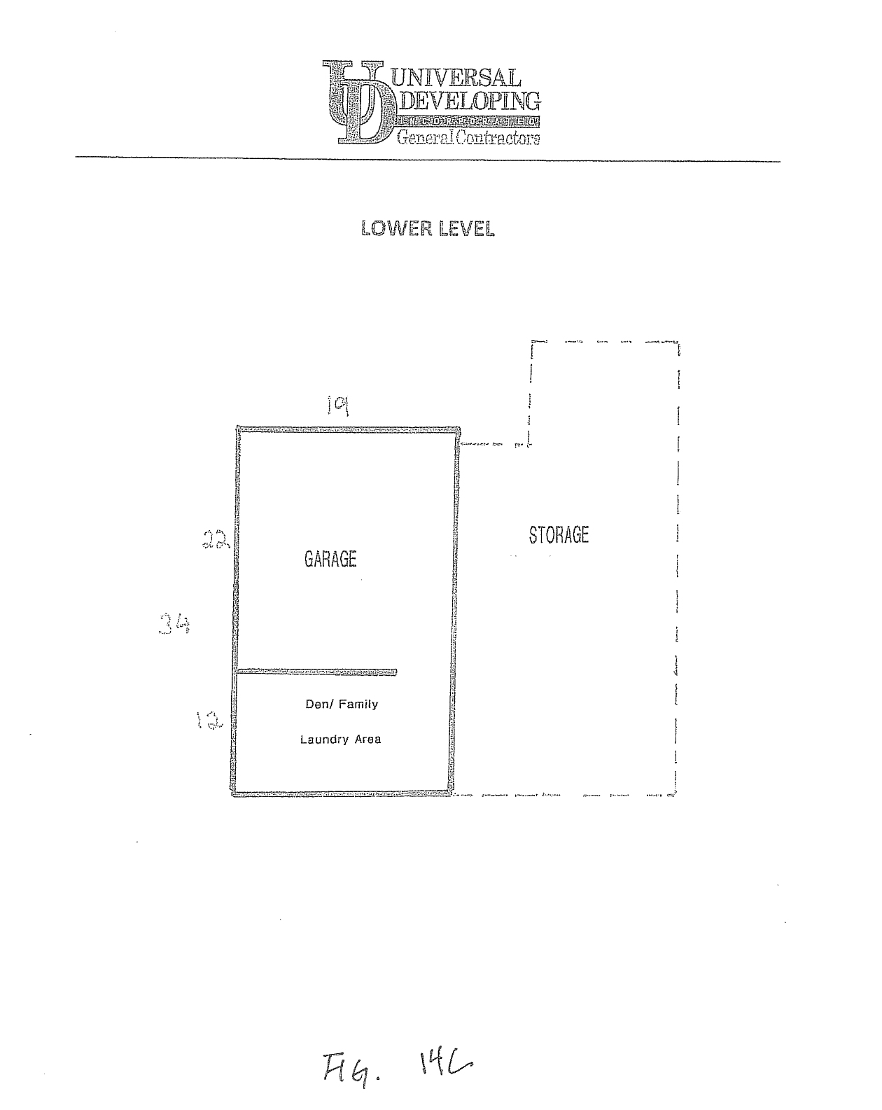

FIGS. 12A-C are representative schedules of was-built finishes from a typical as-built model of a building as developed from independent, verifiable and third-party resources of the present invention. A schedule of actual finishes must be considered, such as type of framing, concrete areas including foundation, driveways, garage slab, etc., gutter types, roof type, exterior materials, decking details, window types, interior and exterior door types, utility ratings, electrical finishes, cabinetry and plumbing finish, paint type and quality, flooring types, appliance model numbers, bath amenities, landscaping, site drainage, and hardscape such as patio and walk-ways.

FIGS. 13A-N are representative CAD sheets including index, site plan, floor plans, exterior elevations, electrical and lighting plans, landscape plans and inventory lists from a typical as-built model of a building as developed from independent, verifiable and third-party resources of the present invention. The following is a representative list of sheets as might be found in a typical reconstruction of a building:

FIG. 13A—New (CAD) Sheet Index (Floor plan from roof and owner's floor plan)

FIG. 13B—Site Plan

FIG. 13C—Main Level Floor Plan

FIG. 13D—Lower Level Floor Plan

FIG. 13E—Roof Plan

FIG. 13F—Front and Ride Side Exterior Elevations

FIG. 13G—Rear and Left Side Exterior Elevations

FIG. 13H—Street View

FIG. 13I—Main Floor Electrical Power & Lighting Plan

FIG. 13J—Lower Floor Electrical Power & Lighting Plan

FIG. 13K—Landscape Plan (Using the plot plan and Google images to re-create.)

FIG. 13L—Landscape Inventory List—Hardscape; Furnishings; Plants

FIG. 13M—Landscape Inventory List—Planters; Annuals in Planters

FIG. 13N—Landscape Inventory List—Annuals in Planters; Ground Cover

A detailed CAD floorplan can be developed based upon all of the above-referenced items. Such detailed floorplan will give actual dimensions of rooms, doorways and windows openings, closets, etc.

A 3D front (e.g., North) elevation can be generated. Often, this front elevation will be developed alongside a Google (trademark) or other photographic images. Based upon the front, side and back elevations (e.g., East, West and South) can be generated and verified. Such elevations are to scale, and provide accurate numbers of windows, doors, eaves, etc.

A floorplan with electrical layout is critical. Plumbing and HVAC layouts are also critical.

Interior elevations can be generated. These include kitchen and bathroom elevations, and appliance details. Cabinetry can be located and specified.

Elevations and site maps can be verified using an Assessor's map. Parcel map volumes are indicated, and sub-development names and reference data is used to verify the construction plan.

The landscape plan of FIG. 13K showing previously existing conditions can be generated using the plot plan and Google (trademark) or other photographic images which exist. The landscape plan shows front and side lawns and planting, backyard lawn and planting, and retaining walls, flower beds, water features, etc. The landscape schedule of finishes FIG. 13L-N is a detailed list of the elements shown in the landscape plan.

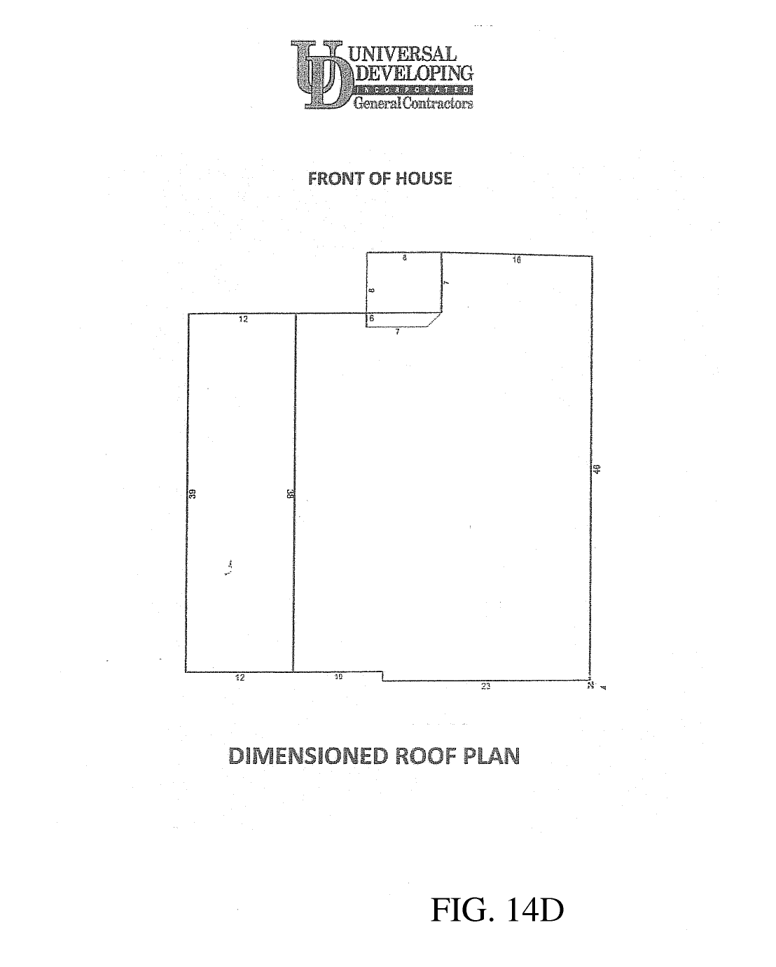

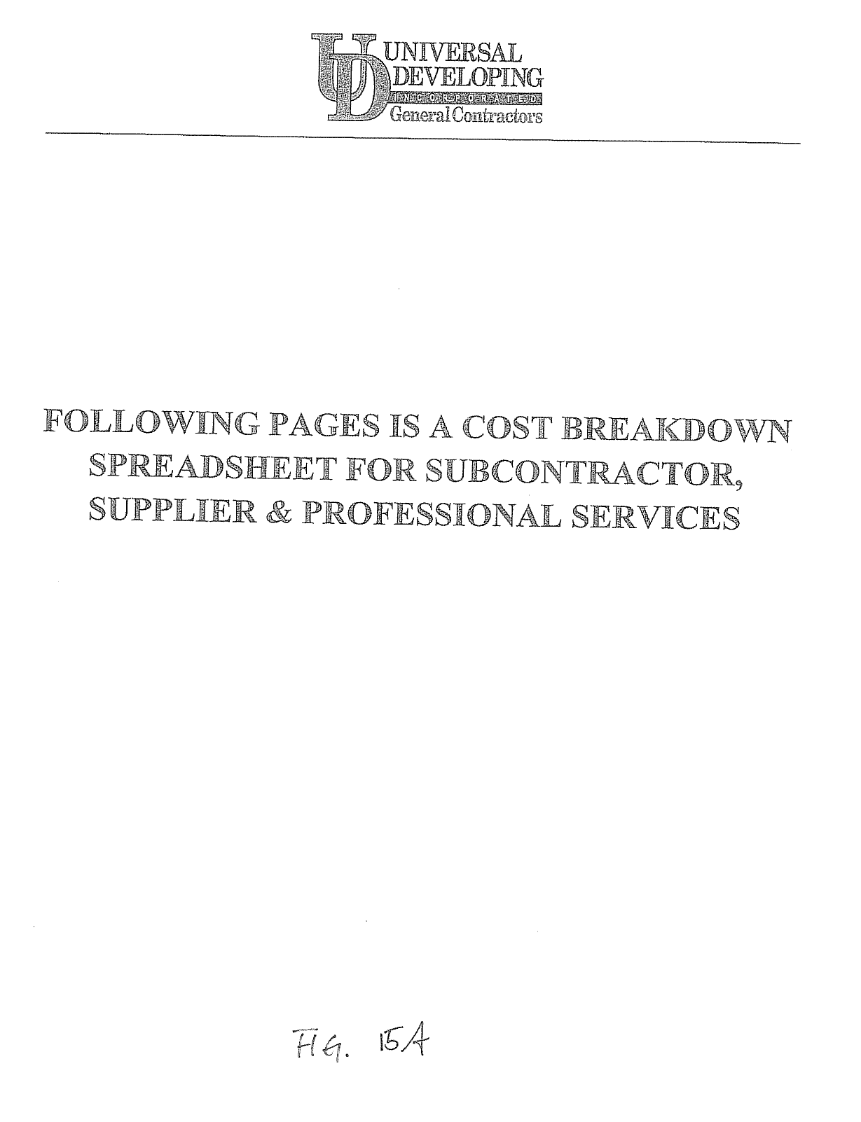

FIGS. 14A-D are representative cross references of livable space quantities compared to County Assessor's office information from a typical as-built model of a building as developed from independent, verifiable and third-party resources of the present invention.

A site plan to scale is then generated. This provides geographical orientation, property line data, setback data, footprint and other zoning details. In essence, the footprint of the previously existing building can be determined exactly and precisely based upon the assessors site map, etc. the house is plotted to the parcel map.

A contractor's verification of coverage can be a cross-check against aerial views, generated reports, and insurance estimates. In one case, a contractor's verification resulted in a difference of 30 square feet out of a total of 1700 square feet constructed.

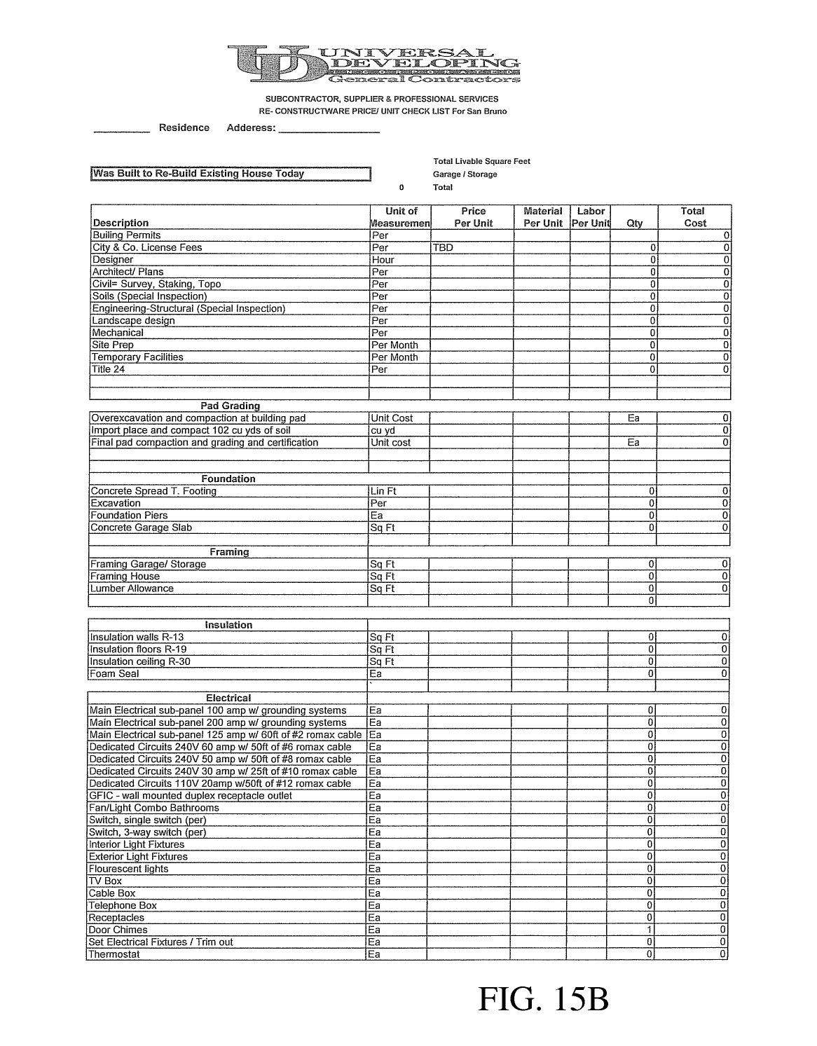

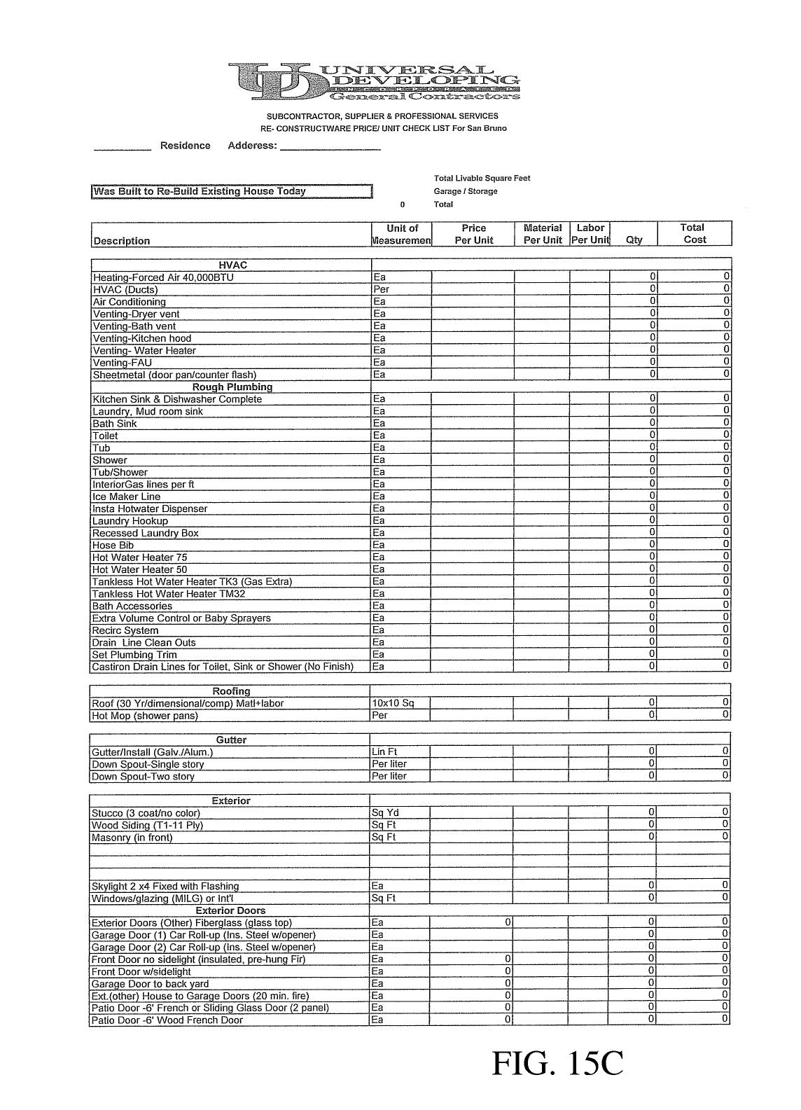

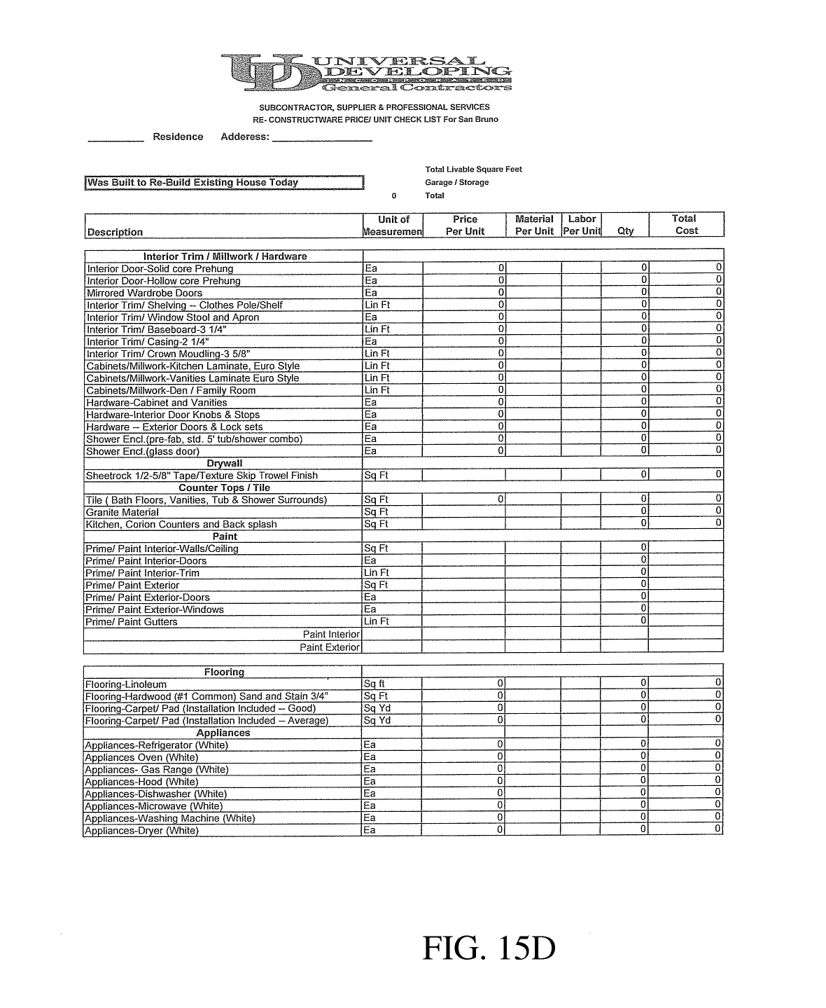

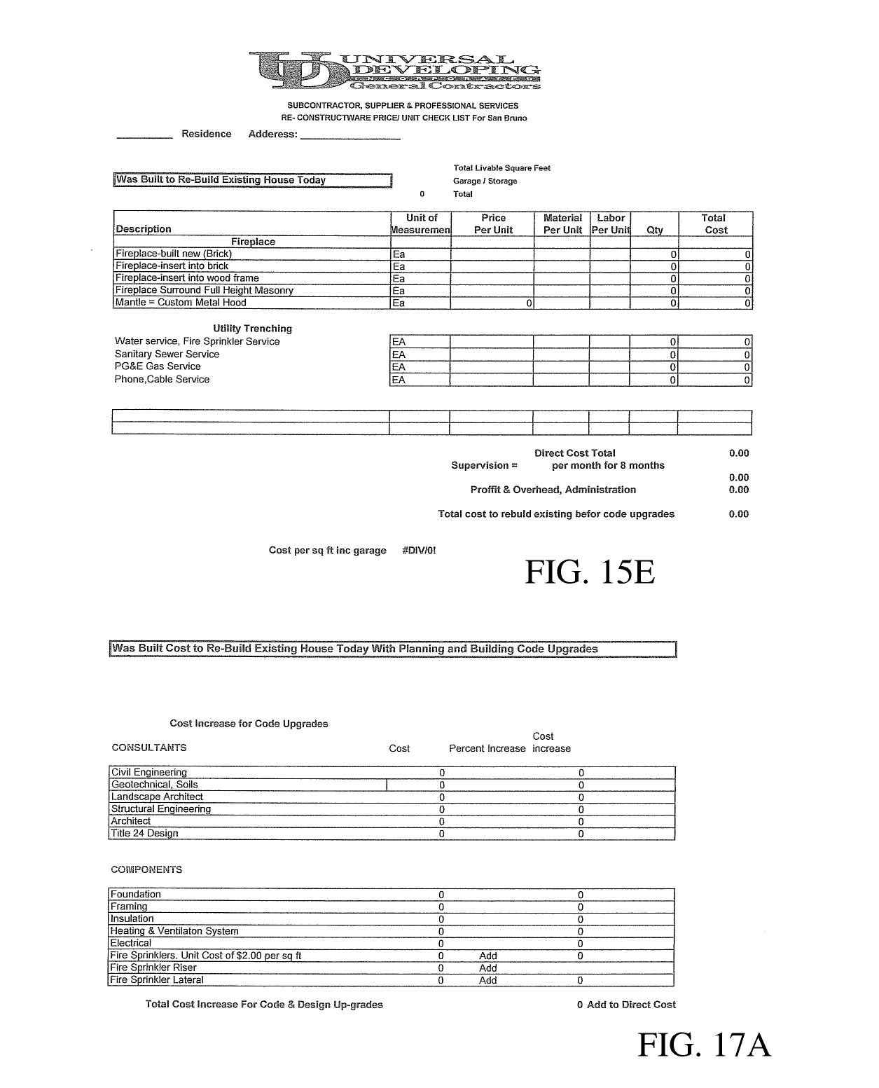

FIGS. 15A-E are representative cost breakdown for subcontractor, supplier & professional services unit price spread sheets from a typical as-built model of a building as developed from independent, verifiable and third-party resources of the present invention.

From all of the above, a detailed checklist of subcontractor, supplier and professional services price and units can be developed. This detailed checklist will include line items with prices. Typical line items include but are not limited to building permits, license fees, designer and architect fees, survey costs, engineering, site prep, temporary facilities, Title 24 compliance, framing, concrete foundation and garage slab costs, roof and gutters, downspouts, insulation for floors, ceiling and walls, siding including stucco and wood, skylights and windows, exterior doors, garage doors, patio doors, electrical main and sub panels, dedicated circuits, GFIC and fans, lights and interior and exterior lighting and switches, phone, cable, ventilation costs, interior doors and trim, cabinets, hardware details, shower and bathroom appliances, kitchen appliances, sinks, tubs, showers, gas lines, laundry hookups, water heaters, HVAC specifications, sheetrock and tile, counters, prime, wall and trim paints, interior and exterior paints, flooring such as hardwood, carpeting, tiles, kitchen appliances such as oven, refrigerator, dishwasher, microwave, washing machine and dryers, fireplace inserts or built, mantles, air conditioning, heaters, fencing, masonry, landscape, site drainage and interior amenities.

FIG. 16 is a representative list of cost adjustments for building and planning code upgrades from a typical as-built model of a building as developed from independent, verifiable and third-party resources of the present invention.

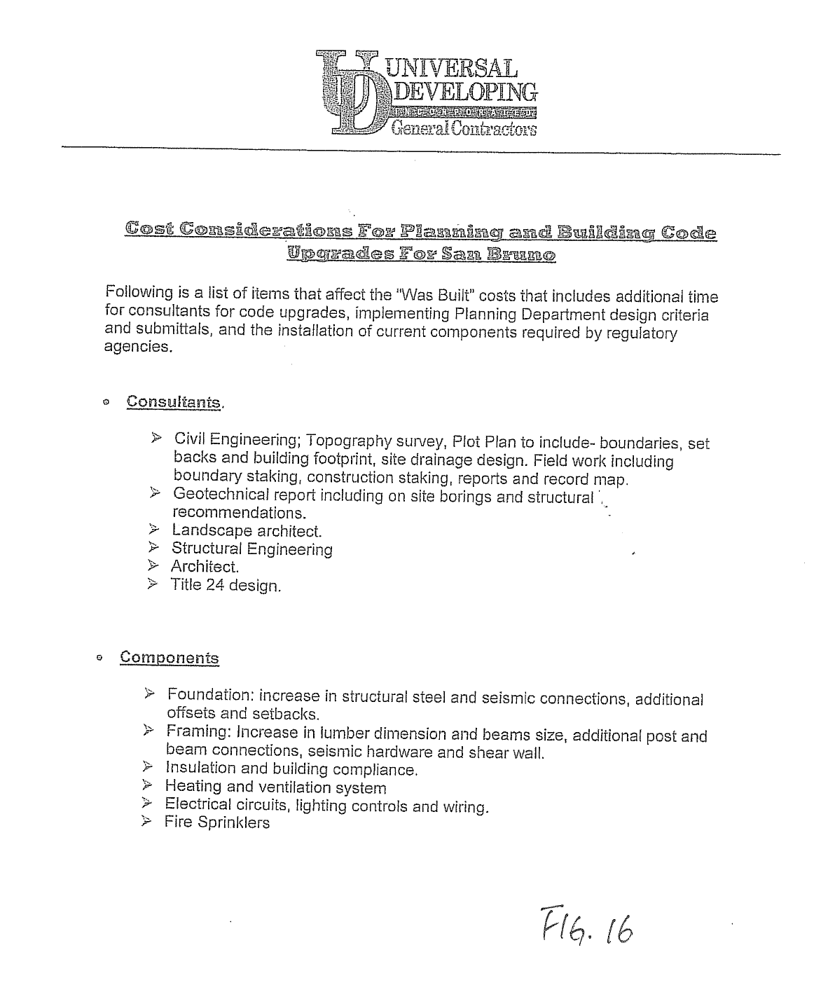

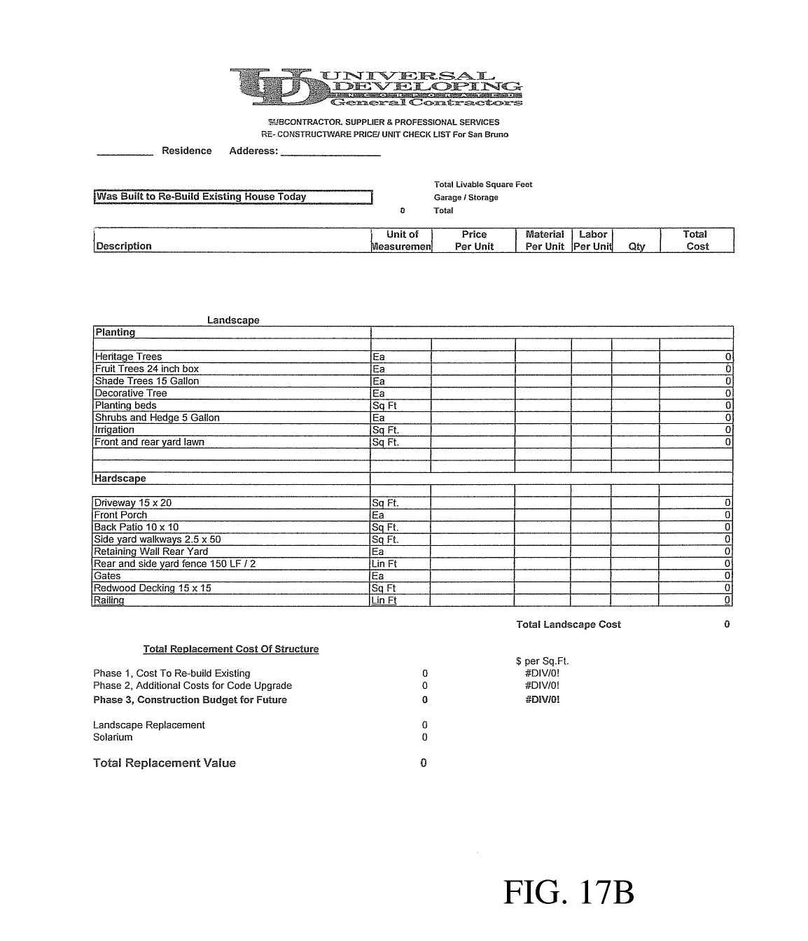

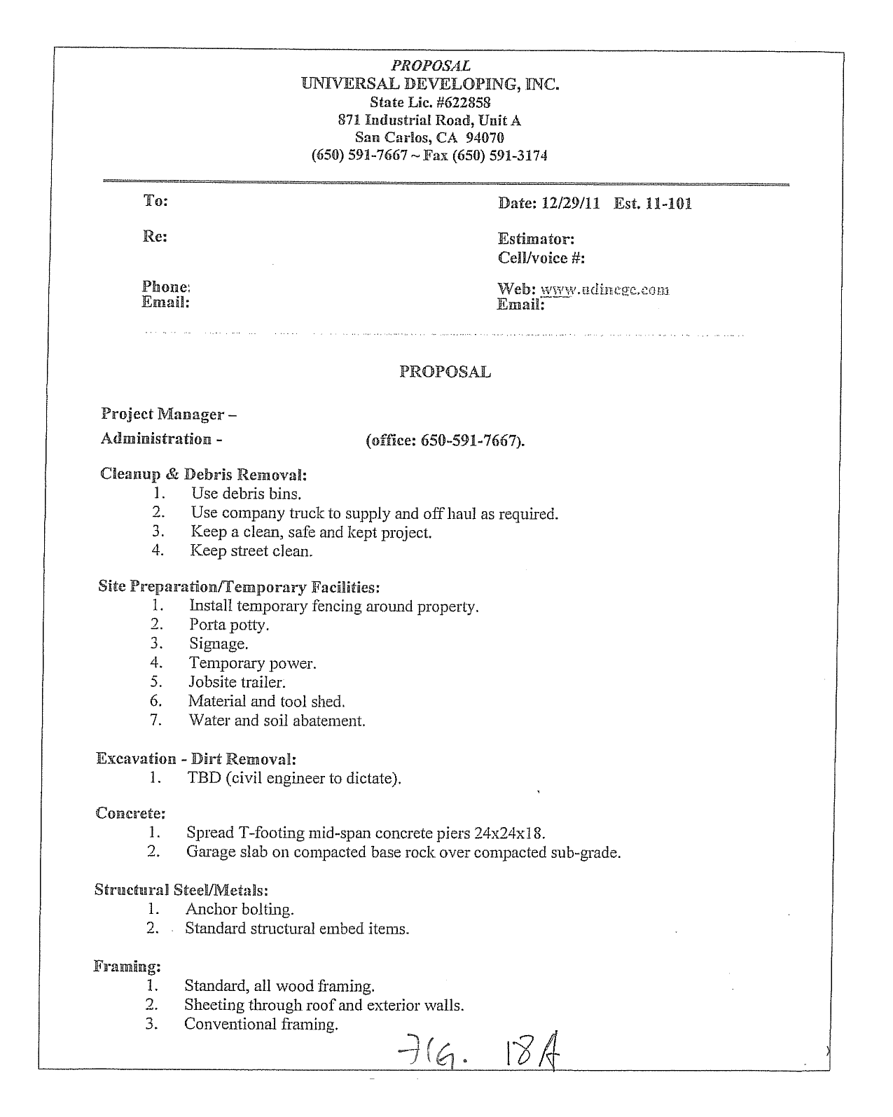

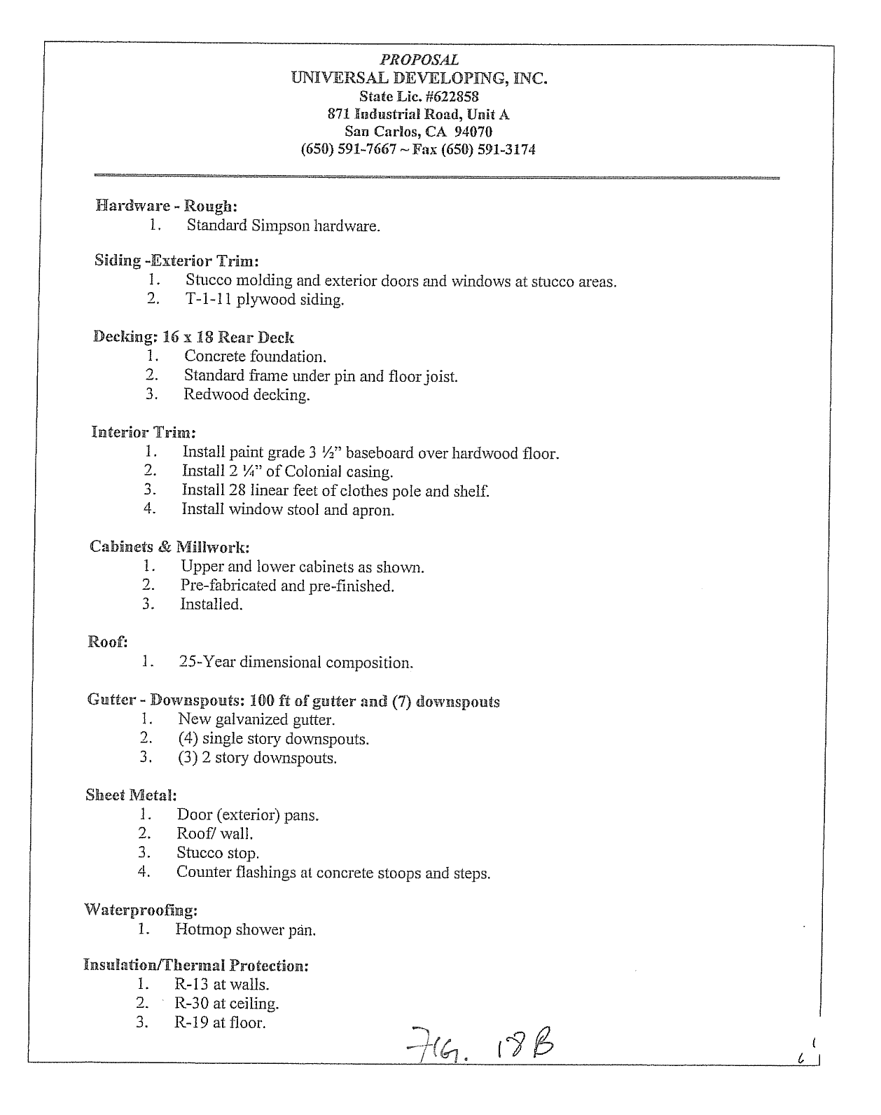

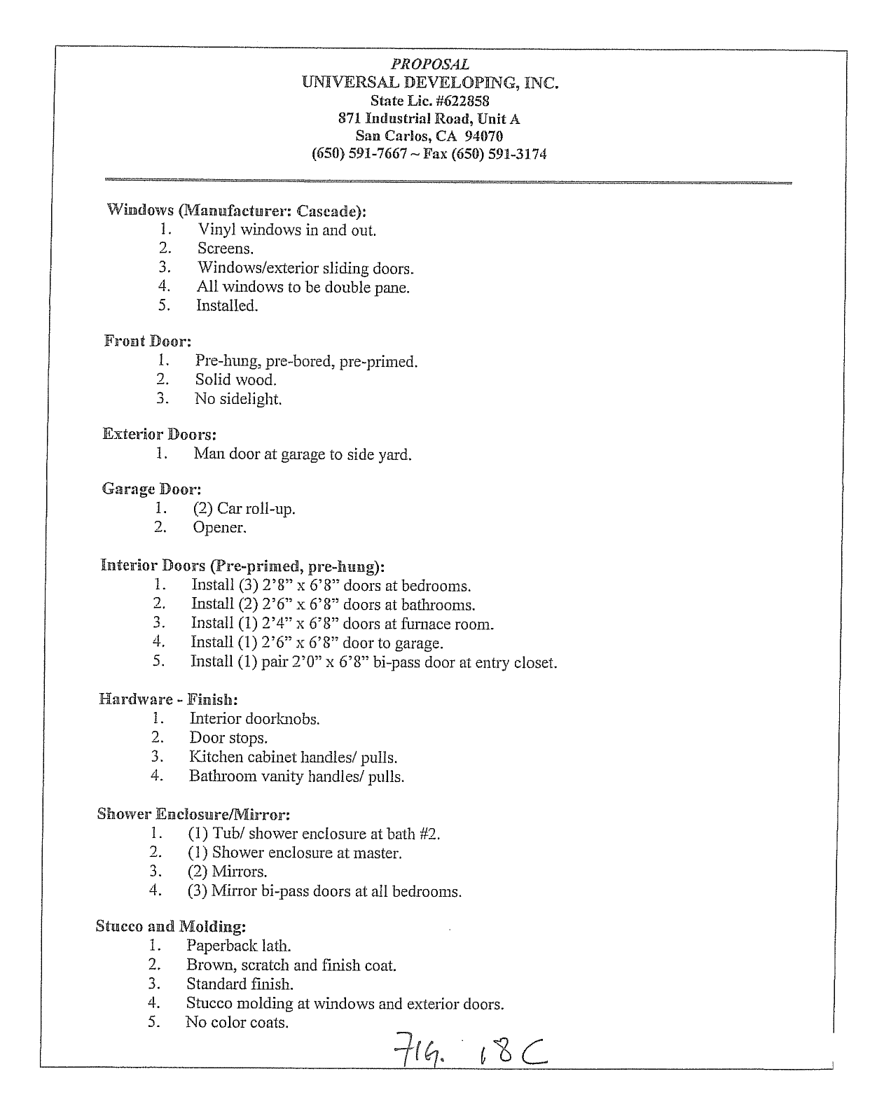

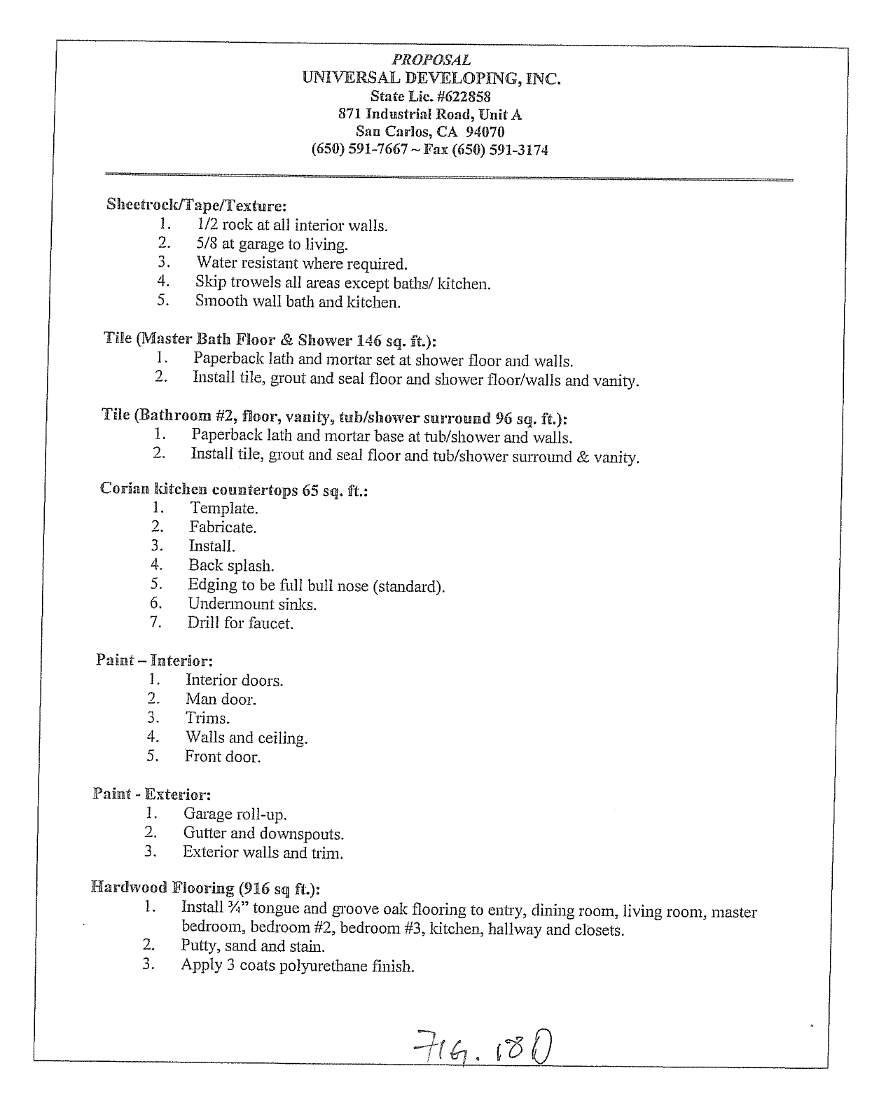

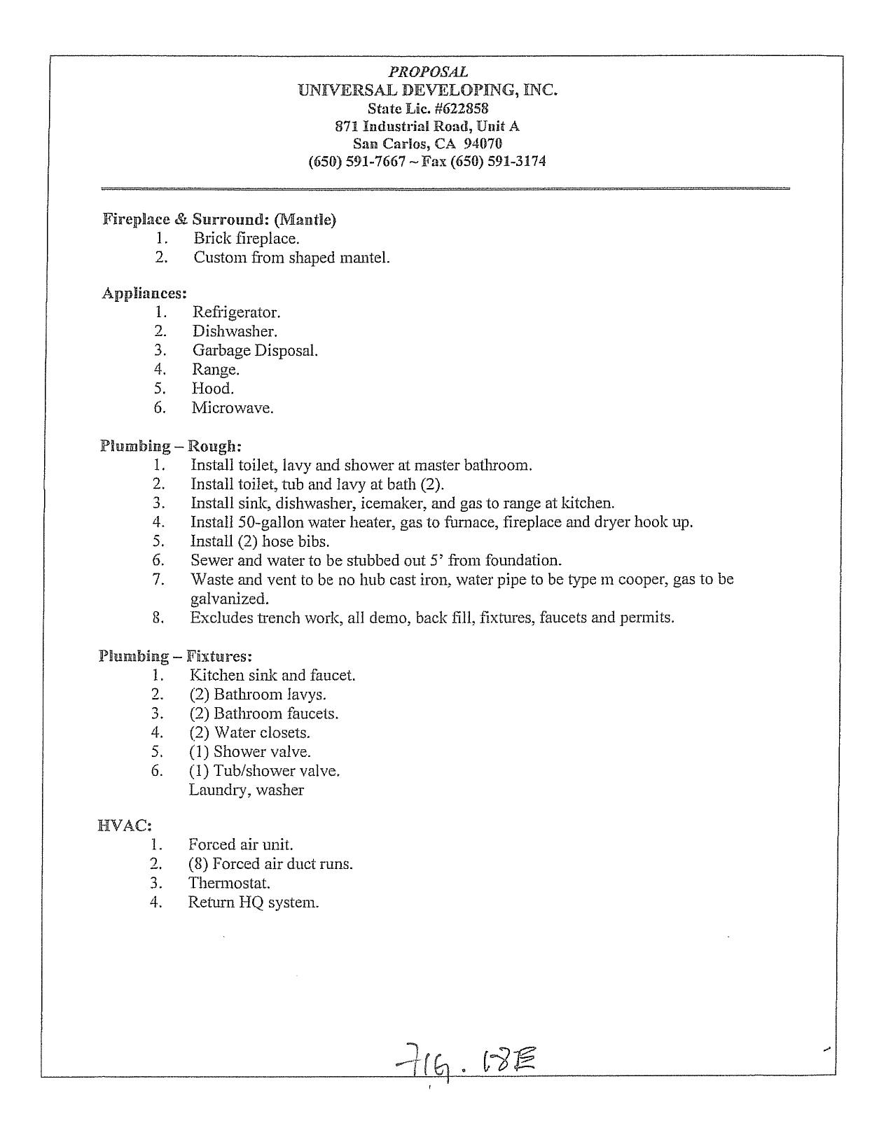

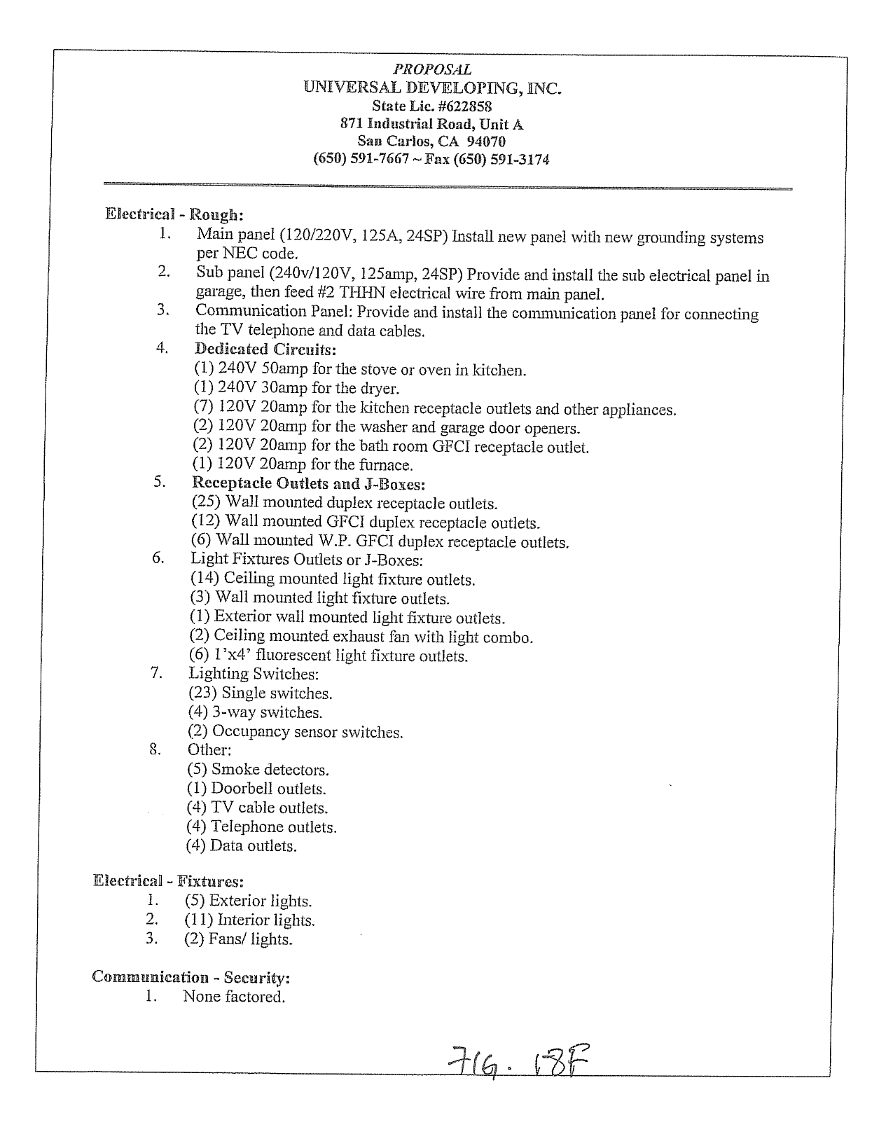

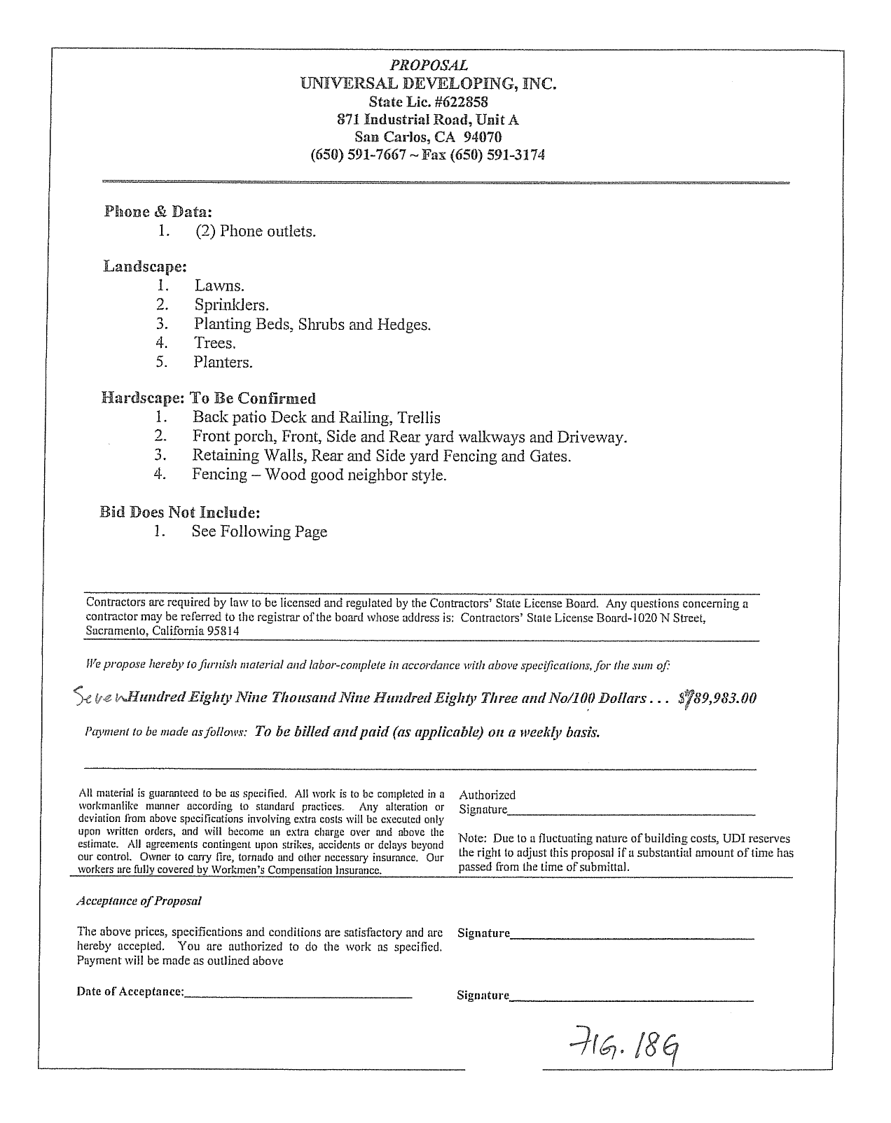

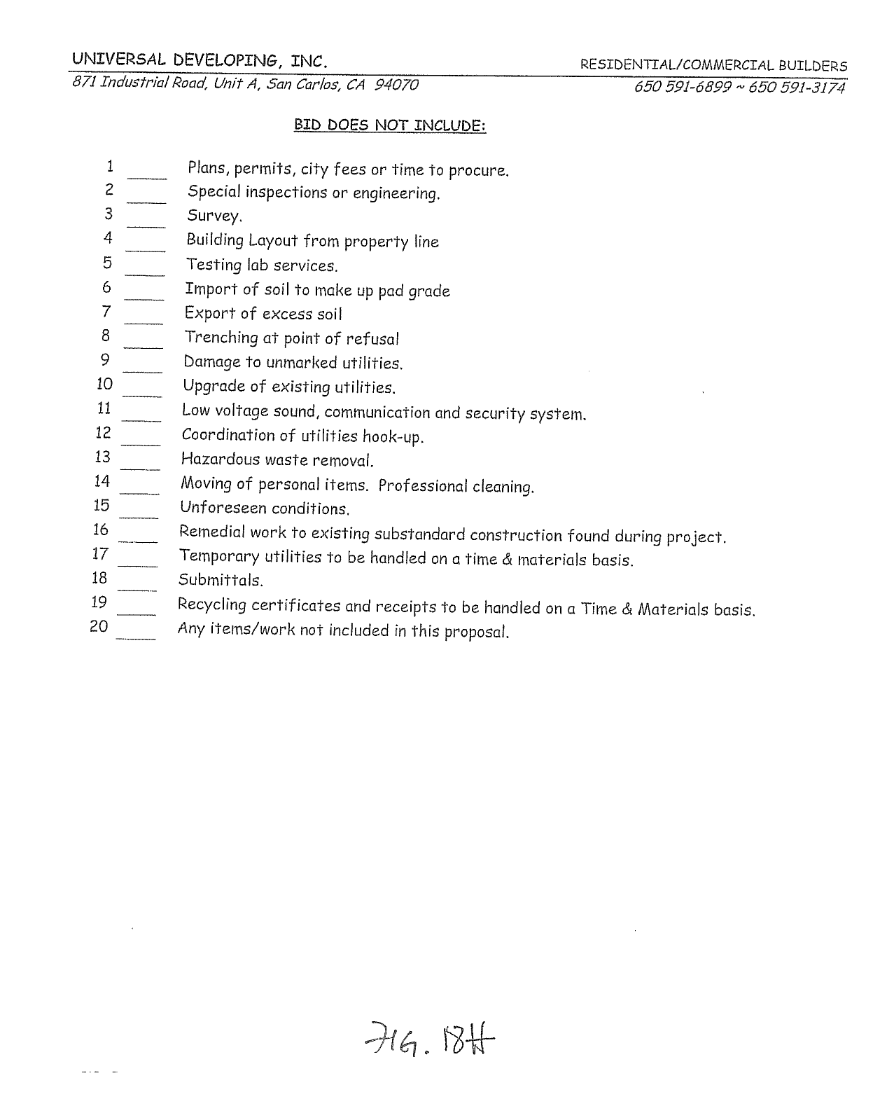

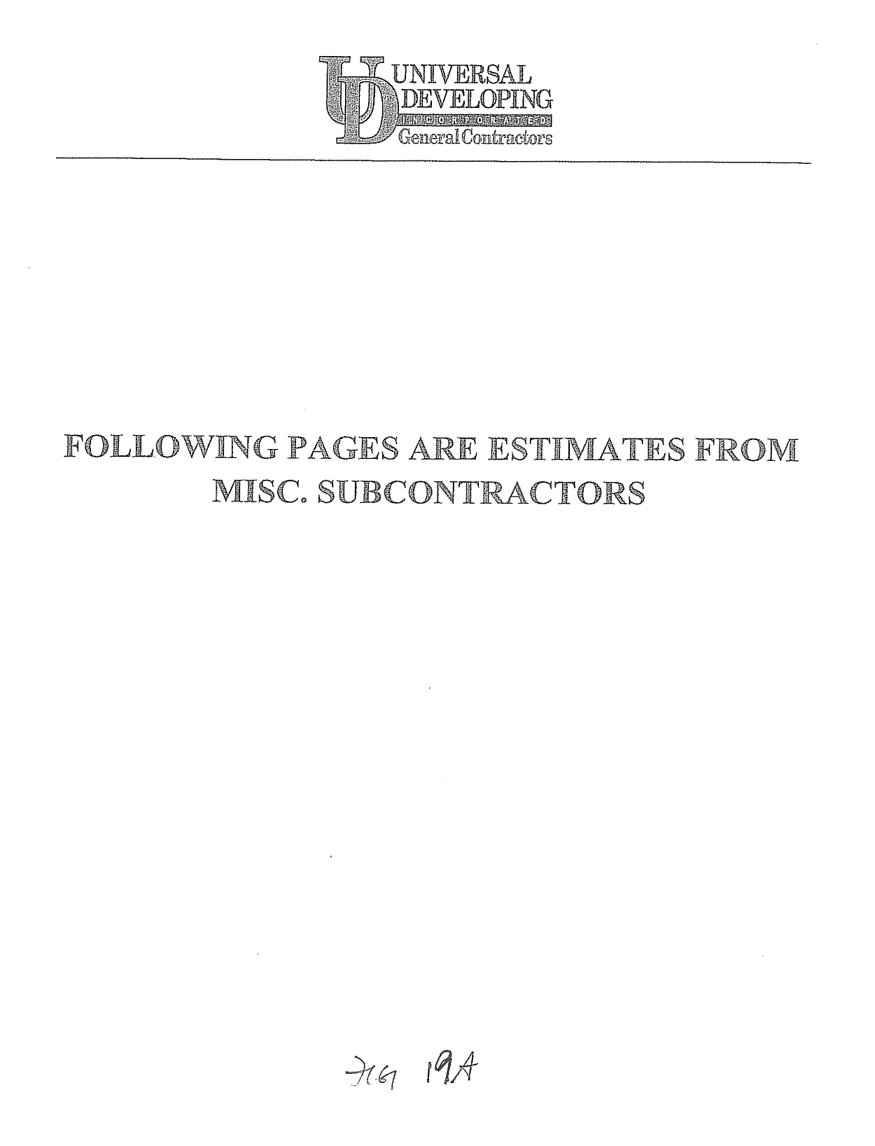

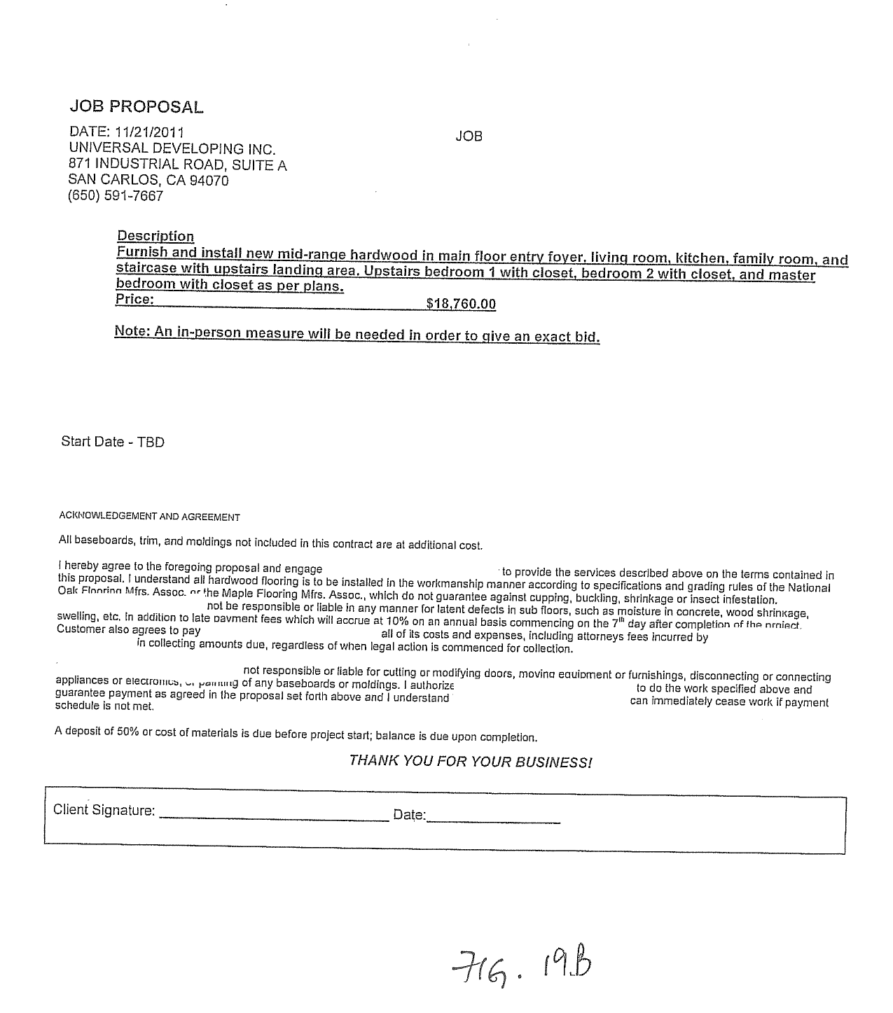

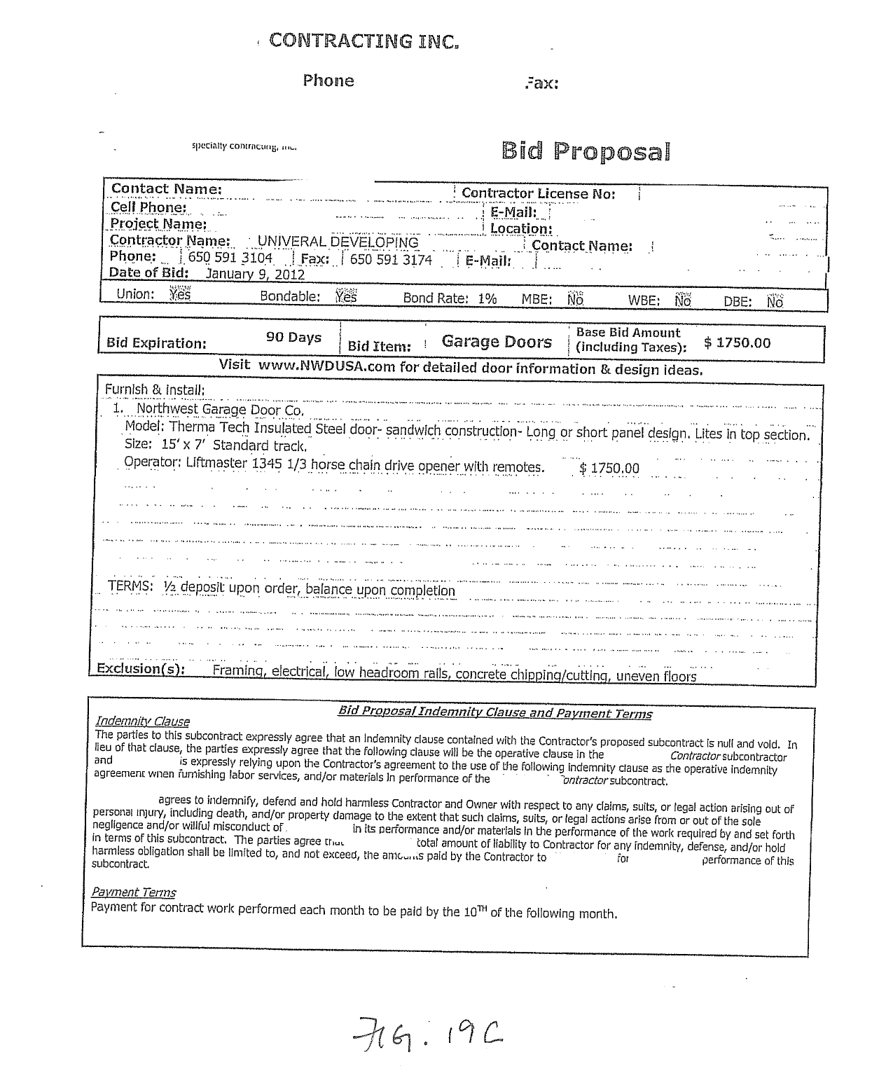

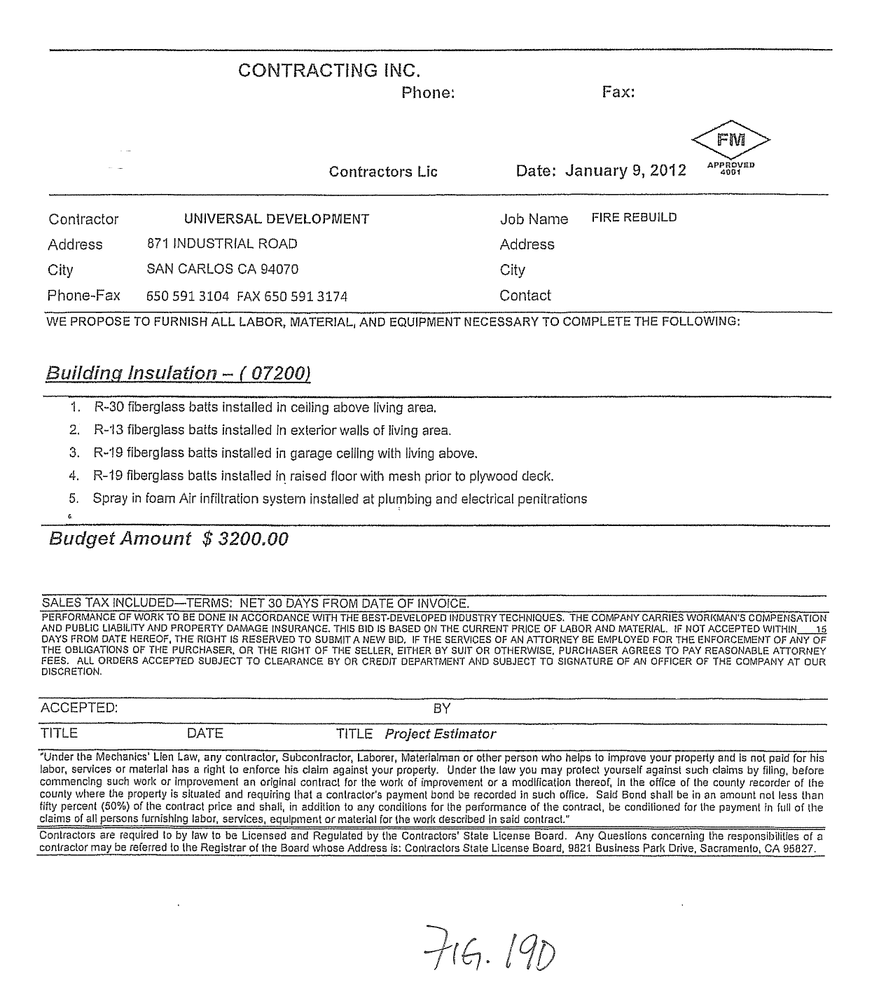

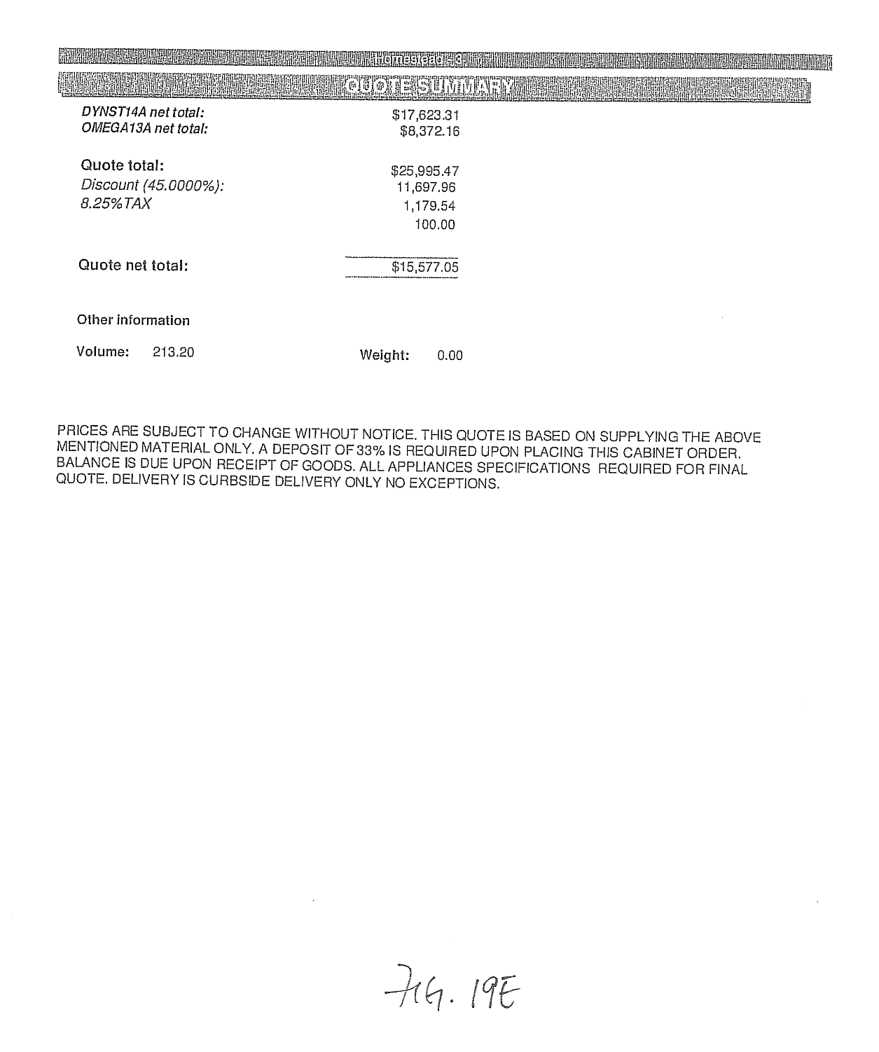

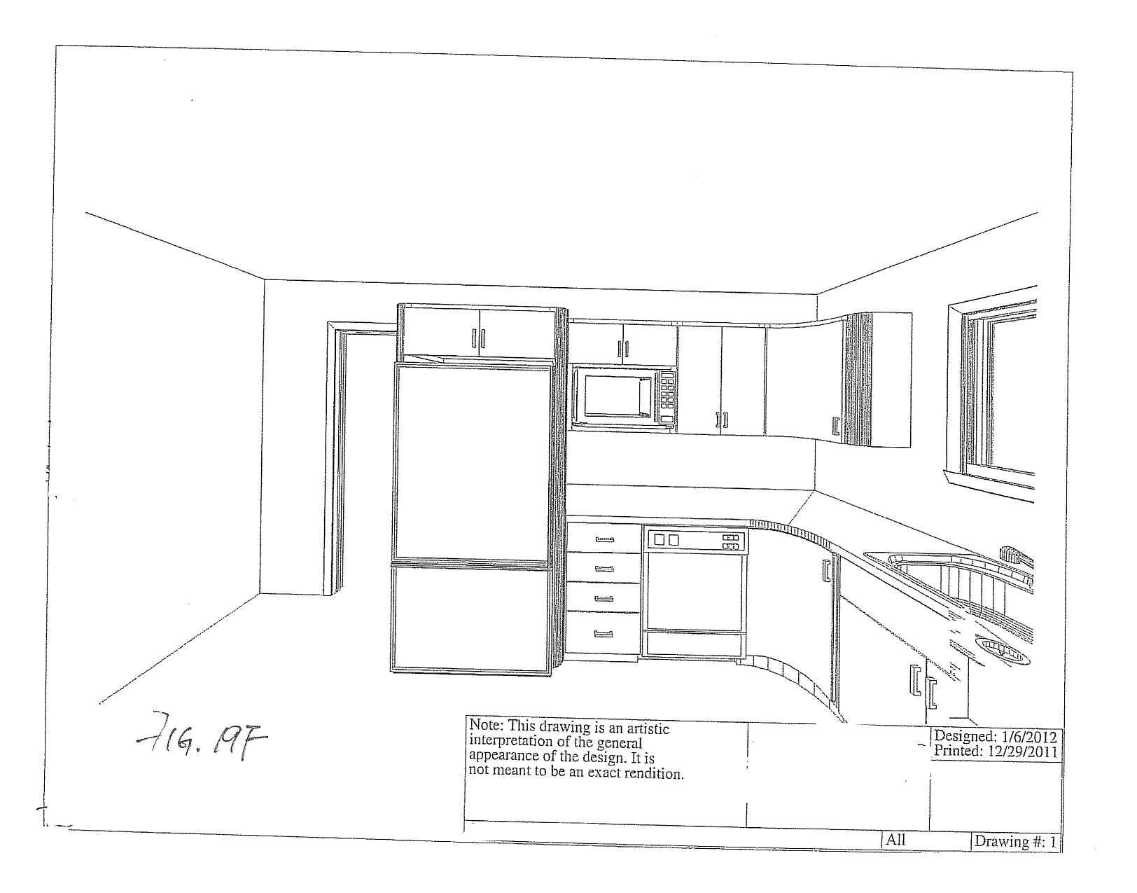

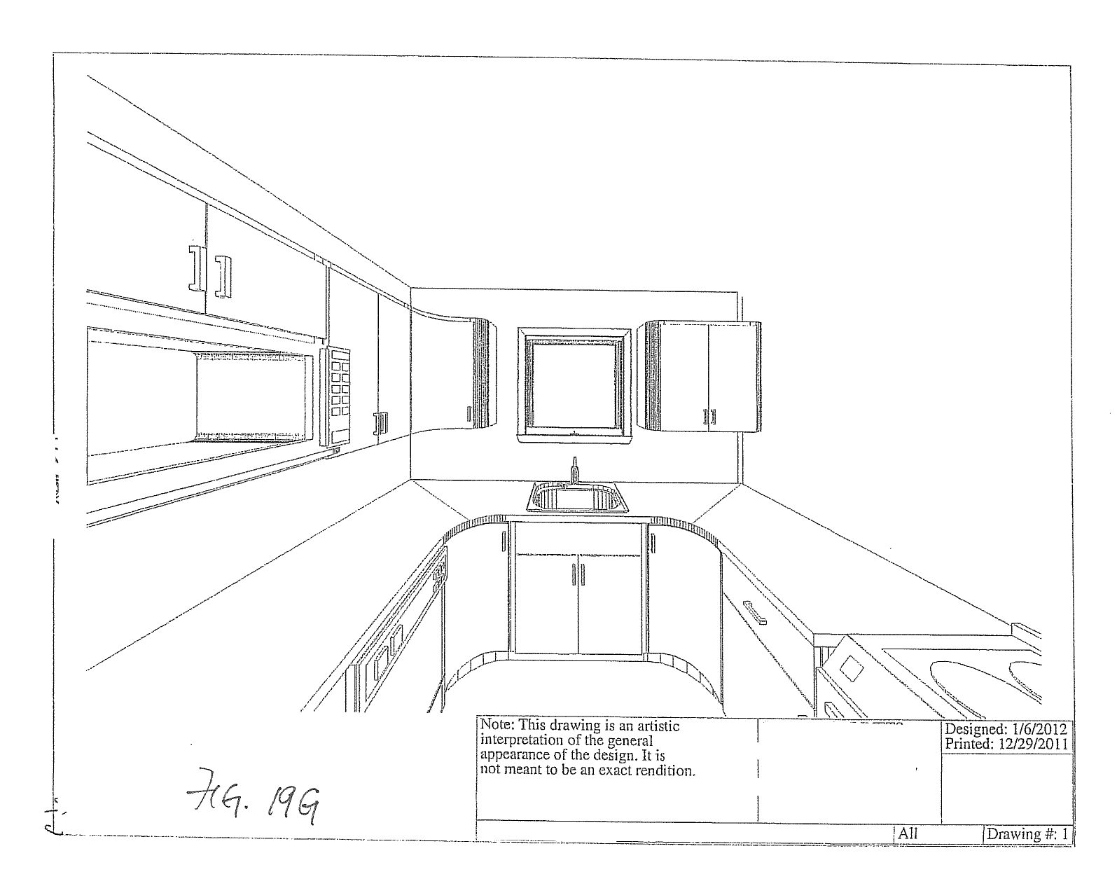

FIGS. 17A-B are representative list of cost adjustments for building and planning code upgrades from a typical as-built model of a building as developed from independent, verifiable and third-party resources of the present invention.

FIGS. 18A-G is a representative written proposal for construction of as-built model of a building as developed from independent, verifiable and third-party resources of the present invention. Ultimately, a building proposal with line items for specific cleanup and debris removal, site prep, demolition, shoring, underpinning, excavation, drilling, landscape, hardscape, pools and fountains, concrete, exterior brick, stone and masonry, structural steel, framing, rough hardware, stairs, siding and exterior trim, decking, railings, columns, trellis, gates, fences, interior trim, cabinets and millwork, roof, gutters, downspouts, sheet metal, waterproofing, insulation and thermal protection, windows, exterior doors, garage doors, interior doors, finish hardware, shower enclosure and mirrors, stuccos, sheetrock, tape and textures, ceilings and coverings, tile, granite or other stone counters, interior and exterior pains, hardwood and carpet and linoleum flooring, fireplaces and surrounds, specialty items, bath accessories, appliances, elevators, plumbing rough and fixtures, HVAC, solar, electrical rough and appliances, communicators, security, phone and data, supplies and services. Typical exclusions and/or allowances would also be included in the overall contractor's bid. These estimates are based upon the precise geographical location of the jobsite. In other words, they will include consideration of actual costs depending upon what part of the United States or other city and country of construction. Furthermore, actual price and timeline (see below) constrains will be based upon the time of the year, the current prices, estimated future prices and costs of inflation, costs of living, and increased materials costs, if and when critical.

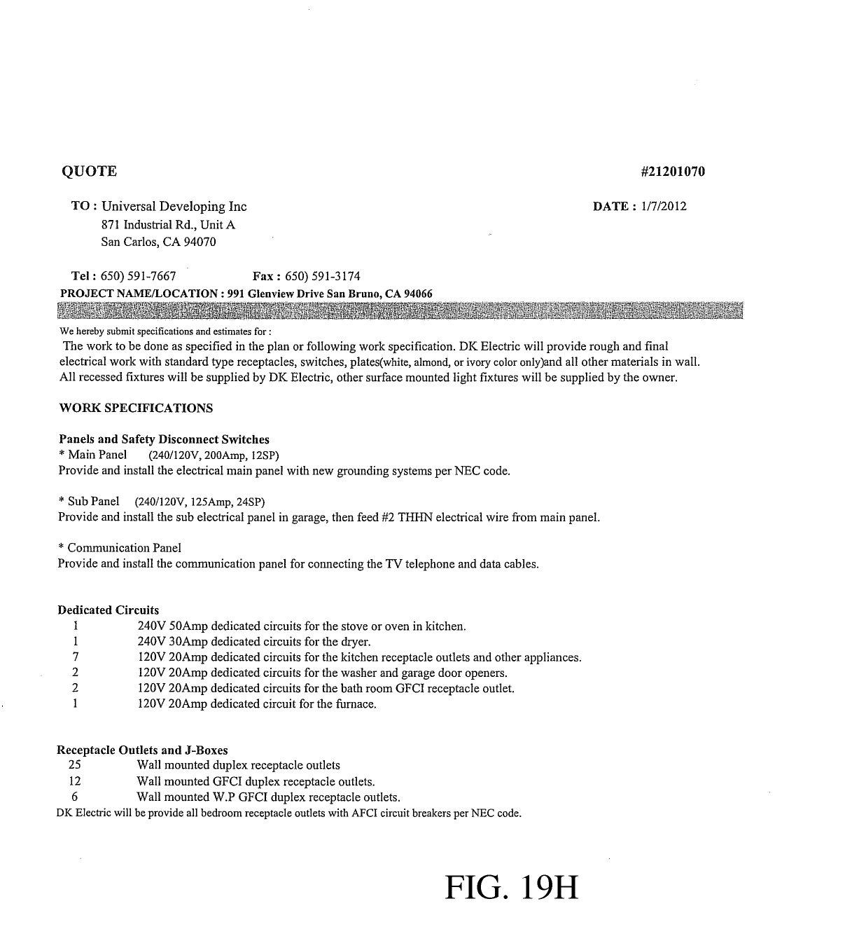

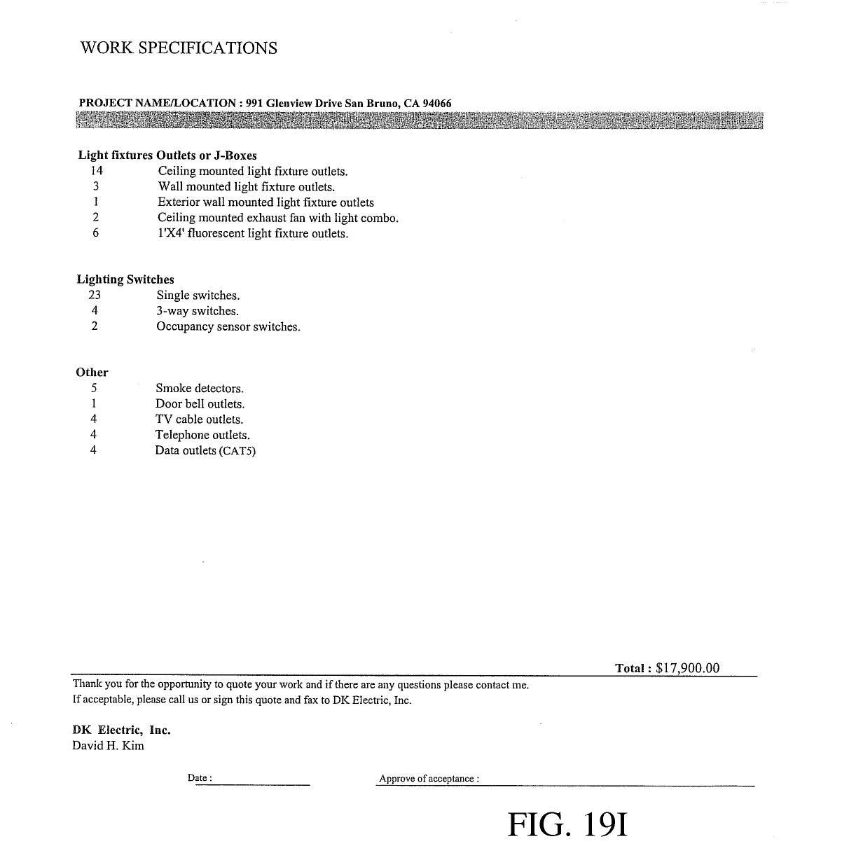

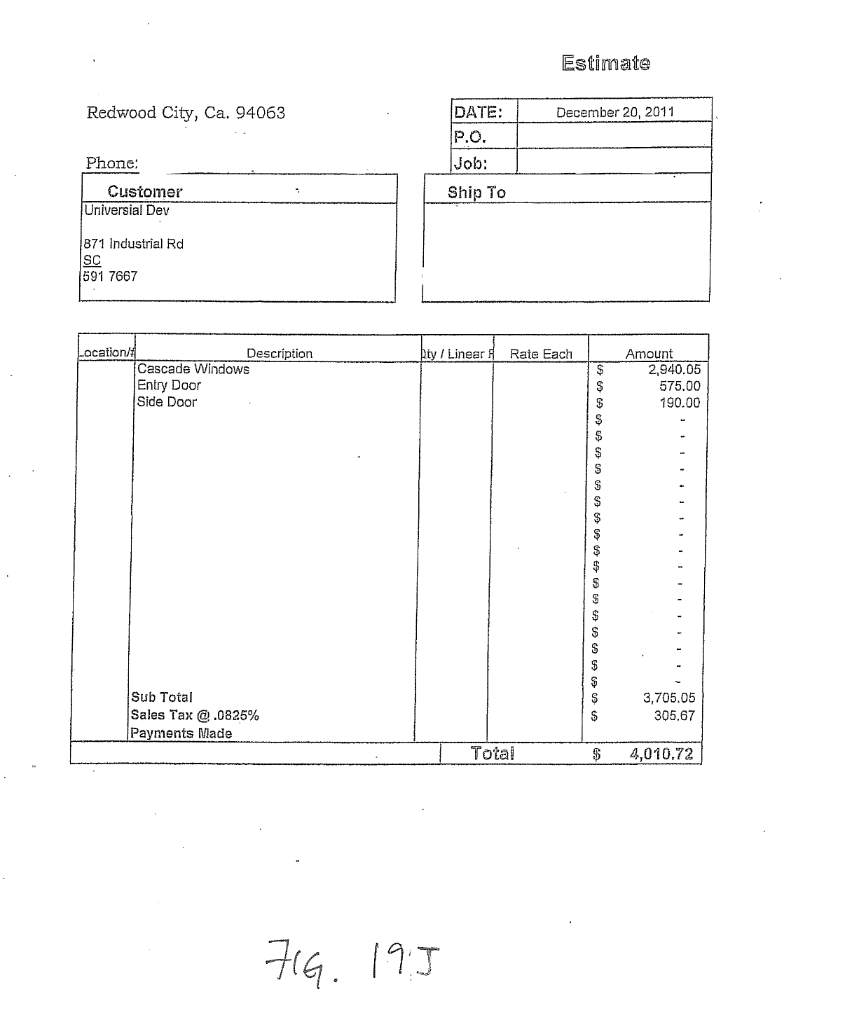

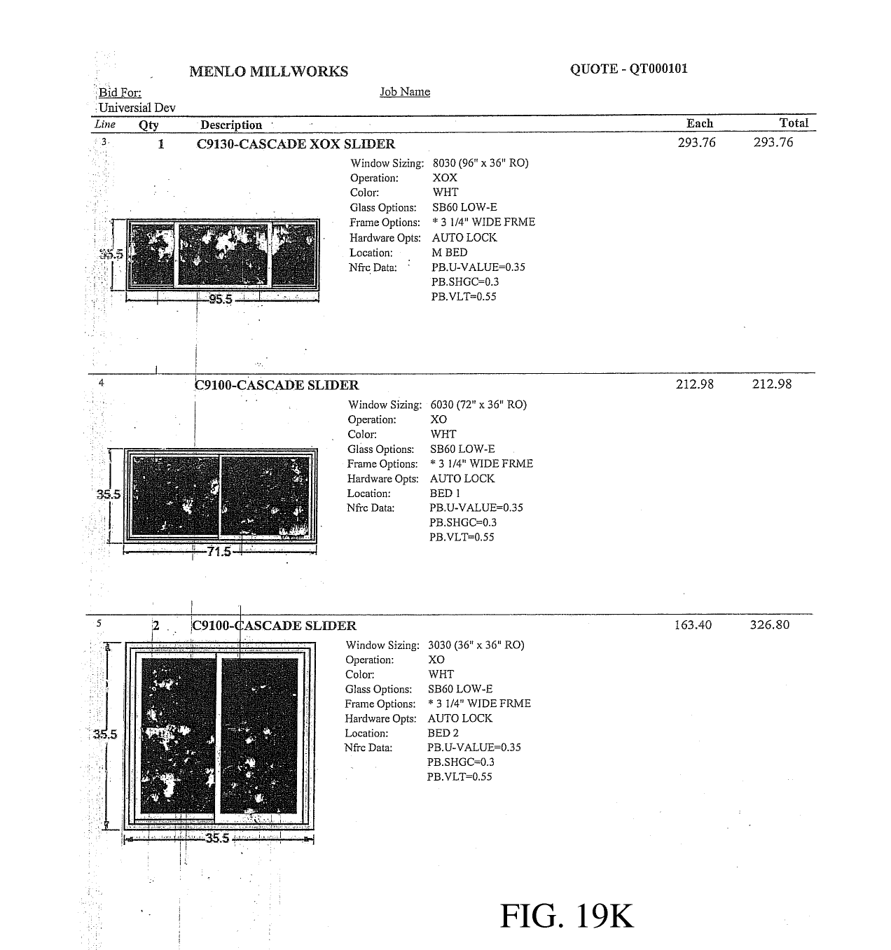

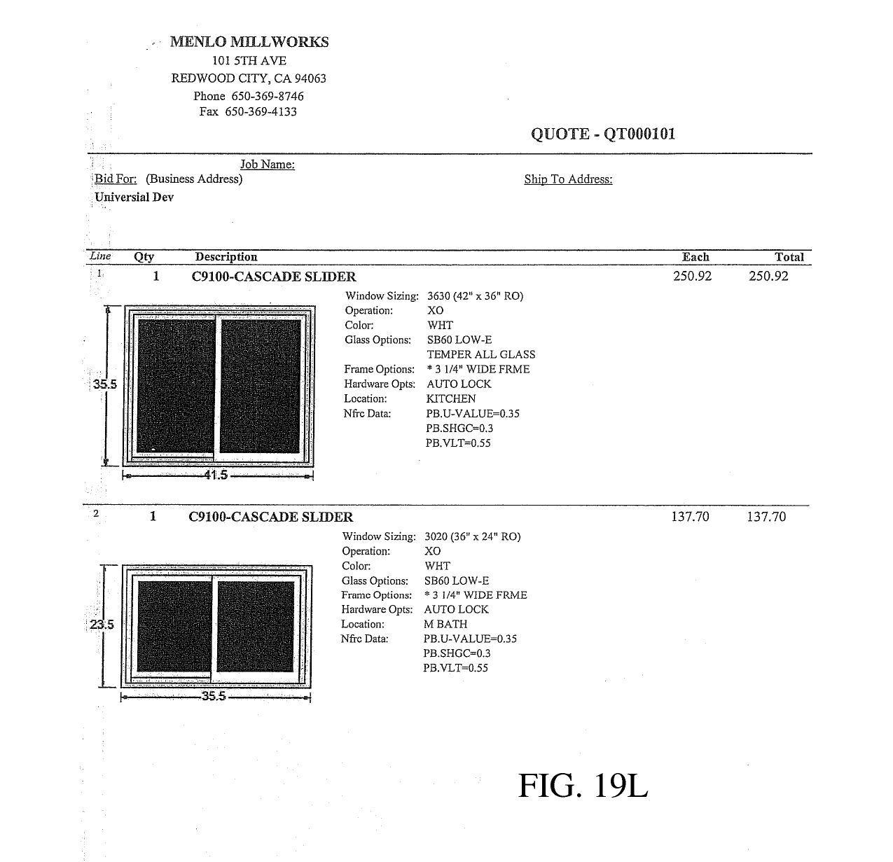

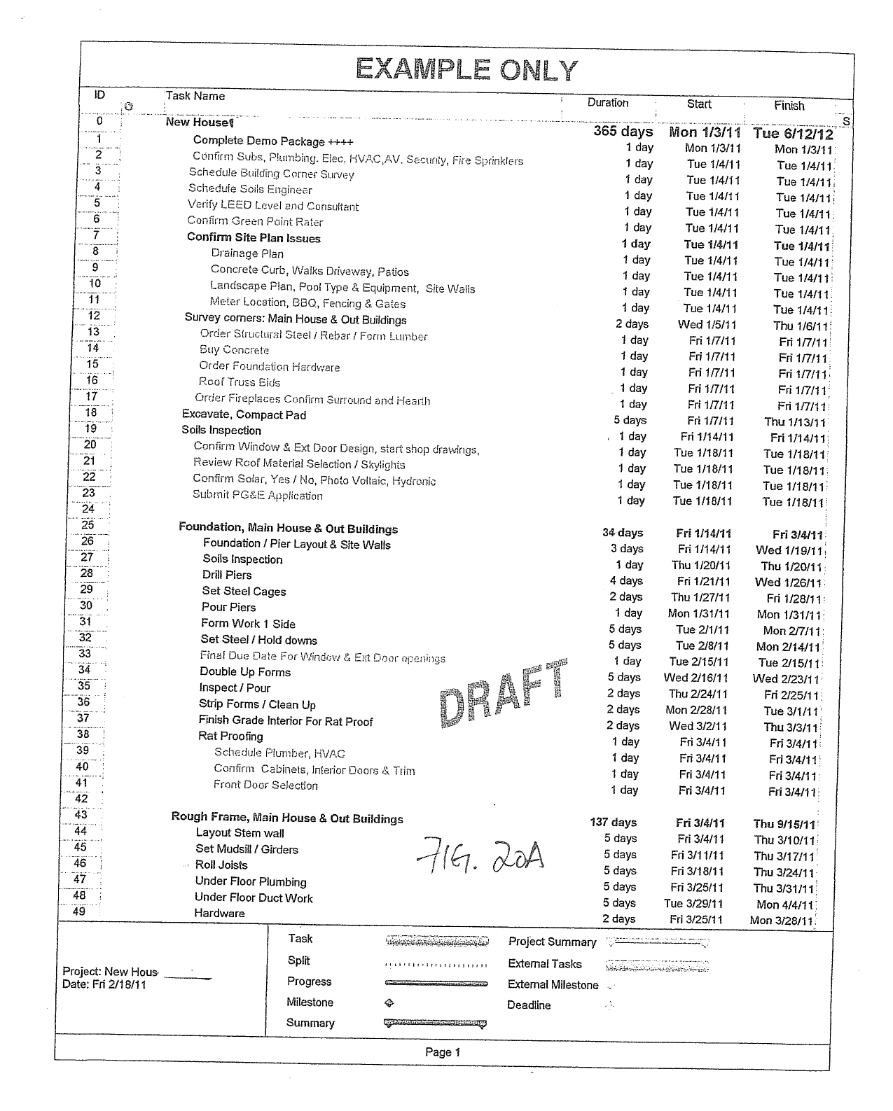

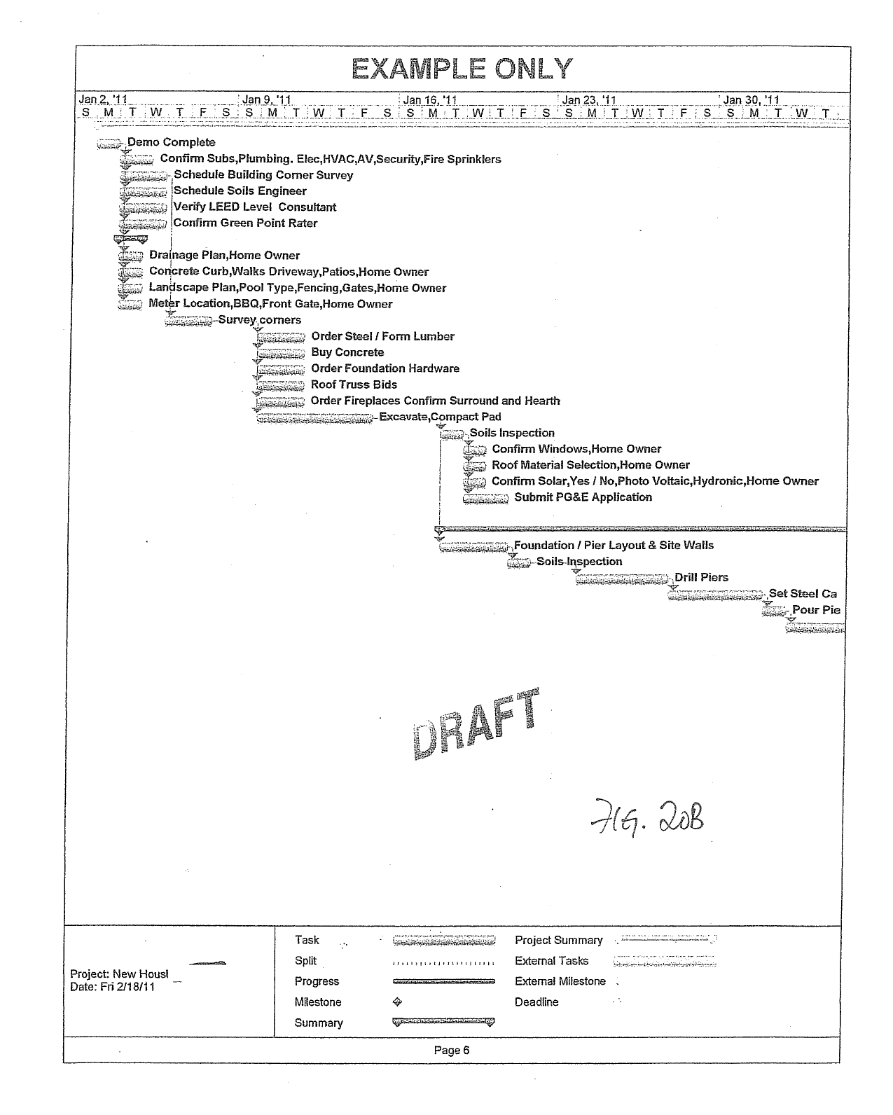

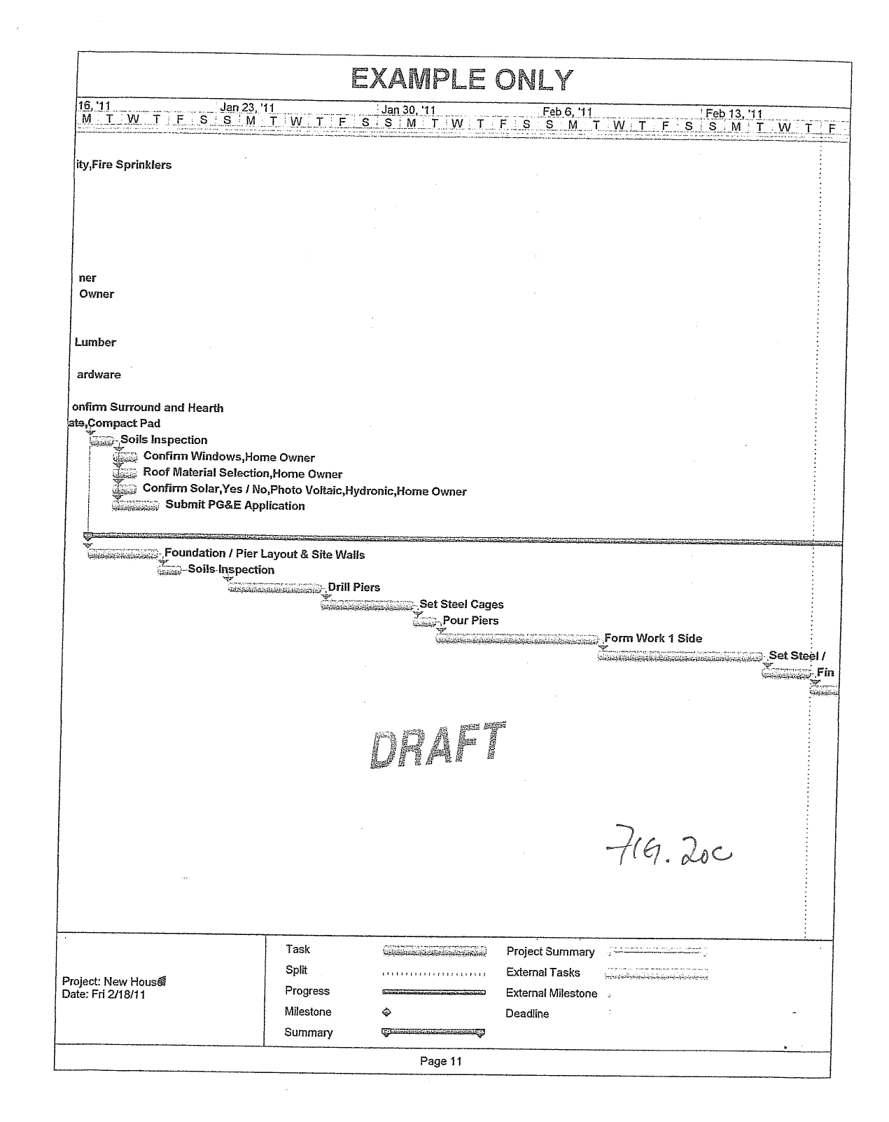

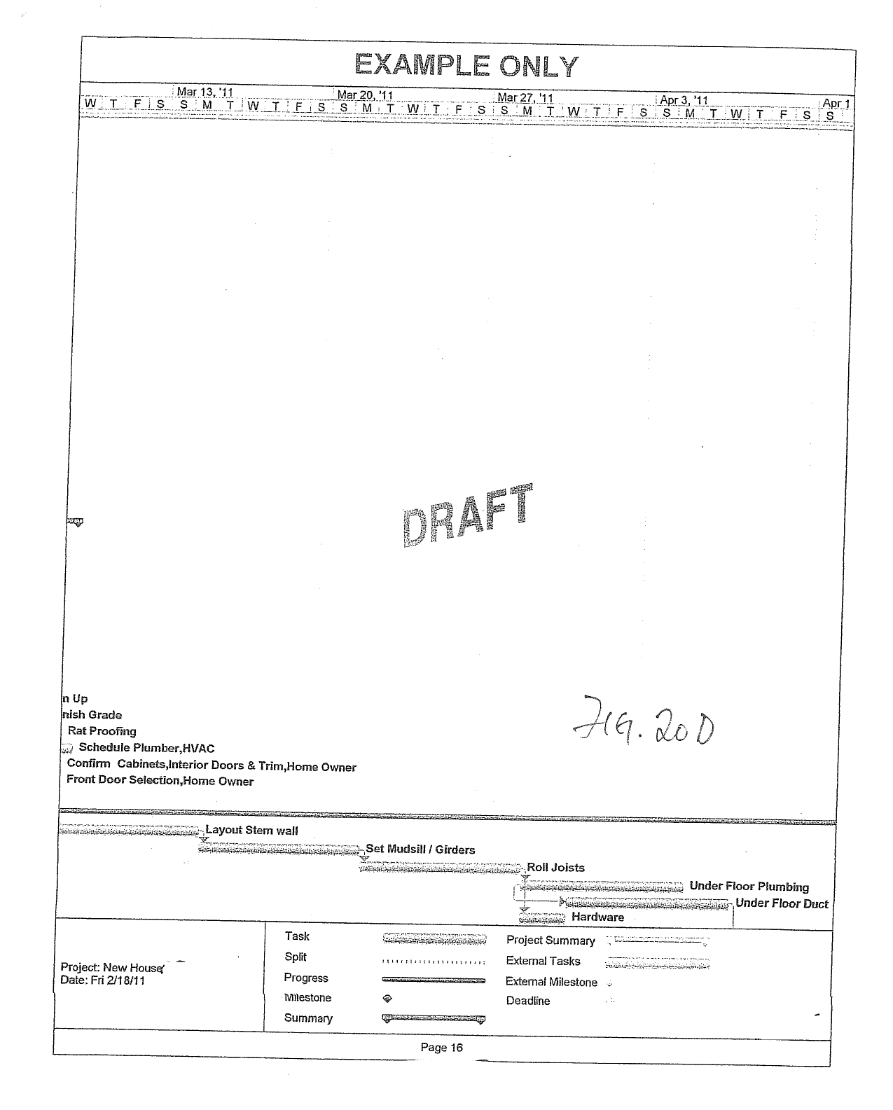

FIGS. 19A-L are representative sub-contractor's estimates for the as-built model of a building as developed from independent, verifiable and third-party resources of the present invention. Such subcontractors fields typically include but are not limited to the following:

Demolition and/or Clearing

Surveying/Engineering

Grading

Concrete or Block Foundation

Framing

Electrical

Plumbing

HVAC

Insulation

Glazing

Exterior Siding/Stucco

Dry Wall/Interior Finish

Interior/Exterior Painting

Flatwork/Landscape

It will be understood that the was-built model generated by the method and system of the present invention is specific to a date and location. For example, a printed limitation could read as follows: “Note: All Estimates are +/−, based on Mid Peninsula Calif. Year 2011 pricing

A geologists' survey or map will corroborate the landscape and foundation plans and compliance with local and national building standards and regulations. The geologists map gives information regarding soil and ground conditions.

FIGS. 20A-D are representative critical path flowcharts for the as-built model of a building as developed from independent, verifiable and third-party resources of the present invention. Ultimately, all of the specific items can be plotted and calendared and aan overall critical path of building schedule can be implemented. This provides all the critical path time periods and other time periods for completing construction in a timely, on-schedule manner.

For a better understanding of the invention reference is made to the following detailed description of the preferred embodiments thereof which should be taken in conjunction with the prior described drawings.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A method to assist homeowners in re-drawing building plans in order to identify the components that were in their previous home, the method comprising the following steps:
Obtaining public documents including aerial photographs, building department records, county assessors office records, sub division and/or parcel maps and the intimate knowledge of the home from the owners;
Integrating the documents with the support of personal or commercial pictures to generate a solid platform for the building footprint, setbacks, lot coverage including living and garage sizes, roof size and slope, window size and location and interior floorplan;
Producing a 3-D model for the re-creation of the “As Was Built” house; and
Identifying and capturing estimated costs for professional services, suppliers, and subcontractors using agreed upon unit price sheet for those specific scopes of work which are unique to the specific geographical location and unique to the specific, temporal construction schedule.

2. A system for multi-verifiable, as-built construction modeling in which accurate, independently verifiable site maps, floorplan, exterior and interior elevations alongside detailed checklists for subcontractors, suppliers, and professional services can be generated for providing detailed written proposals, cost estimates and critical path timeline, the system comprising:
Obtaining a map of the geographical location of construction;
Obtaining a local zoning map;
Providing aerial and/or satellite maps of previous roof structure;
Generating a dimensions diagram of the roof structure;
Obtaining and considering reports from the local Building Department;
Generating a hand drawn floorplan, optionally by collaboration with the owner, asset manager or property manager;
Providing a schedule of finishes, optionally by collaboration with the owner, asset manager or property manager;
Obtaining and factoring in local County assessors' office information;
Generating a new CAD floorplan from roof, and owner's floorplan;
Cross referencing the area square footage statistics, including bedrooms, baths, /floor covering, optionally including garage, fireplaces, set backs, etc.
Generating a 3D front elevation using computer images such as from Google street map;
Generating the other elevations, such as sides and rear elevations;
Generating a floorplan with layouts corresponding to electrical, plumbing, HVAC, etc.;
Creating exact kitchen and bathroom vanity layouts and elevations;
Obtaining a parcel map;
Plotting the site plan such that the building to be built is plotted to parcel lot;
Re-creating the landscape plan, optionally using the plot plan and prior photographic images;
Developing a landscape schedule of finishes;
Developing a detailed subcontractor, supplier and professional services price per unit checklist spreadsheet;
Obtaining and considering the local geology map;
Generating a written estimate or proposal; and
Generating the flow chart for the critical path timeline for construction.
